(19) United States
(12) Patent Application Publication
(10) Pub. No.: US 2025/0106936 A1
(43) Pub. Date: Mar. 27, 2025

(54) CELL DISCONTINUOUS SIGNALING CONFIGURATION

(71) Applicant: Lenovo (Singapore) Pte. Limited, Singapore (SG)

(72) Inventors: Ahmed Hindy, Aurora, IL (US); Vijay Nangia, Woodridge, IL (US)

(73) Assignee: Lenovo (Singapore) Pte. Limited, Singapore (SG)

(21) Appl. No.: 18/896,076

(22) Filed: Sep. 25, 2024

Related U.S. Application Data
(60) Provisional application No. 63/540,574, filed on Sep. 26, 2023.

(51) Int. Cl. H04W 76/28; H04W 72/0446; H04W 72/21

(52) U.S. Cl. CPC H04W 76/28; H04W 72/0446; H04W 72/21

(57) ABSTRACT

Various aspects of the present disclosure relate to cell discontinuous signaling configuration. An apparatus, such as a UE, receives cell discontinuous signaling configuration from a network entity such as a base station. The cell discontinuous signaling configuration includes one or more of a cell discontinuous transmission (DTX) behavior or a cell discontinuous reception (DRX) behavior. The UE can apply the cell discontinuous signaling configuration to determine when to perform signal monitoring and/or signal transmission.

### RELATED APPLICATION

This application claims priority to U.S. Provisional Application Ser. No. 63/540,574 filed 26 Sep. 2023 titled “CELL DISCONTINUOUS SIGNALING CONFIGURATION,” the disclosure of which is incorporated by reference herein in its entirety.

### TECHNICAL FIELD

The present disclosure relates to wireless communications, and more specifically to discontinuous signaling in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications system implement measures to attempt to control energy consumption. Some current techniques, however, may adversely impact network performance.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include functionality to receive a first signaling occasion including cell discontinuous signaling configuration and including at least one of: a cell discontinuous transmission (DTX) behavior including a cell DTX cycle in which a UE is not to monitor a first signal set corresponding to a cell DTX inactive period and at least two monitor intervals in which the UE is permitted to monitor the first signal set; or a cell discontinuous reception (DRX) behavior including a cell DRX cycle in which the UE is not to transmit a second signal set corresponding to a cell DRX inactive period and at least two transmit intervals in which the UE is permitted to transmit the second signal set; receive a second signaling occasion activating the cell discontinuous signaling configuration; and perform at least one of to: monitor a first signal monitor group of the first signal set at a first monitor interval of the at least two monitor intervals, and monitor a second signal monitor group of the first signal set at a second monitor interval of the at least two monitor intervals based on the cell DTX behavior; or transmit a first signal transmit group of the second signal set at a first transmit interval of the at least two transmit intervals, and transmit a second signal transmit group of the second signal set at a second transmit interval of the at least two transmit intervals based on the cell DRX behavior.

In some implementations of the method and apparatuses described herein, a first subset of the first signal set includes at least one of semi-persistent scheduling (SPS) occasions including SPS physical downlink shared channel (PDSCH), one or more of periodic or semi-persistent channel state information (CSI) reference signal (RS) for CSI measurement associated with rank indicator (RI) reporting, or physical downlink control channel (PDCCH) corresponding to downlink control information (DCI) formats not associated with scheduling PDSCH or physical uplink shared channel (PUSCH); and a second subset of the first signal set includes at least one of synchronization signal block (SSB), system information block (SIB), phase tracking reference signal (PTRS), periodic or semi-persistent CSI-RS for beam management (BM), positioning reference signal (PRS), PDCCH scrambled with UE-specific radio network temporary identifier (RNTI), PDCCH in Type-3 common search space (CSS), PDCCH for random access response (RAR), PDCCH for msg4 hybrid automatic repeat request (HARQ) transmission.

In some implementations of the method and apparatuses described herein, at least one of: the first signal monitor group includes the first subset of the first set signal set and the second signal monitor group includes the second subset of the first signal set; the first signal monitor group includes the first subset of the first set signal set and the second subset of the first signal set, and the second signal monitor group includes the second subset of the first signal set; or the first signal monitor group and second signal monitor group each include the first subset of the first set signal set and the second subset of the first signal set; a first subset of the second signal set includes at least one of configured grant (CG) occasions including CG PUSCH, one or more of periodic or semi-persistent sounding reference signal (SRS) not associated with positioning, one or more of periodic or semi-persistent CSI report over one or more of PUSCH or physical uplink control channel (PUCCH), scheduling request (SR) occasions; and a second subset of the second signal set includes at least one of SRS for positioning or hybrid automatic repeat request acknowledgement (HARQ-ACK) feedback for SPS PDSCH.

In some implementations of the method and apparatuses described herein, at least one of: the first signal transmit group includes the first subset of the second set signal set and the second signal transmit group includes the second subset of the second signal set; the first signal transmit group includes the first subset of the second set signal set and the second subset of the second signal set, and the second signal transmit group includes the second subset of the second signal set; or the first signal transmit group and second signal transmit group each include the first subset of the second set signal set and the second subset of the second signal set; at least one of: the at least two monitor intervals include at least one of a first monitor interval that precedes a first slot corresponding to a first cell DTX cycle based on a cell DTX activation via the second signaling occasion, and a second monitor interval that succeeds a last slot corresponding to a last cell DTX cycle based on a cell DTX deactivation via the second signaling occasion; or the at least two transmit intervals include at least one of a first transmit interval that precedes a first slot corresponding to a first cell DRX cycle based on a cell DRX activation via the second signaling occasion, and a second transmit interval that succeeds a last slot corresponding to a last DRX cycle based on a cell DRX deactivation via the second signaling occasion.

In some implementations of the method and apparatuses described herein, at least one of: one or more signals received in the at least two monitor intervals are based at least in part on aperiodic triggering, wherein aperiodic triggering for one or more signals received in a first monitor interval of the at least two monitor intervals is inferred from cell DTX activation via the second signaling occasion, and aperiodic triggering one or more signals received in a second monitor interval of the at least two monitor intervals is inferred from cell DTX deactivation via the second signaling occasion; or one or more signals transmitted in the at least two transmit intervals are based at least in part on aperiodic triggering, wherein aperiodic triggering for one or more signals transmitted in a first transmit interval of the at least two transmit intervals is inferred from cell DRX activation via the second signaling occasion, and aperiodic triggering one or more signals transmitted in a second transmit interval of the at least two transmit intervals is inferred from cell DRX deactivation via the second signaling occasion.

In some implementations of the method and apparatuses described herein, at least one of: the at least two monitor intervals correspond to two on-duration periods within a same cell DTX cycle, wherein a monitor first interval is associated with a first slot offset value and a first on-duration timer value, and a second monitor interval is associated with a second slot offset value and a second on-duration timer value; or the at least two transmit intervals correspond to two on-duration periods within a same cell DRX cycle, wherein a transmit first interval is associated with a first slot offset value and a first on-duration timer value, and a second transmit interval is associated with a second slot offset value and a second on-duration timer value; at least one of: the cell discontinuous signaling configuration indicates two types of cell DTX cycles, a first type of cell DTX cycle corresponding to a long cell DTX cycle and a second type of cell DTX cycle corresponding to a short cell DTX cycle; or the cell discontinuous signaling configuration indicates two types of cell DRX cycles, a first type of cell DRX cycle corresponding to a long cell DRX cycle and a second type of cell DRX cycle corresponding to a short cell DRX cycle.

In some implementations of the method and apparatuses described herein, at least one of: a length of the long cell DTX cycle is an integer multiple of a length of the short cell DTX cycle, and a first slot offset value associated with a first on-duration timer of the long cell DTX cycle is equivalent to a second slot offset value associated with a second on-duration timer of the short cell DTX cycle, and a first on-duration timer value of the long cell DTX cycle is equivalent to a second first on-duration timer value of the short cell DTX cycle; or a length of the long cell DRX cycle is an integer multiple of a length of the short cell DRX cycle, and a first slot offset value associated with a first on-duration timer of the long cell DRX cycle is equivalent to a second slot offset value associated with a second on-duration timer of the short cell DRX cycle, and a first on-duration timer value of the long cell DRX cycle is equivalent to a second first on-duration timer value of the short cell DRX cycle; at least one of: the long cell DTX cycle and the short cell DTX cycle are jointly triggered via the second signaling occasion; or the long cell DRX cycle and the short cell DRX cycle are jointly triggered via the second signaling occasion.

In some implementations of the method and apparatuses described herein, at least one of: the at least two monitor intervals correspond to two on-duration periods associated with two alternating cell DTX cycles, wherein the first monitor interval is associated with a first slot offset value and a first on-duration timer value, and the second monitor interval is associated with a second slot offset value and a second on-duration timer value; or the at least two transmit intervals correspond to two on-duration periods associated with two alternating cell DRX cycles, wherein the first transmit interval is associated with a third slot offset value and a third on-duration timer value, and the second transmit interval is associated with a fourth slot offset value and a fourth on-duration timer value; at least one of: a signal associated with cell DTX is configured with two higher-layer DTX configurations, a first higher-layer DTX configuration corresponding to a period wherein cell DTX is deactivated, and a second higher-layer DTX configuration corresponding to the at least two monitor intervals associated with cell DTX being activated; or a signal associated with cell DRX is configured with two higher-layer DRX configurations, a first higher-layer DRX configuration corresponding to a period wherein cell DRX is deactivated, and a second higher-layer DRX configuration corresponding to the at least two monitor intervals associated with cell DRX being activated.

In some implementations of the method and apparatuses described herein, any one or combination of to infer a trigger of a higher-layer configuration of the two higher-layer configurations from a trigger of one or more of cell DTX activation or cell DTX deactivation via the second signaling occasion; or infer a trigger of a higher-layer configuration of the two higher-layer configurations from a trigger of one or more of cell DRX activation or cell DRX deactivation via the second signaling occasion; at least one of: a trigger of a higher-layer configuration of the two higher-layer configurations is based at least in part on a cell DTX-based command medium access control (MAC) control element (CE); or a trigger of a higher-layer configuration of the two higher-layer configurations is based at least in part on a cell DRX-based command MAC-CE; at least one of: an identification (1D) value of a second higher-layer DTX configuration of the two higher-layer DTX configurations is indicated within at least one of the first signaling occasion or the second signaling occasion; or an ID value of a second higher-layer DRX configuration of the two higher-layer DRX configurations is indicated within at least one of the first signaling occasion or the second signaling occasion.

Some implementations of the method and apparatuses described herein may further include receiving a first signaling occasion including cell discontinuous signaling configuration and including at least one of: a cell DTX behavior including a cell DTX cycle in which the UE is not to monitor a first signal set corresponding to a cell DTX inactive period and at least two monitor intervals in which the UE is permitted to monitor the first signal set; or a cell DRX behavior including a cell DRX cycle in which the UE is not to transmit a second signal set corresponding to a cell DRX inactive period and at least two transmit intervals in which the UE is permitted to transmit the second signal set; receiving a second signaling occasion activating the cell discontinuous signaling configuration; and performing at least one of: monitoring a first signal monitor group of the first signal set at a first monitor interval of the at least two monitor intervals, and monitor a second signal monitor group of the first signal set at a second monitor interval of the at least two monitor intervals based on the cell DTX behavior; or transmitting a first signal transmit group of the second signal set at a first transmit interval of the at least two transmit intervals, and transmit a second signal transmit group of the second signal set at a second transmit interval of the at least two transmit intervals based on the cell DRX behavior.

In some implementations of the method and apparatuses described herein, a first subset of the first signal set includes at least one of SPS occasions including SPS PDSCH, one or more of periodic or semi-persistent CSI RS for CSI measurement associated with RI reporting, or PDCCH corresponding to DCI formats not associated with scheduling PDSCH or PUSCH; and a second subset of the first signal set includes at least one of SSB, SIB, PTRS, periodic or semi-persistent CSI-RS for BM, PRS, PDCCH scrambled with UE-specific radio network temporary identifier (RNTI), PDCCH in Type-3 CSS, PDCCH for RAR, PDCCH for msg4 hybrid automatic repeat request (HARQ) transmission; at least one of: the first signal monitor group includes the first subset of the first set signal set and the second signal monitor group includes the second subset of the first signal set; the first signal monitor group includes the first subset of the first set signal set and the second subset of the first signal set, and the second signal monitor group includes the second subset of the first signal set; or the first signal monitor group and second signal monitor group each include the first subset of the first set signal set and the second subset of the first signal set.

In some implementations of the method and apparatuses described herein, a first subset of the second signal set includes at least one of CG occasions including CG PUSCH, one or more of periodic or semi-persistent SRS not associated with positioning, one or more of periodic or semi-persistent CSI report over one or more of PUSCH or PUCCH, SR occasions; and a second subset of the second signal set includes at least one of SRS for positioning or HARQ-ACK feedback for SPS PDSCH; at least one of: the first signal transmit group includes the first subset of the second set signal set and the second signal transmit group includes the second subset of the second signal set; the first signal transmit group includes the first subset of the second set signal set and the second subset of the second signal set, and the second signal transmit group includes the second subset of the second signal set; or the first signal transmit group and second signal transmit group each include the first subset of the second set signal set and the second subset of the second signal set.

In some implementations of the method and apparatuses described herein, at least one of: the at least two monitor intervals include at least one of a first monitor interval that precedes a first slot corresponding to a first cell DTX cycle based on a cell DTX activation via the second signaling occasion, and a second monitor interval that succeeds a last slot corresponding to a last cell DTX cycle based on a cell DTX deactivation via the second signaling occasion; or the at least two transmit intervals include at least one of a first transmit interval that precedes a first slot corresponding to a first cell DRX cycle based on a cell DRX activation via the second signaling occasion, and a second transmit interval that succeeds a last slot corresponding to a last DRX cycle based on a cell DRX deactivation via the second signaling occasion; at least one of: one or more signals received in the at least two monitor intervals are based at least in part on aperiodic triggering, wherein aperiodic triggering for one or more signals received in a first monitor interval of the at least two monitor intervals is inferred from cell DTX activation via the second signaling occasion, and aperiodic triggering one or more signals received in a second monitor interval of the at least two monitor intervals is inferred from cell DTX deactivation via the second signaling occasion; or one or more signals transmitted in the at least two transmit intervals are based at least in part on aperiodic triggering.

In some implementations of the method and apparatuses described herein, aperiodic triggering for one or more signals transmitted in a first transmit interval of the at least two transmit intervals is inferred from cell DRX activation via the second signaling occasion, and aperiodic triggering one or more signals transmitted in a second transmit interval of the at least two transmit intervals is inferred from cell DRX deactivation via the second signaling occasion; at least one of: the at least two monitor intervals correspond to two on-duration periods within a same cell DTX cycle, wherein a monitor first interval is associated with a first slot offset value and a first on-duration timer value, and a second monitor interval is associated with a second slot offset value and a second on-duration timer value; or the at least two transmit intervals correspond to two on-duration periods within a same cell DRX cycle, wherein a transmit first interval is associated with a first slot offset value and a first on-duration timer value, and a second transmit interval is associated with a second slot offset value and a second on-duration timer value; at least one of: the cell discontinuous signaling configuration indicates two types of cell DTX cycles, a first type of cell DTX cycle corresponding to a long cell DTX cycle and a second type of cell DTX cycle corresponding to a short cell DTX cycle; or the cell discontinuous signaling configuration indicates two types of cell DRX cycles, a first type of cell DRX cycle corresponding to a long cell DRX cycle and a second type of cell DRX cycle corresponding to a short cell DRX cycle.

In some implementations of the method and apparatuses described herein, at least one of: a length of the long cell DTX cycle is an integer multiple of a length of the short cell DTX cycle, and a first slot offset value associated with a first on-duration timer of the long cell DTX cycle is equivalent to a second slot offset value associated with a second on-duration timer of the short cell DTX cycle, and a first on-duration timer value of the long cell DTX cycle is equivalent to a second first on-duration timer value of the short cell DTX cycle; or a length of the long cell DRX cycle is an integer multiple of a length of the short cell DRX cycle, and a first slot offset value associated with a first on-duration timer of the long cell DRX cycle is equivalent to a second slot offset value associated with a second on-duration timer of the short cell DRX cycle, and a first on-duration timer value of the long cell DRX cycle is equivalent to a second first on-duration timer value of the short cell DRX cycle.

In some implementations of the method and apparatuses described herein, at least one of: the long cell DTX cycle and the short cell DTX cycle are jointly triggered via the second signaling occasion; or the long cell DRX cycle and the short cell DRX cycle are jointly triggered via the second signaling occasion; at least one of: the at least two monitor intervals correspond to two on-duration periods associated with two alternating cell DTX cycles, wherein the first monitor interval is associated with a first slot offset value and a first on-duration timer value, and the second monitor interval is associated with a second slot offset value and a second on-duration timer value; or the at least two transmit intervals correspond to two on-duration periods associated with two alternating cell DRX cycles, wherein the first transmit interval is associated with a third slot offset value and a third on-duration timer value, and the second transmit interval is associated with a fourth slot offset value and a fourth on-duration timer value; at least one of: a signal associated with cell DTX is configured with two higher-layer DTX configurations, a first higher-layer DTX configuration corresponding to a period wherein cell DTX is deactivated, and a second higher-layer DTX configuration corresponding to the at least two monitor intervals associated with cell DTX being activated; or a signal associated with cell DRX is configured with two higher-layer DRX configurations, a first higher-layer DRX configuration corresponding to a period wherein cell DRX is deactivated, and a second higher-layer DRX configuration corresponding to the at least two monitor intervals associated with cell DRX being activated.

In some implementations of the method and apparatuses described herein, at least one of: inferring a trigger of a higher-layer configuration of the two higher-layer configurations from a trigger of one or more of cell DTX activation or cell DTX deactivation via the second signaling occasion; or inferring a trigger of a higher-layer configuration of the two higher-layer configurations from a trigger of one or more of cell DRX activation or cell DRX deactivation via the second signaling occasion; at least one of: a trigger of a higher-layer configuration of the two higher-layer configurations is based at least in part on a cell DTX-based command MAC CE; or a trigger of a higher-layer configuration of the two higher-layer configurations is based at least in part on a cell DRX-based command MAC-CE; at least one of: an ID value of a second higher-layer DTX configuration of the two higher-layer DTX configurations is indicated within at least one of the first signaling occasion or the second signaling occasion; or an ID value of a second higher-layer DRX configuration of the two higher-layer DRX configurations is indicated within at least one of the first signaling occasion or the second signaling occasion.

Some implementations of the method and apparatuses described herein may further include to receive a first signaling occasion including cell discontinuous signaling configuration and including at least one of: a cell DTX behavior including a cell DTX cycle in which a UE is not to monitor a first signal set corresponding to a cell DTX inactive period and at least two monitor intervals in which the UE is permitted to monitor the first signal set; or a cell DRX behavior including a cell DRX cycle in which the UE is not to transmit a second signal set corresponding to a cell DRX inactive period and at least two transmit intervals in which the UE is permitted to transmit the second signal set; receive a second signaling occasion activating the cell discontinuous signaling configuration; and perform at least one of to: monitor a first signal monitor group of the first signal set at a first monitor interval of the at least two monitor intervals, and monitor a second signal monitor group of the first signal set at a second monitor interval of the at least two monitor intervals based on the cell DTX behavior; or transmit a first signal transmit group of the second signal set at a first transmit interval of the at least two transmit intervals, and transmit a second signal transmit group of the second signal set at a second transmit interval of the at least two transmit intervals based on the cell DRX behavior.

In some implementations of the method and apparatuses described herein, a first subset of the first signal set includes at least one of SPS occasions including SPS PDSCH, one or more of periodic or semi-persistent CSI RS for CSI measurement associated with RI reporting, or PDCCH corresponding to DCI formats not associated with scheduling PDSCH or PUSCH; and a second subset of the first signal set includes at least one of SSB, SIB, PTRS, periodic or semi-persistent CSI-RS for BM, PRS, PDCCH scrambled with UE-specific radio network temporary identifier (RNTI), PDCCH in Type-3 CSS, PDCCH for RAR, PDCCH for msg4 hybrid automatic repeat request (HARQ) transmission; at least one of: the first signal monitor group includes the first subset of the first set signal set and the second signal monitor group includes the second subset of the first signal set.

In some implementations of the method and apparatuses described herein, the first signal monitor group includes the first subset of the first set signal set and the second subset of the first signal set, and the second signal monitor group includes the second subset of the first signal set; or the first signal monitor group and second signal monitor group each include the first subset of the first set signal set and the second subset of the first signal set; a first subset of the second signal set includes at least one of CG occasions including CG PUSCH, one or more of periodic or semi-persistent SRS not associated with positioning, one or more of periodic or semi-persistent CSI report over one or more of PUSCH or PUCCH, SR occasions; and a second subset of the second signal set includes at least one of SRS for positioning or HARQ-ACK feedback for SPS PDSCH.

In some implementations of the method and apparatuses described herein, at least one of: the first signal transmit group includes the first subset of the second set signal set and the second signal transmit group includes the second subset of the second signal set; the first signal transmit group includes the first subset of the second set signal set and the second subset of the second signal set, and the second signal transmit group includes the second subset of the second signal set; or the first signal transmit group and second signal transmit group each include the first subset of the second set signal set and the second subset of the second signal set; at least one of: the at least two monitor intervals include at least one of a first monitor interval that precedes a first slot corresponding to a first cell DTX cycle based on a cell DTX activation via the second signaling occasion, and a second monitor interval that succeeds a last slot corresponding to a last cell DTX cycle based on a cell DTX deactivation via the second signaling occasion; or the at least two transmit intervals include at least one of a first transmit interval that precedes a first slot corresponding to a first cell DRX cycle based on a cell DRX activation via the second signaling occasion, and a second transmit interval that succeeds a last slot corresponding to a last DRX cycle based on a cell DRX deactivation via the second signaling occasion.

In some implementations of the method and apparatuses described herein, at least one of: one or more signals received in the at least two monitor intervals are based at least in part on aperiodic triggering, wherein aperiodic triggering for one or more signals received in a first monitor interval of the at least two monitor intervals is inferred from cell DTX activation via the second signaling occasion, and aperiodic triggering one or more signals received in a second monitor interval of the at least two monitor intervals is inferred from cell DTX deactivation via the second signaling occasion; or one or more signals transmitted in the at least two transmit intervals are based at least in part on aperiodic triggering, wherein aperiodic triggering for one or more signals transmitted in a first transmit interval of the at least two transmit intervals is inferred from cell DRX activation via the second signaling occasion, and aperiodic triggering one or more signals transmitted in a second transmit interval of the at least two transmit intervals is inferred from cell DRX deactivation via the second signaling occasion.

In some implementations of the method and apparatuses described herein, at least one of: the at least two monitor intervals correspond to two on-duration periods within a same cell DTX cycle, wherein a monitor first interval is associated with a first slot offset value and a first on-duration timer value, and a second monitor interval is associated with a second slot offset value and a second on-duration timer value; or the at least two transmit intervals correspond to two on-duration periods within a same cell DRX cycle, wherein a transmit first interval is associated with a first slot offset value and a first on-duration timer value, and a second transmit interval is associated with a second slot offset value and a second on-duration timer value; at least one of: the cell discontinuous signaling configuration indicates two types of cell DTX cycles, a first type of cell DTX cycle corresponding to a long cell DTX cycle and a second type of cell DTX cycle corresponding to a short cell DTX cycle; or the cell discontinuous signaling configuration indicates two types of cell DRX cycles, a first type of cell DRX cycle corresponding to a long cell DRX cycle and a second type of cell DRX cycle corresponding to a short cell DRX cycle.

In some implementations of the method and apparatuses described herein, at least one of: a length of the long cell DTX cycle is an integer multiple of a length of the short cell DTX cycle, and a first slot offset value associated with a first on-duration timer of the long cell DTX cycle is equivalent to a second slot offset value associated with a second on-duration timer of the short cell DTX cycle, and a first on-duration timer value of the long cell DTX cycle is equivalent to a second first on-duration timer value of the short cell DTX cycle; or a length of the long cell DRX cycle is an integer multiple of a length of the short cell DRX cycle, and a first slot offset value associated with a first on-duration timer of the long cell DRX cycle is equivalent to a second slot offset value associated with a second on-duration timer of the short cell DRX cycle, and a first on-duration timer value of the long cell DRX cycle is equivalent to a second first on-duration timer value of the short cell DRX cycle; at least one of: the long cell DTX cycle and the short cell DTX cycle are jointly triggered via the second signaling occasion; or the long cell DRX cycle and the short cell DRX cycle are jointly triggered via the second signaling occasion.

In some implementations of the method and apparatuses described herein, at least one of: the at least two monitor intervals correspond to two on-duration periods associated with two alternating cell DTX cycles, wherein the first monitor interval is associated with a first slot offset value and a first on-duration timer value, and the second monitor interval is associated with a second slot offset value and a second on-duration timer value; or the at least two transmit intervals correspond to two on-duration periods associated with two alternating cell DRX cycles, wherein the first transmit interval is associated with a third slot offset value and a third on-duration timer value, and the second transmit interval is associated with a fourth slot offset value and a fourth on-duration timer value; at least one of: a signal associated with cell DTX is configured with two higher-layer DTX configurations, a first higher-layer DTX configuration corresponding to a period wherein cell DTX is deactivated, and a second higher-layer DTX configuration corresponding to the at least two monitor intervals associated with cell DTX being activated; or a signal associated with cell DRX is configured with two higher-layer DRX configurations, a first higher-layer DRX configuration corresponding to a period wherein cell DRX is deactivated, and a second higher-layer DRX configuration corresponding to the at least two monitor intervals associated with cell DRX being activated.

In some implementations of the method and apparatuses described herein, the at least one controller is configured to cause the processor to at least one of: infer a trigger of a higher-layer configuration of the two higher-layer configurations from a trigger of one or more of cell DTX activation or cell DTX deactivation via the second signaling occasion; or infer a trigger of a higher-layer configuration of the two higher-layer configurations from a trigger of one or more of cell DRX activation or cell DRX deactivation via the second signaling occasion; at least one of: a trigger of a higher-layer configuration of the two higher-layer configurations is based at least in part on a cell DTX-based command MAC CE; or a trigger of a higher-layer configuration of the two higher-layer configurations is based at least in part on a cell DRX-based command MAC-CE; at least one of: an ID value of a second higher-layer DTX configuration of the two higher-layer DTX configurations is indicated within at least one of the first signaling occasion or the second signaling occasion; or an ID value of a second higher-layer DRX configuration of the two higher-layer DRX configurations is indicated within at least one of the first signaling occasion or the second signaling occasion.

Some implementations of the method and apparatuses described herein may further include functionality to transmit, to a UE, a first signaling occasion including cell discontinuous signaling configuration and including at least one of: a cell DTX behavior including a cell DTX cycle in which the UE is not to monitor a first signal set corresponding to a cell DTX inactive period and at least two monitor intervals in which the UE is permitted to monitor the first signal set; or a cell DRX behavior including a cell DRX cycle in which the UE is not to transmit a second signal set corresponding to a cell DRX inactive period and at least two transmit intervals in which the UE is permitted to transmit the second signal set; and transmit, to the UE, a second signaling occasion activating the cell discontinuous signaling configuration.

In some implementations of the method and apparatuses described herein, a first subset of the first signal set includes at least one of SPS occasions including SPS PDSCH, one or more of periodic or semi-persistent CSI RS for CSI measurement associated with RI reporting, or PDCCH corresponding to DCI formats not associated with scheduling PDSCH or PUSCH; and a second subset of the first signal set includes at least one of SSB, SIB, PTRS, periodic or semi-persistent CSI-RS for BM, PRS, PDCCH scrambled with UE-specific radio network temporary identifier (RNTI), PDCCH in Type-3 CSS, PDCCH for RAR, PDCCH for msg4 hybrid automatic repeat request (HARQ) transmission.

In some implementations of the method and apparatuses described herein, a first subset of the second signal set includes at least one of CG occasions including CG PUSCH, one or more of periodic or semi-persistent SRS not associated with positioning, one or more of periodic or semi-persistent CSI report over one or more of PUSCH or PUCCH, SR occasions; and a second subset of the second signal set includes at least one of SRS for positioning or HARQ-ACK feedback for SPS PDSCH; at least one of: the at least two monitor intervals include at least one of a first monitor interval that precedes a first slot corresponding to a first cell DTX cycle based on a cell DTX activation via the second signaling occasion, and a second monitor interval that succeeds a last slot corresponding to a last cell DTX cycle based on a cell DTX deactivation via the second signaling occasion; or the at least two transmit intervals include at least one of a first transmit interval that precedes a first slot corresponding to a first cell DRX cycle based on a cell DRX activation via the second signaling occasion, and a second transmit interval that succeeds a last slot corresponding to a last DRX cycle based on a cell DRX deactivation via the second signaling occasion.

In some implementations of the method and apparatuses described herein, at least one of: the at least two monitor intervals correspond to two on-duration periods within a same cell DTX cycle, wherein a monitor first interval is associated with a first slot offset value and a first on-duration timer value, and a second monitor interval is associated with a second slot offset value and a second on-duration timer value; or the at least two transmit intervals correspond to two on-duration periods within a same cell DRX cycle, wherein a transmit first interval is associated with a first slot offset value and a first on-duration timer value, and a second transmit interval is associated with a second slot offset value and a second on-duration timer value; at least one of: the cell discontinuous signaling configuration indicates at least two types of cell DTX cycles, a first type of cell DTX cycle corresponding to a long cell DTX cycle and a second type of cell DTX cycle corresponding to a short cell DTX cycle; or the cell discontinuous signaling configuration indicates at least two types of cell DRX cycles, a first type of cell DRX cycle corresponding to a long cell DRX cycle and a second type of cell DRX cycle corresponding to a short cell DRX cycle.

In some implementations of the method and apparatuses described herein, at least one of: a length of the long cell DTX cycle is an integer multiple of a length of the short cell DTX cycle, and a first slot offset value associated with a first on-duration timer of the long cell DTX cycle is equivalent to a second slot offset value associated with a second on-duration timer of the short cell DTX cycle, and a first on-duration timer value of the long cell DTX cycle is equivalent to a second first on-duration timer value of the short cell DTX cycle; or a length of the long cell DRX cycle is an integer multiple of a length of the short cell DRX cycle, and a first slot offset value associated with a first on-duration timer of the long cell DRX cycle is equivalent to a second slot offset value associated with a second on-duration timer of the short cell DRX cycle, and a first on-duration timer value of the long cell DRX cycle is equivalent to a second first on-duration timer value of the short cell DRX cycle.

In some implementations of the method and apparatuses described herein, at least one of: the at least two monitor intervals correspond to two on-duration periods associated with two alternating cell DTX cycles, wherein the first monitor interval is associated with a first slot offset value and a first on-duration timer value, and the second monitor interval is associated with a second slot offset value and a second on-duration timer value; or the at least two transmit intervals correspond to two on-duration periods associated with two alternating cell DRX cycles, wherein the first transmit interval is associated with a third slot offset value and a third on-duration timer value, and the second transmit interval is associated with a fourth slot offset value and a fourth on-duration timer value; at least one of: a signal associated with cell DTX is configured with two higher-layer DTX configurations, a first higher-layer DTX configuration corresponding to a period wherein cell DTX is deactivated, and a second higher-layer DTX configuration corresponding to the at least two monitor intervals associated with cell DTX being activated; or a signal associated with cell DRX is configured with two higher-layer DRX configurations, a first higher-layer DRX configuration corresponding to a period wherein cell DRX is deactivated, and a second higher-layer DRX configuration corresponding to the at least two monitor intervals associated with cell DRX being activated.

In some implementations of the method and apparatuses described herein, at least one of: a trigger of a higher-layer configuration of the two higher-layer configurations is based at least in part on a cell DTX-based command MAC CE; or a trigger of a higher-layer configuration of the two higher-layer configurations is based at least in part on a cell DRX-based command MAC-CE; at least one of: an ID value of a second higher-layer DTX configuration of the two higher-layer DTX configurations is indicated within at least one of the first signaling occasion or the second signaling occasion; or an ID value of a second higher-layer DRX configuration of the two higher-layer DRX configurations is indicated within at least one of the first signaling occasion or the second signaling occasion.

Some implementations of the method and apparatuses described herein may further include transmitting, to a UE, a first signaling occasion including cell discontinuous signaling configuration and including at least one of: a cell DTX behavior including a cell DTX cycle in which the UE is not to monitor a first signal set corresponding to a cell DTX inactive period and at least two monitor intervals in which the UE is permitted to monitor the first signal set; or a cell DRX behavior including a cell DRX cycle in which the UE is not to transmit a second signal set corresponding to a cell DRX inactive period and at least two transmit intervals in which the UE is permitted to transmit the second signal set; and transmitting, to the UE, a second signaling occasion activating the cell discontinuous signaling configuration.

In some implementations of the method and apparatuses described herein, a first subset of the first signal set includes at least one of SPS occasions including SPS PDSCH, one or more of periodic or semi-persistent CSI RS for CSI measurement associated with RI reporting, or PDCCH corresponding to DCI formats not associated with scheduling PDSCH or PUSCH; and a second subset of the first signal set includes at least one of SSB, SIB, PTRS, periodic or semi-persistent CSI-RS for BM, PRS, PDCCH scrambled with UE-specific radio network temporary identifier (RNTI), PDCCH in Type-3 CSS, PDCCH for RAR, PDCCH for msg4 hybrid automatic repeat request (HARQ) transmission; a first subset of the second signal set includes at least one of CG occasions including CG PUSCH, one or more of periodic or semi-persistent SRS not associated with positioning, one or more of periodic or semi-persistent CSI report over one or more of PUSCH or PUCCH, SR occasions; and a second subset of the second signal set includes at least one of SRS for positioning or HARQ-ACK feedback for SPS PDSCH.

In some implementations of the method and apparatuses described herein, at least one of: the at least two monitor intervals include at least one of a first monitor interval that precedes a first slot corresponding to a first cell DTX cycle based on a cell DTX activation via the second signaling occasion, and a second monitor interval that succeeds a last slot corresponding to a last cell DTX cycle based on a cell DTX deactivation via the second signaling occasion; or the at least two transmit intervals include at least one of a first transmit interval that precedes a first slot corresponding to a first cell DRX cycle based on a cell DRX activation via the second signaling occasion, and a second transmit interval that succeeds a last slot corresponding to a last DRX cycle based on a cell DRX deactivation via the second signaling occasion; at least one of: the at least two monitor intervals correspond to two on-duration periods within a same cell DTX cycle, wherein a monitor first interval is associated with a first slot offset value and a first on-duration timer value, and a second monitor interval is associated with a second slot offset value and a second on-duration timer value; or the at least two transmit intervals correspond to two on-duration periods within a same cell DRX cycle, wherein a transmit first interval is associated with a first slot offset value and a first on-duration timer value, and a second transmit interval is associated with a second slot offset value and a second on-duration timer value.

In some implementations of the method and apparatuses described herein, at least one of: the cell discontinuous signaling configuration indicates at least two types of cell DTX cycles, a first type of cell DTX cycle corresponding to a long cell DTX cycle and a second type of cell DTX cycle corresponding to a short cell DTX cycle; or the cell discontinuous signaling configuration indicates at least two types of cell DRX cycles, a first type of cell DRX cycle corresponding to a long cell DRX cycle and a second type of cell DRX cycle corresponding to a short cell DRX cycle; at least one of: a length of the long cell DTX cycle is an integer multiple of a length of the short cell DTX cycle, and a first slot offset value associated with a first on-duration timer of the long cell DTX cycle is equivalent to a second slot offset value associated with a second on-duration timer of the short cell DTX cycle, and a first on-duration timer value of the long cell DTX cycle is equivalent to a second first on-duration timer value of the short cell DTX cycle; or a length of the long cell DRX cycle is an integer multiple of a length of the short cell DRX cycle, and a first slot offset value associated with a first on-duration timer of the long cell DRX cycle is equivalent to a second slot offset value associated with a second on-duration timer of the short cell DRX cycle, and a first on-duration timer value of the long cell DRX cycle is equivalent to a second first on-duration timer value of the short cell DRX cycle.

In some implementations of the method and apparatuses described herein, at least one of: the at least two monitor intervals correspond to two on-duration periods associated with two alternating cell DTX cycles, wherein the first monitor interval is associated with a first slot offset value and a first on-duration timer value, and the second monitor interval is associated with a second slot offset value and a second on-duration timer value; or the at least two transmit intervals correspond to two on-duration periods associated with two alternating cell DRX cycles, wherein the first transmit interval is associated with a third slot offset value and a third on-duration timer value, and the second transmit interval is associated with a fourth slot offset value and a fourth on-duration timer value; at least one of: a signal associated with cell DTX is configured with two higher-layer DTX configurations, a first higher-layer DTX configuration corresponding to a period wherein cell DTX is deactivated, and a second higher-layer DTX configuration corresponding to the at least two monitor intervals associated with cell DTX being activated; or a signal associated with cell DRX is configured with two higher-layer DRX configurations, a first higher-layer DRX configuration corresponding to a period wherein cell DRX is deactivated, and a second higher-layer DRX configuration corresponding to the at least two monitor intervals associated with cell DRX being activated.

In some implementations of the method and apparatuses described herein, at least one of: a trigger of a higher-layer configuration of the two higher-layer configurations is based at least in part on a cell DTX-based command MAC CE; or a trigger of a higher-layer configuration of the two higher-layer configurations is based at least in part on a cell DRX-based command MAC-CE; at least one of: an ID value of a second higher-layer DTX configuration of the two higher-layer DTX configurations is indicated within at least one of the first signaling occasion or the second signaling occasion; or an ID value of a second higher-layer DRX configuration of the two higher-layer DRX configurations is indicated within at least one of the first signaling occasion or the second signaling occasion.

Some implementations of the method and apparatuses described herein may further include functionality to receive a first signaling occasion including cell discontinuous signaling configuration including at least one of: a cell DTX behavior including a plurality of DTX cycles, a DTX cycle including a period of time in which the UE is not to monitor a first set of downlink (DL) signals except for a first on-duration period configured in each DTX cycle, and a first DL signal in the first set of DL signals occupies a first set of multiple slots that overlap at least in part with slots of the DTX cycle excluding the first on-duration period; or a cell DRX behavior including a plurality of DRX cycles, a DRX cycle including a period of time in which the UE is not to transmit a second set of uplink (UL) signals except for a second on-duration period configured in each DRX cycle, and a second UL signal in the second set of UL signals occupies a second set of multiple slots that overlap at least in part with slots of the DRX cycle excluding the second on-duration period; receive a second signaling occasion activating the cell discontinuous signaling configuration; and perform at least one of to: monitor, based at least in part on the cell DTX behavior, the first DL signal based at least in part on a type of the first DL signal and a first overlapping pattern between the first set of multiple slots and the slots of the DTX cycle excluding the first on-duration period; or transmit, based at least in part on the cell DRX behavior, the second UL signal based at least in part on a type of the second UL signal and a second overlapping pattern between the second set of multiple slots and the slots of the DRX cycle excluding the second on-duration period.

In some implementations of the method and apparatuses described herein, at least one of: the first overlapping pattern corresponds to at least a first slot over which a first DL signal is configured and overlaps with the DTX cycle excluding the first on-duration period, and subsequent slots over which the first DL signal do not overlap with the DTX cycle excluding the first on-duration period; or the second overlapping pattern corresponds to at least a second slot over which the second UL signal is configured, overlaps with the DRX cycle excluding the second on-duration period, and subsequent slots over which the second UL signal do not overlap with the DRX cycle excluding the second on-duration period; the at least one processor is configured to cause the UE to least one of: not monitor the first DL signal; or not transmit the second UL signal; at least one of: the first overlapping pattern corresponds to at least a first slot over which the first DL signal is configured and does not overlap with the DTX cycle excluding the first on-duration period; or the second overlapping pattern corresponds to at least a first slot over which the second UL signal is configured and does not overlap with the DRX cycle excluding the second on-duration period.

In some implementations of the method and apparatuses described herein, the at least one processor is configured to cause the UE to at least one of: monitor the first DL signal; or transmit the second UL signal; the first DL signal includes at least one of: one or more of a periodic or semi-persistent CSI RS associated with a jointly configured non-zero power (NZP) CSI-RS resource pair and two resource groups occupying two consecutive slots; a periodic or semi-persistent CSI-RS associated with a plurality of NZP CSI-RS resources associated with a CSI reporting setting configured with a joint transmission precoder matrix indicator (PMI) codebook type; or a SPS PDSCH configured with a repetition scheme set to time-division multiplexing (TDM) over multiple slots; the second UL signal includes at least one of: a periodic or semi-persistent SRS associated with a usage value set to antenna switching over more than one slot; a PUCCH configured with an inter-slot repetition pattern; or a PUSCH configured with a repetition pattern over multiple slots.

In some implementations of the method and apparatuses described herein, at least one of: the first DL signal is associated with a repetition pattern including multiple transmissions of a same DL signal content from a network over the first set of multiple slots; or the second UL signal is associated with a repetition pattern including multiple scheduled transmissions of a same UL signal content from the UE over the second set of the multiple slots; the first DL signal includes at least a PDSCH configured with a repetition scheme set to TDM over multiple slots; the second UL signal includes at least one of: a PUCCH configured with inter-slot repetition; or a PUSCH configured with repetition type B over multiple slots; at least one of: the first overlapping pattern corresponds to a first subset of the multiple transmissions from the network that overlaps with the DTX cycle excluding the first on-duration period and a second subset of the multiple transmissions from the network does not overlap with the DTX cycle excluding the first on-duration period; or the second overlapping pattern corresponds to a third subset of the multiple scheduled transmissions and overlaps with the DRX cycle excluding the second on-duration period, and a fourth subset of the multiple scheduled transmissions does not overlap with the DRX cycle excluding the second on-duration period.

In some implementations of the method and apparatuses described herein, the at least one processor is configured to cause the UE to at least one of: not monitor the first subset of the multiple transmissions from the network, and to monitor the second subset of the multiple transmissions from the network; or not transmit the third subset of the multiple scheduled transmissions and transmit the fourth subset of the multiple scheduled transmissions; at least one of: the first DL signal is associated with multiple transmissions of different DL signal content from a network over the first set of multiple slots; or the second UL signal is associated with multiple scheduled transmissions of different UL signal content from the UE over the second set of multiple slots; the first DL signal includes at least one of: a periodic or semi-persistent CSI RS associated with a jointly configured NZP CSI-RS resource pair and two resource groups occupying two consecutive slots; or a periodic or semi-persistent CSI-RS associated with a plurality of NZP CSI-RS resources associated with a CSI reporting setting configured with a joint transmission PMI codebook type.

In some implementations of the method and apparatuses described herein, the second UL signal includes at least a periodic or semi-persistent SRS associated with a usage value set to antenna switching over more than one slot; at least one of: the first overlapping pattern corresponds to a first subset of the multiple transmissions and overlaps with the DTX cycle excluding the first on-duration period, and a second subset of the multiple transmissions does not overlap with the DTX cycle excluding the first on-duration period; or the second overlapping pattern corresponds to a third subset of the multiple scheduled transmissions and overlaps with the DRX cycle excluding the second on-duration period, and a fourth subset of the multiple transmissions does not overlap with the DRX cycle excluding the second on-duration period; the at least one processor is configured to cause the UE to at least one of: not monitor the first DL signal; or not transmit the second UL signal; the first DL signal is a periodic or semi-persistent NZP CSI RS associated with a CSI reporting setting configured with one or more of a time restriction for channel measurements configuration set to disabled or a time restriction for interference measurements configuration set to disabled; the at least one processor is configured to cause the UE to ignore the time restriction for channel measurements configuration and the time restriction for interference measurements configuration from the CSI reporting setting, and assume time restriction for channel measurements configuration and time restriction for interference measurements configuration; the first DL signal occupies a single slot for each transmission occasion.

Some implementations of the method and apparatuses described herein may further include receiving a first signaling occasion including cell discontinuous signaling configuration including at least one of: a cell DTX behavior including a plurality of DTX cycles, a DTX cycle including a period of time in which the UE is not to monitor a first set of DL signals except for a first on-duration period configured in each DTX cycle, and a first DL signal in the first set of DL signals occupies a first set of multiple slots that overlap at least in part with slots of the DTX cycle excluding the first on-duration period; or a cell DRX behavior including a plurality of DRX cycles, a DRX cycle including a period of time in which the UE is not to transmit a second set of UL signals except for a second on-duration period configured in each DRX cycle, and a second UL signal in the second set of UL signals occupies a second set of multiple slots that overlap at least in part with slots of the DRX cycle excluding the second on-duration period; receiving a second signaling occasion activating the cell discontinuous signaling configuration; and performing at least one of to: monitoring, based at least in part on the cell DTX behavior, the first DL signal based at least in part on a type of the first DL signal and a first overlapping pattern between the first set of multiple slots and the slots of the DTX cycle excluding the first on-duration period; or transmitting, based at least in part on the cell DRX behavior, the second UL signal based at least in part on a type of the second UL signal and a second overlapping pattern between the second set of multiple slots and the slots of the DRX cycle excluding the second on-duration period.

In some implementations of the method and apparatuses described herein, at least one of: the first overlapping pattern corresponds to at least a first slot over which a first DL signal is configured and overlaps with the DTX cycle excluding the first on-duration period, and subsequent slots over which the first DL signal do not overlap with the DTX cycle excluding the first on-duration period; or the second overlapping pattern corresponds to at least a second slot over which the second UL signal is configured, overlaps with the DRX cycle excluding the second on-duration period, and subsequent slots over which the second UL signal do not overlap with the DRX cycle excluding the second on-duration period; further including at least one of: not monitoring the first DL signal; or not transmitting the second UL signal; at least one of: the first overlapping pattern corresponds to at least a first slot over which the first DL signal is configured and does not overlap with the DTX cycle excluding the first on-duration period; or the second overlapping pattern corresponds to at least a first slot over which the second UL signal is configured and does not overlap with the DRX cycle excluding the second on-duration period.

In some implementations of the method and apparatuses described herein, at least one of: monitoring the first DL signal; or transmitting the second UL signal; the first DL signal includes at least one of: one or more of a periodic or semi-persistent CSI RS associated with a jointly configured NZP CSI-RS resource pair and two resource groups occupying two consecutive slots; a periodic or semi-persistent CSI-RS associated with a plurality of NZP CSI-RS resources associated with a CSI reporting setting configured with a joint transmission PMI codebook type; or a SPS PDSCH configured with a repetition scheme set to TDM over multiple slots; the second UL signal includes at least one of: a periodic or semi-persistent SRS associated with a usage value set to antenna switching over more than one slot; a PUCCH configured with an inter-slot repetition pattern; or a PUSCH configured with a repetition pattern over multiple slots.

In some implementations of the method and apparatuses described herein, at least one of: the first DL signal is associated with a repetition pattern including multiple transmissions of a same DL signal content from a network over the first set of multiple slots; or the second UL signal is associated with a repetition pattern including multiple scheduled transmissions of a same UL signal content from the UE over the second set of the multiple slots; the first DL signal includes at least a PDSCH configured with a repetition scheme set to TDM over multiple slots; the second UL signal includes at least one of: a PUCCH configured with inter-slot repetition; or a PUSCH configured with repetition type B over multiple slots; at least one of: the first overlapping pattern corresponds to a first subset of the multiple transmissions from the network that overlaps with the DTX cycle excluding the first on-duration period and a second subset of the multiple transmissions from the network does not overlap with the DTX cycle excluding the first on-duration period; or the second overlapping pattern corresponds to a third subset of the multiple scheduled transmissions and overlaps with the DRX cycle excluding the second on-duration period, and a fourth subset of the multiple scheduled transmissions does not overlap with the DRX cycle excluding the second on-duration period.

In some implementations of the method and apparatuses described herein, at least one of: not monitoring the first subset of the multiple transmissions from the network, and to monitor the second subset of the multiple transmissions from the network; or not transmitting the third subset of the multiple scheduled transmissions and transmit the fourth subset of the multiple scheduled transmissions; at least one of: the first DL signal is associated with multiple transmissions of different DL signal content from a network over the first set of multiple slots; or the second UL signal is associated with multiple scheduled transmissions of different UL signal content from the UE over the second set of multiple slots; the first DL signal includes at least one of: a periodic or semi-persistent CSI RS associated with a jointly configured NZP CSI-RS resource pair and two resource groups occupying two consecutive slots; or a periodic or semi-persistent CSI-RS associated with a plurality of NZP CSI-RS resources associated with a CSI reporting setting configured with a joint transmission PMI codebook type.

In some implementations of the method and apparatuses described herein, the second UL signal includes at least a periodic or semi-persistent SRS associated with a usage value set to antenna switching over more than one slot; at least one of: the first overlapping pattern corresponds to a first subset of the multiple transmissions and overlaps with the DTX cycle excluding the first on-duration period, and a second subset of the multiple transmissions does not overlap with the DTX cycle excluding the first on-duration period; or the second overlapping pattern corresponds to a third subset of the multiple scheduled transmissions and overlaps with the DRX cycle excluding the second on-duration period, and a fourth subset of the multiple transmissions does not overlap with the DRX cycle excluding the second on-duration period; further including at least one of: not monitoring the first DL signal; or not transmitting the second UL signal; the first DL signal is a periodic or semi-persistent NZP CSI RS associated with a CSI reporting setting configured with one or more of a time restriction for channel measurements configuration set to disabled or a time restriction for interference measurements configuration set to disabled; further including ignoring the time restriction for channel measurements configuration and the time restriction for interference measurements configuration from the CSI reporting setting, and assuming time restriction for channel measurements configuration and time restriction for interference measurements configuration; the first DL signal occupies a single slot for each transmission occasion.

Some implementations of the method and apparatuses described herein may further include functionality to receive a first signaling occasion including cell discontinuous signaling configuration including at least one of: a cell DTX behavior including a plurality of DTX cycles, a DTX cycle including a period of time in which a UE is not to monitor a first set of DL signals except for a first on-duration period configured in each DTX cycle, and a first DL signal in the first set of DL signals occupies a first set of multiple slots that overlap at least in part with slots of the DTX cycle excluding the first on-duration period; or a cell DRX behavior including a plurality of DRX cycles, a DRX cycle including a period of time in which the UE is not to transmit a second set of UL signals except for a second on-duration period configured in each DRX cycle, and a second UL signal in the second set of UL signals occupies a second set of multiple slots that overlap at least in part with slots of the DRX cycle excluding the second on-duration period; receive a second signaling occasion activating the cell discontinuous signaling configuration; and perform at least one of to: monitor, based at least in part on the cell DTX behavior, the first DL signal based at least in part on a type of the first DL signal and a first overlapping pattern between the first set of multiple slots and the slots of the DTX cycle excluding the first on-duration period; or transmit, based at least in part on the cell DRX behavior, the second UL signal based at least in part on a type of the second UL signal and a second overlapping pattern between the second set of multiple slots and the slots of the DRX cycle excluding the second on-duration period.

In some implementations of the method and apparatuses described herein, at least one of: the first overlapping pattern corresponds to at least a first slot over which a first DL signal is configured and overlaps with the DTX cycle excluding the first on-duration period, and subsequent slots over which the first DL signal do not overlap with the DTX cycle excluding the first on-duration period; or the second overlapping pattern corresponds to at least a second slot over which the second UL signal is configured, overlaps with the DRX cycle excluding the second on-duration period, and subsequent slots over which the second UL signal do not overlap with the DRX cycle excluding the second on-duration period; the at least one controller is configured to cause the processor to least one of: not monitor the first DL signal; or not transmit the second UL signal; at least one of: the first overlapping pattern corresponds to at least a first slot over which the first DL signal is configured and does not overlap with the DTX cycle excluding the first on-duration period; or the second overlapping pattern corresponds to at least a first slot over which the second UL signal is configured and does not overlap with the DRX cycle excluding the second on-duration period; the at least one controller is configured to cause the processor to least one of: monitor the first DL signal; or transmit the second UL signal.

In some implementations of the method and apparatuses described herein, the first DL signal includes at least one of: one or more of a periodic or semi-persistent CSI RS associated with a jointly configured NZP CSI-RS resource pair and two resource groups occupying two consecutive slots; a periodic or semi-persistent CSI-RS associated with a plurality of NZP CSI-RS resources associated with a CSI reporting setting configured with a joint transmission PMI codebook type; or a SPS PDSCH configured with a repetition scheme set to TDM over multiple slots; the second UL signal includes at least one of: a periodic or semi-persistent SRS associated with a usage value set to antenna switching over more than one slot; a PUCCH configured with an inter-slot repetition pattern; or a PUSCH configured with a repetition pattern over multiple slots.

In some implementations of the method and apparatuses described herein, at least one of: the first DL signal is associated with a repetition pattern including multiple transmissions of a same DL signal content from a network over the first set of multiple slots; or the second UL signal is associated with a repetition pattern including multiple scheduled transmissions of a same UL signal content from the UE over the second set of the multiple slots; the first DL signal includes at least a PDSCH configured with a repetition scheme set to TDM over multiple slots; the second UL signal includes at least one of: a PUCCH configured with inter-slot repetition; or a PUSCH configured with repetition type B over multiple slots; at least one of: the first overlapping pattern corresponds to a first subset of the multiple transmissions from the network that overlaps with the DTX cycle excluding the first on-duration period and a second subset of the multiple transmissions from the network does not overlap with the DTX cycle excluding the first on-duration period; or the second overlapping pattern corresponds to a third subset of the multiple scheduled transmissions and overlaps with the DRX cycle excluding the second on-duration period, and a fourth subset of the multiple scheduled transmissions does not overlap with the DRX cycle excluding the second on-duration period.

In some implementations of the method and apparatuses described herein, the at least one controller is configured to cause the processor to least one of: not monitor the first subset of the multiple transmissions from the network, and to monitor the second subset of the multiple transmissions from the network; or not transmit the third subset of the multiple scheduled transmissions and transmit the fourth subset of the multiple scheduled transmissions; at least one of: the first DL signal is associated with multiple transmissions of different DL signal content from a network over the first set of multiple slots; or the second UL signal is associated with multiple scheduled transmissions of different UL signal content from the UE over the second set of multiple slots; the first DL signal includes at least one of: a periodic or semi-persistent CSI RS associated with a jointly configured NZP CSI-RS resource pair and two resource groups occupying two consecutive slots; or a periodic or semi-persistent CSI-RS associated with a plurality of NZP CSI-RS resources associated with a CSI reporting setting configured with a joint transmission PMI codebook type.

In some implementations of the method and apparatuses described herein, the second UL signal includes at least a periodic or semi-persistent SRS associated with a usage value set to antenna switching over more than one slot; at least one of: the first overlapping pattern corresponds to a first subset of the multiple transmissions and overlaps with the DTX cycle excluding the first on-duration period, and a second subset of the multiple transmissions does not overlap with the DTX cycle excluding the first on-duration period; or the second overlapping pattern corresponds to a third subset of the multiple scheduled transmissions and overlaps with the DRX cycle excluding the second on-duration period, and a fourth subset of the multiple transmissions does not overlap with the DRX cycle excluding the second on-duration period; the at least one controller is configured to cause the processor to least one of: not monitor the first DL signal; or not transmit the second UL signal; the first DL signal is a periodic or semi-persistent NZP CSI RS associated with a CSI reporting setting configured with one or more of a time restriction for channel measurements configuration set to disabled or a time restriction for interference measurements configuration set to disabled; the at least one controller is configured to cause the processor to least one of ignore the time restriction for channel measurements configuration and the time restriction for interference measurements configuration from the CSI reporting setting, and assume time restriction for channel measurements configuration and time restriction for interference measurements configuration; the first DL signal occupies a single slot for each transmission occasion.

Some implementations of the method and apparatuses described herein may further include functionality to transmit a first signaling occasion including cell discontinuous signaling configuration including at least one of: a cell DTX behavior including a plurality of DTX cycles, a DTX cycle including a period of time in which a UE is not to monitor a first set of DL signals except for a first on-duration period configured in each DTX cycle, and a first DL signal in the first set of DL signals occupies a first set of multiple slots that overlap at least in part with slots of the DTX cycle excluding the first on-duration period; or a cell DRX behavior including a plurality of DRX cycles, a DRX cycle including a period of time in which the UE is not to transmit a second set of UL signals except for a second on-duration period configured in each DRX cycle, and a second UL signal in the second set of UL signals occupies a second set of multiple slots that overlap at least in part with slots of the DRX cycle excluding the second on-duration period; and transmit a second signaling occasion activating the cell discontinuous signaling configuration.

Some implementations of the method and apparatuses described herein may further include transmitting a first signaling occasion including cell discontinuous signaling configuration including at least one of: a cell DTX behavior including a plurality of DTX cycles, a DTX cycle including a period of time in which a UE is not to monitor a first set of DL signals except for a first on-duration period configured in each DTX cycle, and a first DL signal in the first set of DL signals occupies a first set of multiple slots that overlap at least in part with slots of the DTX cycle excluding the first on-duration period; or a cell DRX behavior including a plurality of DRX cycles, a DRX cycle including a period of time in which the UE is not to transmit a second set of UL signals except for a second on-duration period configured in each DRX cycle, and a second UL signal in the second set of UL signals occupies a second set of multiple slots that overlap at least in part with slots of the DRX cycle excluding the second on-duration period; and transmitting a second signaling occasion activating the cell discontinuous signaling configuration.

### BRIEF DESCRIPTION OF THE DRAWINGS

FIG. 1 illustrates an example of a wireless communications system in accordance with aspects of the present disclosure.

FIGS. 2, 3, 4 illustrate an example of DRX configuration information element (IE) in accordance with aspects of the present disclosure.

FIG. 5 illustrates example cell DTX cycles with a single on-duration period.

FIG. 6 illustrates aperiodic trigger state defining a list of CSI report settings.

FIG. 7 illustrates an example for aperiodic trigger state indicates the resource set and Quasi Co-Location (QCL) information.

FIG. 8 illustrates an example of aperiodic trigger state indicating the resource set and QCL information.

FIG. 9 illustrates an example of RRC configuration for: (a) NZP-CSI-RS Resource (b) CSI-IM-Resource.

FIG. 10 illustrates an example of partial CSI omission for PUSCH-Based CSI.

FIG. 11 illustrates an example of ASN-1 code for configuring an NZP-CSI-RS resource set.

FIG. 12 illustrates an example where four resources are single port with density 3.

FIG. 13 illustrates an example of ASN-1 code for QCL information.

FIG. 14 illustrates an example implementation in accordance with aspects of the present disclosure.

FIG. 15 illustrates an example implementation in accordance with aspects of the present disclosure.

FIG. 16 illustrates an example implementation in accordance with aspects of the present disclosure.

FIG. 17 illustrates an example implementation in accordance with aspects of the present disclosure.

FIG. 18 illustrates an example implementation in accordance with aspects of the present disclosure.

FIG. 19 illustrates an example implementation in accordance with aspects of the present disclosure.

FIG. 20 illustrates an example implementation in accordance with aspects of the present disclosure.

FIG. 21 illustrates an example implementation in accordance with aspects of the present disclosure.

FIG. 22 illustrates an example implementation in accordance with aspects of the present disclosure.

FIG. 23 illustrates an example implementation in accordance with aspects of the present disclosure.

FIG. 24 illustrates an example implementation in accordance with aspects of the present disclosure.

FIG. 25 illustrates an example implementation in accordance with aspects of the present disclosure.

FIG. 26 illustrates an example of a UE 2600 in accordance with aspects of the present disclosure.

FIG. 27 illustrates an example of a processor 2700 in accordance with aspects of the present disclosure.

FIG. 28 illustrates an example of a network equipment (NE) 2800 in accordance with aspects of the present disclosure.

FIG. 29 illustrates a flowchart of a method performed by a UE in accordance with aspects of the present disclosure.

FIG. 30 illustrates a flowchart of a method performed by a UE in accordance with aspects of the present disclosure.

FIG. 31 illustrates a flowchart of a method performed by a NE in accordance with aspects of the present disclosure.

FIG. 32 illustrates a flowchart of a method performed by a NE in accordance with aspects of the present disclosure.

### DETAILED DESCRIPTION

In wireless communications systems one of the fundamental challenges towards more efficient network implementation is energy consumption. While devices at the user end are usually perceived as the main target for further energy savings, the need for further reduction on energy consumption at the network end is gaining more traction owing to higher running costs and the lack of ubiquitous energy supply from renewable energy sources. For instance, renewable energy sources are becoming more widely implemented due to environmental regulations and enterprise initiatives to cut carbon emissions. One way of achieving such network energy savings is via cell DTX and/or cell DRX wherein a cell suspends the transmission and/or reception of a selected set of signals and/or channels (referred to herein as “signals”) for a configured period of time for the sake of energy saving. One downside of cell DTX and/or DRX can be degraded network performance due to the inactivity of the cell during cell DTX and/or cell DRX inactive periods.

In some conventional cell DTX/DRX frameworks a straightforward application of cell DTX/DRX is based on configuring cell DTX/DRX via cycle and on-duration timer values that have the same range of values as C-DRX. One drawback to such an approach is that the periodicity of different signals may not be aligned with the on-duration intervals across different cycles, leading to a given signal to not be signaled for much longer than a cell DTX/DRX cycle time. Another approach uses aperiodic signal configuration at the beginning and/or end of cell DTX/DRX active period. For instance, a UE is configured with an aperiodic signal right before the cell DTX/DRX inactive period and/or right after cell DTX/DRX inactive period. One drawback to such an approach is large overhead since aperiodic signals are configured via DCI. Moreover, some aperiodic signals are associated with high computational complexity, e.g., aperiodic CSI reporting can occupy a maximum CPU allocation of a UE.

As yet another approach a shorter cell DTX/DRX inactive periods can be implemented. For instance, CSI reporting is triggered based on network-monitored event (e.g., based on HARQ/ACK feedback) where a UE triggers a new CSI feedback report when a NACK is received. One drawback to such an approach is large delay incurred to report the updated CSI feedback, leading to possible PDSCH decoding error (e.g., reduced reliability) and additional PDSCH transmissions, e.g., reduced power efficiency per transport block (TB) due to HARQ-ACK based retransmissions.

Another example approach uses single-slot signal monitoring for cell DTX/DRX. For instance, discussions on cell DTX/DRX in Rel-18 have been focused on single-slots signals where a signal is monitored based on whether the single slot corresponding to the signal falls within a cell DTX/DRX in active period. One drawback to such an approach is occurs in scenarios where a signal occupies multiple slots (e.g., CSI-RS for multi-TRP, PUSCH with repetition Type B) and may occupy slots that partially overlap with cell DTX/DRX inactive periods. No explicit UE behavior is defined for these scenarios.

Accordingly, the present disclosure discusses methods for reducing the impact of cell DTX and/or cell DRX configuration on the wireless performance. The described techniques, for instance, reconfigure the signals that are impacted during inactive times to alleviate system performance degradation via accelerated and more rapid signaling in the active periods that succeed and/or precede the cell DTX/DRX inactive periods. More specifically, the present disclosure proposes an enhanced cell DTX/DRX configuration that includes the following:
1. Autonomous reconfiguration periodic and/or semi-persistent signal transmission and/or reception in cell DTX/DRX active periods that immediately precede or succeed the cell DTX/DRX inactive periods.
2. Aperiodic signal transmission and/or reception that is conditioned on configuring cell DTX/DRX where the aperiodic signal transmission is configured to occupy cell DTX/DRX active periods that immediately precede or succeed the cell DTX/DRX inactive periods.
3. Alternating cell DTX/DRX mode via configuring the UE with two distinct on-duration timer values that take on alternating cell DTX/DRX cycles. For instance, a first of the two on-duration periods is accessible to signals impacted by DTX/DRX and a second of the two on-duration periods is accessible to a subset of the impacted signals that can benefit from more frequent transmission and/or reception for more robust network performance.
4. Defining UE behavior for cell DTX/DRX corresponding to impact on signals that occupy multiple slots where signals whose transmission and/or reception starts before a cell DTX/DRX inactive time are still monitored even if subsequent transmissions and/or receptions are in the inactive period.
5. Defining UE behavior for cell DTX/DRX corresponding to impact on signals that occupy multiple slots where signals whose transmission and/or reception start during a cell DTX/DRX inactive time are not monitored even if subsequent transmissions and/or receptions are in the active period.
6. Defining UE behavior for cell DTX/DRX corresponding to impact on signals that occupy multiple slots where signals are monitored based on whether or not the signal occupying multiple slots is a repetition signal.

Accordingly, implementations discussed in the present disclosure enable energy savings in wireless networks while reducing negative impacts of energy saving techniques, and thus the described implementations can improve performance across wireless networks.

Aspects of the present disclosure are described in the context of a wireless communications system.

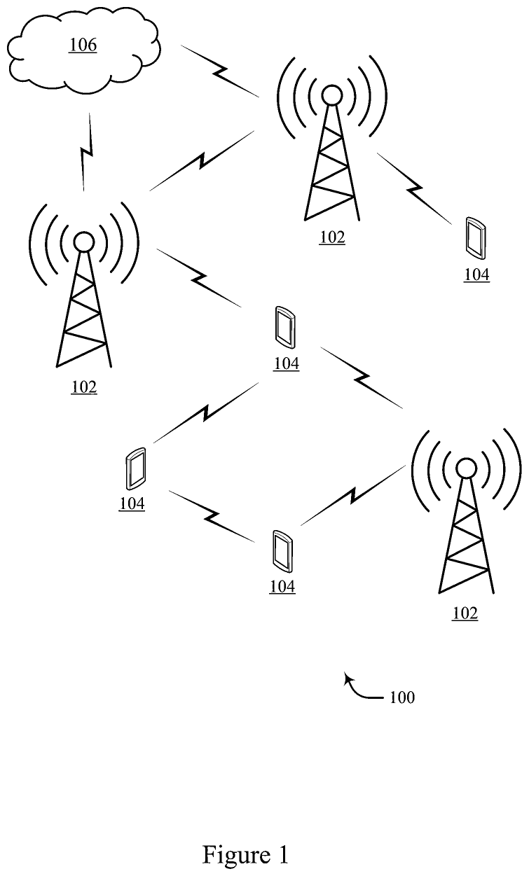

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (e.g., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (e.g., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., Orthogonal Frequency Division Multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHZ), FR4 (52.6 GHZ-114.25 GHZ), FR4a or FR4-1 (52.6 GHz-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a NE 102 (e.g., a base station) communicates cell discontinuous signaling configuration to a UE 104 including cell DTX behavior and/or cell DRX behavior. The UE 104 can utilize the cell discontinuous signaling configuration to adapt signal monitoring and/or signal transmission at the UE such as described herein.

With reference to DRX for UE, a MAC entity may be configured by radio resource control (RRC) with a DRX functionality that controls the UE's PDCCH monitoring activity for the MAC entity's cell radio network temporary identifier (C-RNTI), CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SLCS-RNTI and sidelink (SL) Semi-Persistent Scheduling V-RNTI. When in RRC_CONNECTED, and if DRX is configured, for all the activated Serving Cells the MAC entity may monitor the PDCCH discontinuously using the specified DRX operation; otherwise the MAC entity can monitor the PDCCH as specified in 3GPP Technical Specification (TS) 38.213.

RRC controls DRX operation by configuring the following parameters:
drx-onDurationTimer: the duration at the beginning of a DRX cycle;
drx-SlotOffset: the delay before starting the drx-onDuration Timer;
drx-InactivityTimer: the duration after the PDCCH occasion in which a PDCCH indicates a new UL, DL or SL transmission for the MAC entity;
drx-RetransmissionTimerDL (per DL HARQ process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX cycle starts;
drx-ShortCycle (optional): the Short DRX cycle;
drx-ShortCycleTimer (optional): the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
drx-Retransmission TimerSL (per SL HARQ process): the maximum duration until a grant for SL retransmission is received;
drx-HARQ-RTT-TimerSL (per SL HARQ process): the minimum duration before an SL retransmission grant is expected by the MAC entity;
ps-Wakeup (optional): the configuration to start associated drx-onDurationTimer in case Data Convergence Protocol (DCP) is monitored but not detected;
ps-TransmitOtherPeriodicCSI (optional): the configuration to report periodic CSI that is not L1-Reference Signal Received Power (RSRP) on PUCCH during the time duration indicated by drx-onDurationTimer in case DCP is configured but associated drx-onDurationTimer is not started;
ps-TransmitPeriodicL1-RSRP (optional): the configuration to transmit periodic CSI that is L1-RSRP on PUCCH during the time duration indicated by drx-onDuration Timer in case DCP is configured but associated drx-onDurationTimer is not started;
downlinkHARQ-FeedbackDisabled (optional): the configuration to disable HARQ feedback per DL HARQ process;
uplinkHARQ-Mode (optional): the configuration to set HARQmodeA or HARQmodeB per UL HARQ process.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are: drx-onDurationTimer, drx-InactivityTimer. The DRX parameters that are common to the DRX groups are: drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, and drx-HARQ-RTT-TimerUL.

When DRX is configured, the Active Time for Serving Cells in a DRX group includes the time while:
drx-onDurationTimer or drx-InactivityTimer configured for the DRX group is running;
or
drx-RetransmissionTimerDL, drx-RetransmissionTimerUL or drx-RetransmissionTimerSL is running on any Serving Cell in the DRX group; or
ra-ContentionResolutionTimer or msgB-ResponseWindow is running; or
a Scheduling Request is sent on PUCCH and is pending. If this Serving Cell is part of a non-terrestrial network, the Active Time is started after the Scheduling Request transmission that is performed when the SR_COUNTER is 0 for all the SR configurations with pending SR(s) plus the UE-gNB Round Trip Time (RTT); or
a PDCCH indicating a new transmission addressed to the C-RNTI of the MAC entity has not been received after successful reception of a Random Access Response for the Random Access Preamble not selected by the MAC entity among the contention-based Random Access Preamble.

The following MAC timers are used for DRX operation in a non-terrestrial network:
HARQ-RTT-TimerDL-NTN (per DL HARQ process configured with HARQ feedback enabled): the minimum duration before a DL assignment for HARQ retransmission is expected by the MAC entity;
HARQ-RTT-TimerUL-NTN (per UL HARQ process configured with HARQModeA): the minimum duration before a UL HARQ retransmission grant is expected by the MAC entity.

When DRX is not configured and multicast DRX is configured for a G-RNTI or G-CS-RNTI, the MAC entity can:
1> monitor the PDCCH as specified in 3GPP TS 38.213;
1> if a MAC PDU is received in a configured downlink assignment for unicast; or
1> if the PDCCH indicates a DL unicast transmission:
   2> stop the drx-RetransmissionTimerDL-PTM for the corresponding HARQ process.

When DRX is configured, the MAC entity can:
1> if a MAC PDU is received in a configured downlink assignment for unicast:
   2> if this Serving Cell is configured with downlinkHARQ-FeedbackDisabled:
      3> if the corresponding HARQ process is configured with HARQ feedback enabled:
         4> set HARQ-RTT-TimerDL-NTN for the corresponding HARQ process equal to drx-HARQ-RTT-TimerDL plus the latest available UE-gNB RTT value;
         4> start the HARQ-RTT-TimerDL-NTN for the corresponding HARQ process in the first symbol after the end of the corresponding transmission carrying the DL HARQ feedback.
   2> else:
      3> start the drx-HARQ-RTT-TimerDL for the corresponding HARQ process in the first symbol after the end of the corresponding transmission carrying the DL HARQ feedback.
   2> stop the drx-RetransmissionTimerDL for the corresponding HARQ process;
   2> stop the drx-RetransmissionTimerDL-PTM for the corresponding HARQ process.
1> if a MAC PDU is transmitted in a configured uplink grant and listen before talk (LBT) failure indication is not received from lower layers:
   2> if this Serving Cell is configured with uplinkHARQ-Mode:
      3> if the corresponding HARQ process is configured as HARQModeA:
         4> set HARQ-RTT-TimerUL-NTN for the corresponding HARQ process equal to drx-HARQ-RTT-TimerUL plus the latest available UE-gNB RTT value;
         4> if drx-LastTransmissionUL is configured:
         5> start the HARQ-RTT-TimerUL-NTN for the corresponding HARQ process in the first symbol after the end of the last transmission (within a bundle) of the corresponding PUSCH transmission.
         4> else:
         5> start the HARQ-RTT-TimerUL-NTN for the corresponding HARQ process in the first symbol after the end of the first transmission (within a bundle) of the corresponding PUSCH transmission.
   2> else:
      3> if drx-LastTransmissionUL is configured:
         4> start the drx-HARQ-RTT-TimerUL for the corresponding HARQ process in the first symbol after the end of the last transmission (within a bundle) of the corresponding PUSCH transmission.
      3> else:
         4> start the drx-HARQ-RTT-TimerUL for the corresponding HARQ process in the first symbol after the end of the first transmission (within a bundle) of the corresponding PUSCH transmission.
   2> stop the drx-RetransmissionTimerUL for the corresponding HARQ process at the first transmission (within a bundle) of the corresponding PUSCH transmission.
1> if a MAC PDU is transmitted in a configured sidelink grant:
   2> if the PUCCH resource is configured:
      3> start the drx-HARQ-RTT-TimerSL for the corresponding HARQ process in the first symbol after the end of the corresponding PUCCH transmission carrying the SL HARQ feedback; or
      3> start the drx-HARQ-RTT-TimerSL for the corresponding HARQ process in the first symbol after the end of the corresponding PUCCH resource for the SL HARQ feedback when the PUCCH is not transmitted;
      3> stop the drx-RetransmissionTimerSL for the corresponding HARQ process.
   2> else:
      3> start the drx-HARQ-RTT-TimerSL for the corresponding HARQ process at the first symbol after the end of the corresponding physical sidelink shared channel (PSSCH) transmission;
      3> stop the drx-RetransmissionTimerSL for the corresponding HARQ process.
1> if a drx-HARQ-RTT-TimerDL expires:
   2> if the data of the corresponding HARQ process was not successfully decoded:
      3> start the drx-RetransmissionTimerDL for the corresponding HARQ process in the first symbol after the expiry of drx-HARQ-RTT-TimerDL.
1> if a HARQ-RTT-TimerDL-NTN expires:
   2> if the data of the corresponding HARQ process was not successfully decoded:
      3> start the drx-RetransmissionTimerDL for the corresponding HARQ process in the first symbol after the expiry of HARQ-RTT-TimerDL-NTN.
1> if a drx-HARQ-RTT-TimerUL expires:
   2> start the drx-RetransmissionTimerUL for the corresponding HARQ process in the first symbol after the expiry of drx-HARQ-RTT-TimerUL.
1> if a HARQ-RTT-TimerUL-NTN expires:
   2> start the drx-RetransmissionTimerUL for the corresponding HARQ process in the first symbol after the expiry of HARQ-RTT-TimerUL-NTN.
1> if a drx-HARQ-RTT-TimerSL expires:
   2> if a HARQ negative acknowledgement (NACK) feedback for the corresponding HARQ process is transmitted on PUCCH; or
   2> if a HARQ NACK feedback for the corresponding HARQ process is generated but not transmitted on PUCCH; or
   2> if the PUCCH resource is not configured for the SL grant:
      3> start the drx-RetransmissionTimerSL for the corresponding HARQ process in the first symbol after the expiry of drx-HARQ-RTT-TimerSL.

In implementations a UE can handle the drx-RetransmissionTimerSL operation when sl-PUCCH-Config is configured by RRC but PUCCH resource is not scheduled same as when sl-PUCCH-Config is not configured.
1> if a DRX Command MAC CE indicated by PDCCH addressed to C-RNTI or Configured Scheduling (CS)-RNTI, or by a configured downlink assignment for unicast transmission or a Long DRX Command MAC CE is received:
   2> stop drx-onDurationTimer for each DRX group;
   2> stop drx-InactivityTimer for each DRX group.
1> if drx-InactivityTimer for a DRX group expires:
   2> if the Short DRX cycle is configured:
      3> start or restart drx-ShortCycleTimer for this DRX group in the first symbol after the expiry of drx-InactivityTimer;
      3> use the Short DRX cycle for this DRX group.
   2> else:
      3> use the Long DRX cycle for this DRX group.
1> if a DRX Command MAC CE indicated by PDCCH addressed to C-RNTI or CS-RNTI, or by a configured downlink assignment for unicast transmission is received:
   2> if the Short DRX cycle is configured:
      3> start or restart drx-ShortCycleTimer for each DRX group in the first symbol after the end of DRX Command MAC CE reception;
      3> use the Short DRX cycle for each DRX group.
   2> else:
      3> use the Long DRX cycle for each DRX group.
1> if drx-ShortCycleTimer for a DRX group expires:
   2> use the Long DRX cycle for this DRX group.
1> if a Long DRX Command MAC CE is received:
   2> stop drx-ShortCycleTimer for each DRX group;
   2> use the Long DRX cycle for each DRX group.
1> if the Short DRX cycle is used for a DRX group, and [system frame number (SFN×10)+subframe number] modulo (drx-ShortCycle)=(drx-StartOffset) modulo (drx-ShortCycle):
   2> start drx-onDurationTimer for this DRX group after drx-SlotOffset from the beginning of the subframe.
1> if the Long DRX cycle is used for a DRX group, and [(SFN×10)+subframe number] modulo (drx-LongCycle)=drx-StartOffset:
   2> if DCP monitoring is configured for the active DL bandwidth part (BWP) as specified in 3GPP TS 38.213:
      3> if DCP indication associated with the current DRX cycle received from lower layer indicated to start drx-onDurationTimer, as specified in 3GPP TS 38.213; or
      3> if all DCP occasion(s) in time domain, as specified in 3GPP TS 38.213, associated with the current DRX cycle occurred in Active Time considering grants/assignments/DRX Command MAC CE/Long DRX Command MAC CE received and Scheduling Request sent until 4 ms prior to start of the last DCP occasion, or during a measurement gap, or when the MAC entity monitors for a PDCCH transmission on the search space indicated by recoverySearchSpaceId of the SpCell identified by the C-RNTI while the ra-Response Window is running; or
      3> if ps-Wakeup is configured with value true and DCP indication associated with the current DRX cycle has not been received from lower layers:
         4> start drx-onDurationTimer after drx-SlotOffset from the beginning of the subframe.
   2> else:
      3> start drx-onDurationTimer for this DRX group after drx-SlotOffset from the beginning of the subframe. If an unaligned SFN across carriers in a cell group, the SFN of the SpCell can be used to calculate the DRX duration.
1> if a DRX group is in Active Time:
   2> monitor the PDCCH on the Serving Cells in this DRX group as specified in 3GPP TS 38.213;
   2> if the PDCCH indicates a DL transmission; or
   2> if the PDCCH indicates a one-shot HARQ feedback as specified in 3GPP TS 38.213; or
   2> if the PDCCH indicates a retransmission of HARQ feedback as specified in 3GPP TS 38.213:
      3> if this Serving Cell is configured with downlinkHARQ-FeedbackDisabled:
         4> if the corresponding HARQ process is configured with HARQ feedback enabled:
         5> set HARQ-RTT-TimerDL-NTN for the corresponding HARQ process equal to drx-HARQ-RTT-TimerDL plus the latest available UE-gNB RTT value;
         5> start the HARQ-RTT-TimerDL-NTN for the corresponding HARQ process in the first symbol after the end of the corresponding transmission carrying the DL HARQ feedback.
      3> else:
         4> start or restart the drx-HARQ-RTT-TimerDL for the corresponding HARQ process(es) whose HARQ feedback is reported in the first symbol after the end of the corresponding transmission carrying the DL HARQ feedback. When HARQ feedback is postponed by PDSCH-to-HARQ_feedback timing indicating an inapplicable kl value, as specified in 3GPP TS 38.213, the corresponding transmission opportunity to send the DL HARQ feedback can be indicated in a later PDCCH requesting the HARQ-ACK feedback.
      3> stop the drx-RetransmissionTimerDL for the corresponding HARQ process(es) whose HARQ feedback is reported;
      3> stop the drx-RetransmissionTimerDL-PTM for the corresponding HARQ process;
      3> if the PDSCH-to-HARQ_feedback timing indicate an inapplicable kl value as specified in 3GPP TS 38.213:
         4> start the drx-RetransmissionTimerDL in the first symbol after the (end of the last) PDSCH transmission (within a bundle) for the corresponding HARQ process.
   2> if the PDCCH indicates a UL transmission:
      3> if this Serving Cell is configured with uplinkHARQ-Mode:
         4> if the corresponding HARQ process is configured as HARQModeA:
         5> set HARQ-RTT-TimerUL-NTN for the corresponding HARQ process equal to drx-HARQ-RTT-TimerUL plus the latest available UE-gNB RTT value;
         5> if drx-LastTransmissionUL is configured:
         6> start the HARQ-RTT-TimerUL-NTN for the corresponding HARQ process in the first symbol after the end of the last transmission (within a bundle) of the corresponding PUSCH transmission.
         5> else:
         6> start the HARQ-RTT-TimerUL-NTN for the corresponding HARQ process in the first symbol after the end of the first transmission (within a bundle) of the corresponding PUSCH transmission.
      3> else:
         4> if drx-LastTransmissionUL is configured:
         5> start the drx-HARQ-RTT-TimerUL for the corresponding HARQ process in the first symbol after the end of the last transmission (within a bundle) of the corresponding PUSCH transmission.
         4> else:
         5> start the drx-HARQ-RTT-TimerUL for the corresponding HARQ process in the first symbol after the end of the first transmission (within a bundle) of the corresponding PUSCH transmission.
      3> stop the drx-RetransmissionTimerUL for the corresponding HARQ process.
   2> if the PDCCH indicates an SL transmission:
      3> if the PUCCH resource is configured:
         4> start the drx-HARQ-RTT-TimerSL for the corresponding HARQ process in the first symbol after the end of the corresponding PUCCH transmission carrying the SL HARQ feedback; or
         4> start the drx-HARQ-RTT-TimerSL for the corresponding HARQ process in the first symbol after the end of the corresponding PUCCH resource for the SL HARQ feedback when the PUCCH is not transmitted;
         4> stop the drx-RetransmissionTimerSL for the corresponding HARQ process.
      3> else:
         4> start the drx-HARQ-RTT-TimerSL for the corresponding HARQ process at the first symbol after end of PDCCH occasion;
         4> stop the drx-RetransmissionTimerSL for the corresponding HARQ process.
   2> if the PDCCH indicates a new transmission (DL, UL or SL) on a Serving Cell in this DRX group:
      3> start or restart drx-InactivityTimer for this DRX group in the first symbol after the end of the PDCCH reception. A PDCCH indicating activation of SPS, configured grant type 2, or configured sidelink grant of configured grant Type 2 is considered to indicate a new transmission. If the PDCCH reception includes two PDCCH candidates from corresponding search spaces, as described in clause 10.1 in 38.213, start or restart drx-InactivityTimer for this DRX group in the first symbol after the end of the PDCCH candidate that ends later in time.
   2> if a HARQ process receives downlink feedback information and acknowledgement is indicated:
      3> stop the drx-RetransmissionTimerUL for the corresponding HARQ process.
1> if DCP monitoring is configured for the active DL BWP as specified in 3GPP TS 38.213; and
1> if the current symbol n occurs within drx-onDurationTimer duration; and 1> if drx-onDurationTimer associated with the current DRX cycle is not started as specified in this clause:
   2> if the MAC entity would not be in Active Time considering grants/assignments/DRX Command MAC CE/Long DRX Command MAC CE received and Scheduling Request sent until 4 ms prior to symbol n when evaluating all DRX Active Time conditions as specified in this clause; and
   2> if allowCSI-SRS-Tx-MulticastDRX-Active is not configured or, if all multicast DRXes would not be in Active Time considering multicast assignments/DRX Command MAC CE for multicast broadcast service (MBS) multicast received until 4 ms prior to symbol n when evaluating all DRX Active Time conditions and all multicast sessions are configured with multicast DRX:
      3> not transmit periodic SRS and semi-persistent SRS defined in 3GPP TS 38.214;
      3> not report semi-persistent CSI configured on PUSCH;
      3> if ps-TransmitPeriodicL1-RSRP is not configured with value true:
         4> not report periodic CSI that is L1-RSRP on PUCCH.
      3> if ps-TransmitOtherPeriodicCSI is not configured with value true:
         4> not report periodic CSI that is not L1-RSRP on PUCCH.
1> else:
   2> in current symbol n, if a DRX group would not be in Active Time considering grants/assignments scheduled on Serving Cell(s) in this DRX group and DRX Command MAC CE/Long DRX Command MAC CE received and Scheduling Request sent until 4 ms prior to symbol n when evaluating all DRX Active Time conditions as specified in this clause; and
   2> if allowCSI-SRS-Tx-MulticastDRX-Active is not configured or, in current symbol n, if all multicast DRXes corresponding to the DRX group would not be in Active Time considering multicast assignments/DRX Command MAC CE for MBS multicast received until 4 ms prior to symbol n when evaluating all DRX Active Time conditions as specified in Clause 5.7b and all multicast sessions corresponding to the DRX group are configured with multicast DRX:
      3> not transmit periodic SRS and semi-persistent SRS defined in 3GPP TS 38.214 in this DRX group;
      3> not report CSI on PUCCH and semi-persistent CSI configured on PUSCH in this DRX group.
   2> if CSI masking (csi-Mask) is setup by upper layers:
      3> in current symbol n, if drx-onDurationTimer of a DRX group would not be running considering grants/assignments scheduled on Serving Cell(s) in this DRX group and DRX Command MAC CE/Long DRX Command MAC CE received until 4 ms prior to symbol n when evaluating all DRX Active Time conditions as specified in this clause; and
      3> if allowCSI-SRS-Tx-MulticastDRX-Active is not configured or, in current symbol n, if drx-onDurationTimerPTM(s) of all multicast DRXes corresponding to the DRX group would not be running considering DRX Command MAC CE for MBS multicast received until 4 ms prior to symbol n when evaluating all DRX Active Time conditions as specified in Clause 5.7b and all multicast sessions corresponding to the DRX group are configured with multicast DRX:
         4> not report CSI on PUCCH in this DRX group.

If a UE multiplexes a CSI configured on PUCCH with other overlapping uplink control information (UCI) according to the procedure specified in 3GPP TS 38.213 and this CSI multiplexed with other UCI(s) would be reported on a PUCCH resource either outside DRX Active Time of the DRX group in which this PUCCH is configured or outside the on-duration period of the DRX group in which this PUCCH is configured if CSI masking is setup by upper layers, it is up to UE implementation whether to report this CSI multiplexed with other UCI.

Regardless of whether the MAC entity is monitoring PDCCH or not on the Serving Cells in a DRX group, the MAC entity can transmit HARQ feedback, aperiodic CSI on PUSCH, and aperiodic SRS defined in 3GPP TS 38.214 on the Serving Cells in the DRX group when such is expected. Further, the MAC entity need not monitor the PDCCH if it is not a complete PDCCH occasion (e.g. the Active Time starts or ends in the middle of a PDCCH occasion).

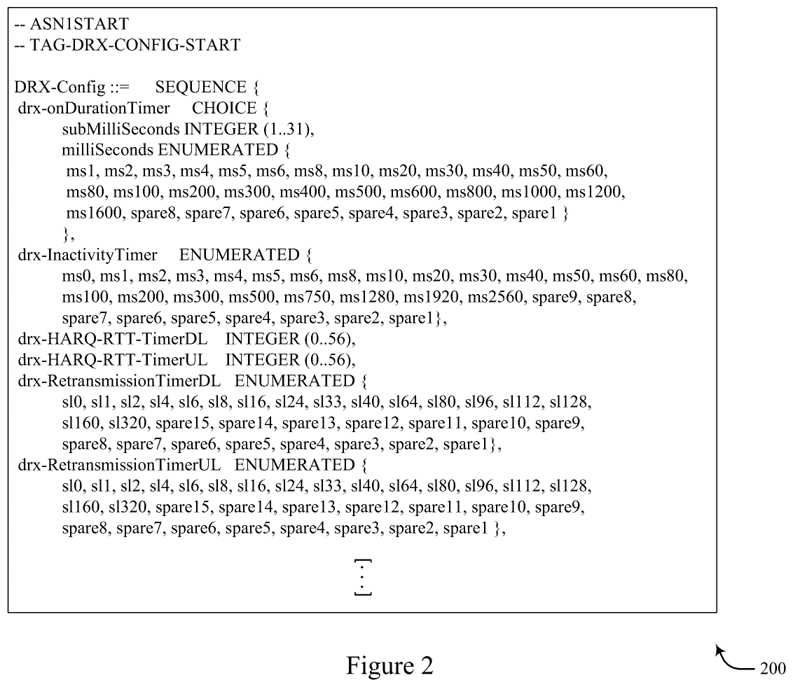

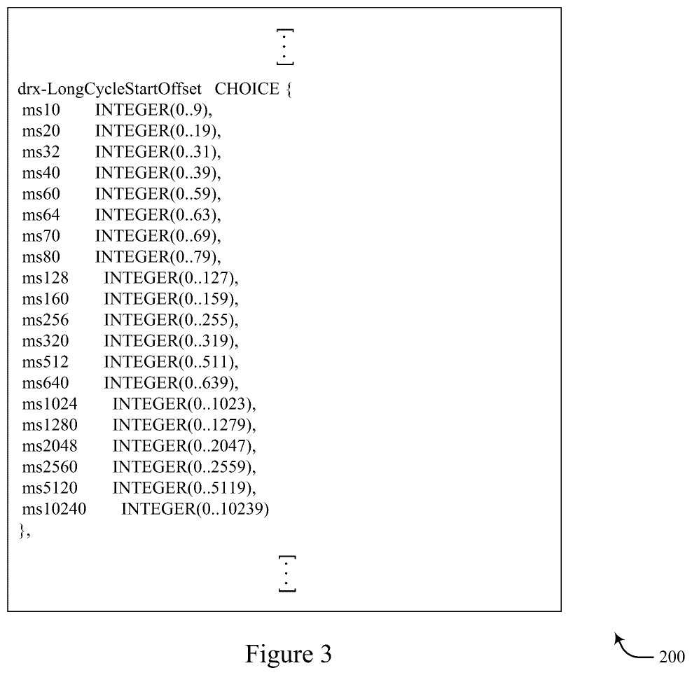

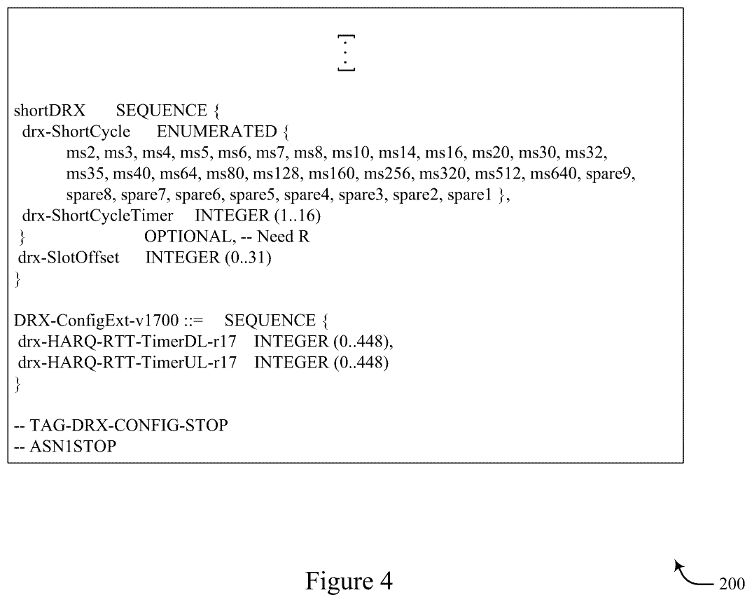

FIGS. 2, 3, 4 illustrate an example DRX configuration information element (IE) 200. The IE 200, for instance, illustrates Abstract Syntax Notation One (ASN-1) code for a DRX-Config IE. A description of fields of the DRX configuration IE 200 can be found in Table 1, below.

TABLE 1
DRX-Config IE field descriptions
DRX-Config field descriptions
drx-HARQ-RTT-TimerDL
Value in number of symbols of the BWP where the transport block was received. drx-HARQ-
RTT-TimerDL-r17 is only applicable for subcarrier spacing (SCS) 480 kHz and 960 kHz. If
configured, the UE shall ignore drx-HARQ-RTT-TimerDL (without suffix) for SCS 480 kHz and
960 kHz.
drx-HARQ-RTT-TimerUL
Value in number of symbols of the BWP where the transport block was transmitted. drx-HARQ-
RTT-TimerUL-r17 is only applicable for SCS 480 kHz and 960 kHz. If configured, the UE shall
ignore drx-HARQ-RTT-TimerUL (without suffix) for SCS 480 kHz and 960 kHz.
drx-InactivityTimer
Value in multiple integers of 1 ms. ms0 corresponds to 0, ms1 corresponds to 1 ms, ms2
corresponds to 2 ms, and so on.
drx-LongCycleStartOffset
drx-LongCycle in ms and drx-StartOffset in multiples of 1 ms. If drx-ShortCycle is configured,
the value of drx-LongCycle shall be a multiple of the drx-ShortCycle value.
drx-onDurationTimer
Value in multiples of 1/32 ms (subMilliSeconds) or in ms (milliSecond). For the latter, value ms1
corresponds to 1 ms, value ms2 corresponds to 2 ms, and so on.
drx-RetransmissionTimerDL
Value in number of slot lengths of the BWP where the transport block was received. value sl0
corresponds to 0 slots, sl1 corresponds to 1 slot, sl2 corresponds to 2 slots, and so on.
drx-RetransmissionTimerUL
Value in number of slot lengths of the BWP where the transport block was transmitted. sl0
corresponds to 0 slots, sl1 corresponds to 1 slot, sl2 corresponds to 2 slots, and so on.
drx-ShortCycleTimer
Value in multiples of drx-ShortCycle. A value of 1 corresponds to drx-ShortCycle, a value of 2
corresponds to 2 * drx-ShortCycle and so on.
drx-ShortCycle
Value in ms. ms1 corresponds to 1 ms, ms2 corresponds to 2 ms, and so on.
drx-SlotOffset
Value in 1/32 ms. Value 0 corresponds to 0 ms, value 1 corresponds to 1/32 ms, value 2
corresponds to 2/32 ms, and so on.

For cell DTX and/or DRX, a summary of Rel-18 based cell DTX/DRX is provided below. The following signals/channels may be impacted, e.g., by a UE not monitoring reception for DL signals/channels and/or not transmitting for UL signals/channels, by cell DTX/DRX, respectively, as follows:
1. A UE may not monitor SPS occasions during cell DTX non-active period, e.g., gNB is assumed to not transmit PDSCH to that UE on such SPS occasions during the Cell DTX non-active periods.
2. A UE may not transmit on CG occasions during cell DRX non-active periods.
3. A UE may not transmit SR occasions overlapping with Cell DRX non-active periods, e.g., SR transmissions are dropped during the cell DRX non-active periods.
4. A UE may not expect to receive and/or process periodic/semi-persistent CSI-RS configured in CSI report configuration in CSI-ReportConfig with reportQuantity including RI (for CSI reporting), during non-active periods of cell DTX.
5. A UE may not expect to transmit periodic/semi-persistent CSI reports during non-active periods of cell DRX.
6. A UE may not expect to transmit periodic/semi-persistent SRS during non-active periods of cell DRX, except when the SRS is for positioning.
7. A UE may not expect to monitor PDCCHs associated with DCI format 2_0-DCI Format 2_5, during non-active periods of cell DTX.

The following signals/channels are may not expected to be impacted by cell DTX/DRX, as follows:
1. No impact to random access channel (RACH), paging, and SIBs in idle/inactive for both gNB and Rel-18 and legacy UEs.
2. UE monitors PDCCH for RAR during Cell DTX non-active time. The ra-Response Window could be started as legacy.
3. UE monitors PDCCH for msg4 during Cell DTX non-active time. The ra-ContentionResolutionTimer could be started as legacy.
4. Once gNB recognizes there is an emergency call or public safety related service (e.g. MPS/MCS), the network ensures there is no impact to the emergency call (e.g., may deactivate cell DTX/DRX).
5. When an DG grant is received, by the gNB during cell DRX/DTX, the UE follows the grant assignment (e.g., like in legacy). This includes DL HARQ feedback.
6. HARQ-ACK of SPS PDSCH transmitted is not impacted by non-active period of cell DRX.
7. SRS for positioning is not impacted by cell DRX operation.
8. HARQ-ACK of a DCI format without scheduling a PDSCH is not impacted by non-active period of cell DRX.

For the supported cell DTX/DRX pattern, the following has been agreed:
1. Pattern configuration for cell DRX/DTX is common for Rel-18 UEs in the cell.
2. Separate DTX and DRX configuration are supported, e.g., cell DTX can be configured without cell DRX.
3. A periodic cell DTX/DRX configuration is explicitly signaled to the UEs.
4. A periodic cell DTX/DRX pattern is configured by UE specific RRC signaling.
5. The Cell DTX/DRX configuration contains at least: periodicity, start slot/offset, on duration.
6. Cell DTX/DRX is activated/deactivated implicitly by RRC signaling, e.g., activated immediately once configured by RRC and deactivated once the RRC configuration is released.
7. The start timer formula of the onDurationTimer from UE C-DRX (including SlotOffset) are to be reused to specify the start of cellDTX-onDurationTimer (and cellDRX-onDurationTimer) in 3GPP TS 38.321, which are expected to have the same value range as UE C-DRX Long cycle.
8. On-duration and cycle parameters are common between cell DTX and DRX, when both are configured.
9. If C-DRX is configured and the retransmission timer is running, the UE is expected to monitor PDCCH, like in legacy. It is up to the network whether it schedules retransmissions out of the Cell DTX active period, e.g., when the DRX retransmission timer is running, the UE should monitor PDCCH regardless of the Cell DTX.
10. The network ensures there is at least partial overlapping between UE C-DRX on-duration and cell DTX/DRX on-duration, e.g., via configuring the cell DTX/DRX and C-DRX periodicity to be a multiple of each other.

It was also agreed to support Layer-1 (L1) signaling for activation and deactivation of cell DTX/DRX. More specifically, the following has been agreed:
1. Pattern configuration for cell DRX/DTX is common for Rel-18 UEs in the cell.
2. The group common L1 signaling using PDCCH for cell DTX/DRX activation and deactivation is based on a new DCI format 2_X, which is monitored in the common search
space.

3. DCI format 2_X at least includes N information block field(s), each containing signaling of activation or deactivation of ‘a configuration of cell DTX and/or DRX’ of ‘a serving cell’. The DCI may also include spare/reserved padding bits to match the size configured for DCI 2_X, if needed. For serving cell configured with SUL, the same bit is applicable for both NUL and SUL.
4. For each serving cell configured with L1 signaling based activation/deactivation of cell DTX and/or cell DRX configuration, starting bit position of an information block of DCI format 2_X is provided by UE specific higher layer signaling.
5. An information block field of DCI format 2_X for activation and deactivation of cell DTX and DRX configuration supports separate (activation/deactivation) signaling for cell DTX and cell DRX, e.g., one activation/deactivation signaling sub-field for cell DTX configuration and one activation/deactivation signaling sub-field for cell DRX configuration, e.g., separate 1 bit indication for each of activation/deactivation for one cell DTX and one cell DRX.
6. An information block field of DCI format 2_X is variable size either 1 or 2 bits, based on whether higher layer signaling configures one or both cell DTX and cell DRX for a given serving cell. If both are configured, the first bit corresponds to activation/deactivation of cell DTX configuration, and the second bit corresponds to activation/deactivation of cell DRX configuration. Otherwise, the 1 bit corresponds to the configured cell DTX or cell DRX configuration.
7. DCI format 2_X supports activation/deactivation of cell DTX/DRX configuration of multiple serving cells and supports activation/deactivation per cell, wherein a UE monitors DCI format 2_X in one serving cell.
8. A new RNTI, e.g., nes-RNTI, which is configured by higher layer, for scrambling of DCI format 2_X.
9. Both the search space set configuration with new DCI format 2_X and the DCI size for DCI format 2_X are to be included to the RRC parameter list for new DCI format 2_X for activation and deactivation of cell DTX/DRX.
10. A delay value (D) that is applied after DCI Format 2_X reception that activates/deactivates cell DTX/DRX configuration is defined, where the UE is expected to apply cell DTX or DRX activation/deactivation change at beginning of the slot k where the SCS of slot X is with respect to the active DL or UL BWP of the serving cell, respectively. Slot k is the first slot whose beginning is no earlier than the beginning of slot n+D, where n is the slot containing the PDCCH of DCI format 2_X based on SCS of PDCCH, where the possible values of D with respect to SCS are provided in Table 2, below.

TABLE 2
Values of D with respect to SCS

| SCS of PDCCH | D (in |
|---|---|
| (kHz) | slots) |
| 15 | 3 |
| 30 | 6 |
| 60 | 12 |
| 120 | 24 |
| 480 | 96 |
| 960 | 192 |

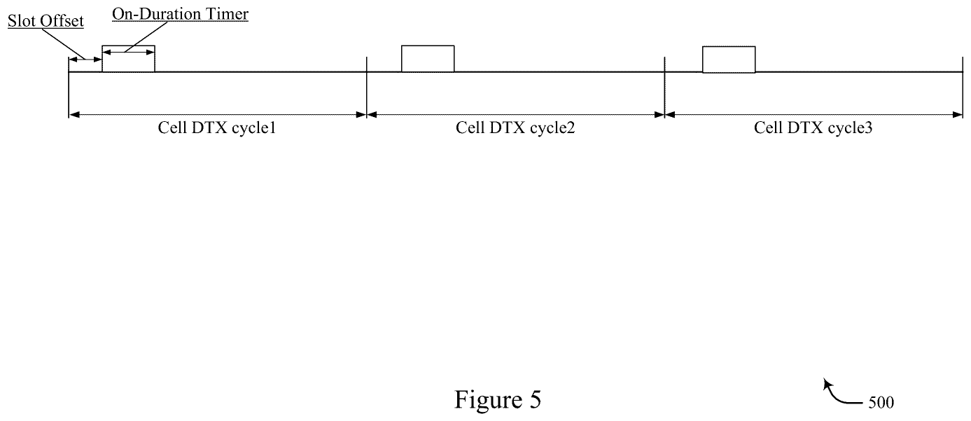

FIG. 5 illustrates at 500 example cell DTX cycles with a single on-duration period.

For CSI reporting triggering, a UE can report CSI information for the network using the CSI framework in NR Release 15. The triggering mechanism between a report setting and a resource setting can be summarized in Table 3 below.

TABLE 3
Triggering mechanism between a report setting and a resource setting

| | | | | Aperiodic |
|---|---|---|---|---|
| | | Periodic CSI | SP CSI | (AP) CSI |
| | | reporting | reporting | Reporting |
| Time Domain | Periodic | RRC configured | MAC CE | DCI |
| Behaviour of | CSI-RS | | (PUCCH) | |
| Resource | | | DCI (PUSCH) | |
| Setting | SP CSI-RS | Not Supported | MAC CE | DCI |
| | | | (PUCCH) | |
| | | | DCI (PUSCH) | |
| | AP CSI-RS | Not Supported | Not Supported | DCI |

In scenarios,
Associated Resource Settings for a CSI Report Setting may have same time domain behavior.
Periodic CSI-RS/Interference Management (IM) resource and CSI reports may be assumed to be present and active once configured by RRC.
Aperiodic and semi-persistent CSI-RS/IM resources and CSI reports may be explicitly triggered or activated.
Aperiodic CSI-RS/IM resources and aperiodic CSI reports, the triggering can be done jointly by transmitting a DCI Format 0-1.
Semi-persistent CSI-RS/IM resources and semi-persistent CSI reports can be independently activated.

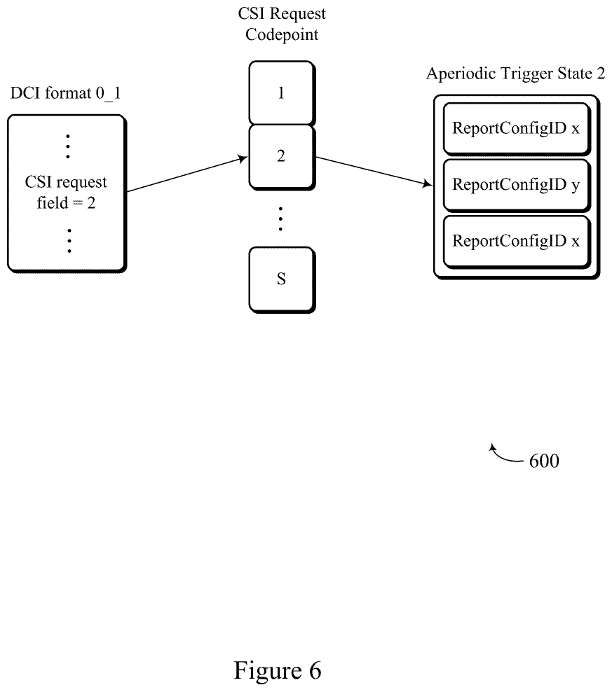

FIG. 6 illustrates at 600 aperiodic trigger state defining a list of CSI report settings. For aperiodic CSI-RS/IM resources and aperiodic CSI reports, the triggering can be done jointly by transmitting a DCI Format 0_1. The DCI Format 0_1 contains a CSI request field (0 to 6 bits). A non-zero request field points to a so-called aperiodic trigger state configured by RRC (see, e.g., FIG. 5). An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

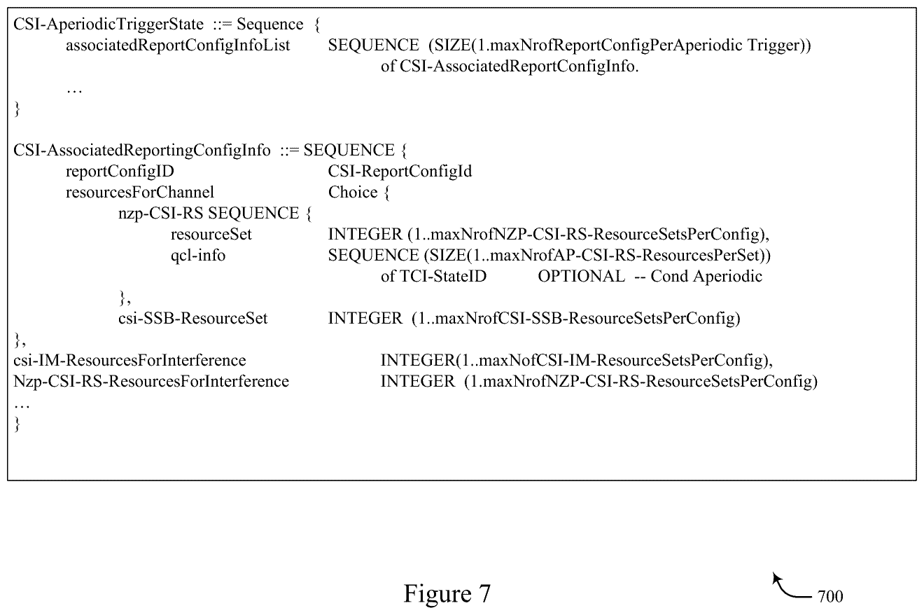

FIG. 7 illustrates at 700 an example for aperiodic trigger state indicates the resource set and Quasi Co-Location (QCL) information. For instance, when the CSI Report Setting is linked with aperiodic Resource Setting (can comprise multiple Resource Sets), the aperiodic NZP CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition such as illustrated in FIG. 6. For aperiodic NZP CSI-RS, the QCL source to use can also be configured in the aperiodic trigger state. The UE can assume that the resources used for the computation of the channel and interference can be processed with the same spatial filter e.g. quasi-co-located with respect to “QCL-TypeD.”

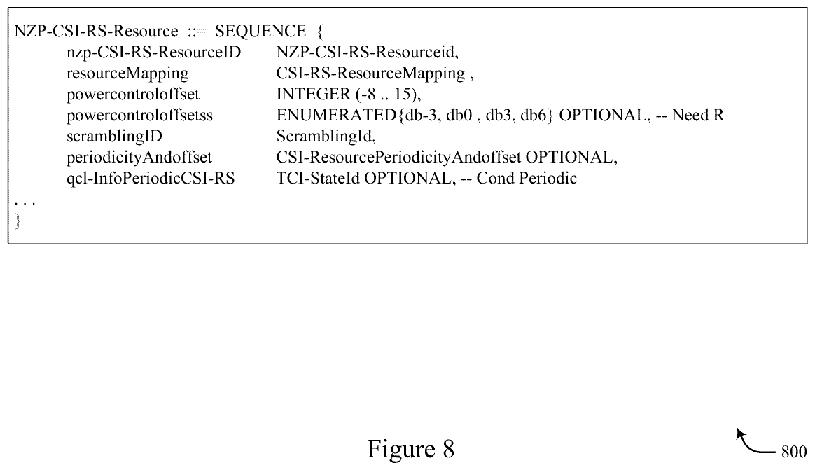

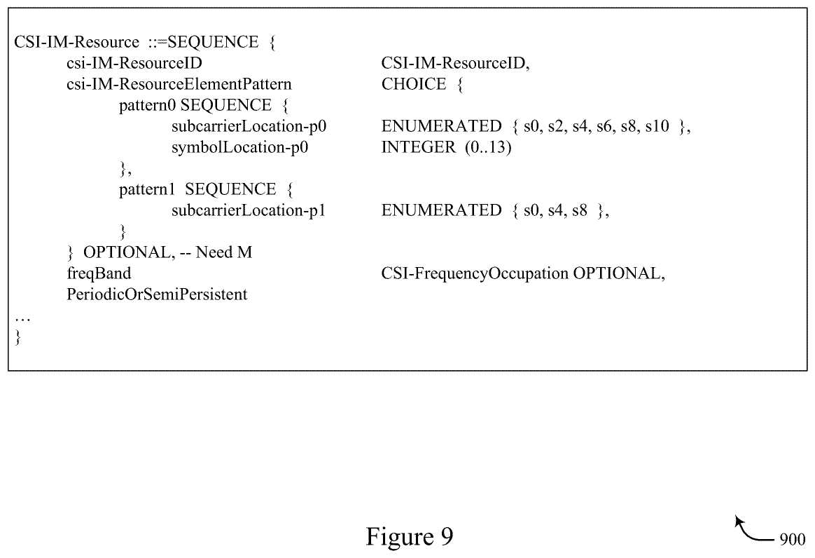

FIG. 8 illustrates an example 800 for aperiodic trigger state indicating the resource set and QCL information, and FIG. 9 illustrates an example 900 for RRC configuration for: (a) NZP-CSI-RS Resource (b) CSI-IM-Resource. Table 4 summarizes the type of uplink channels used for CSI reporting as a function of the CSI codebook type.

TABLE 4
Uplink channels used for CSI reporting
as a function of the CSI codebook type

| | Periodic CSI | | AP CSI |
|---|---|---|---|
| | reporting | SP CSI reporting | reporting |
| Type I WB | PUCCH Format | PUCCH Format 2 | PUSCH |
| | 2, 3, 4 | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 only | | PUCCH Format 3, 4 | |

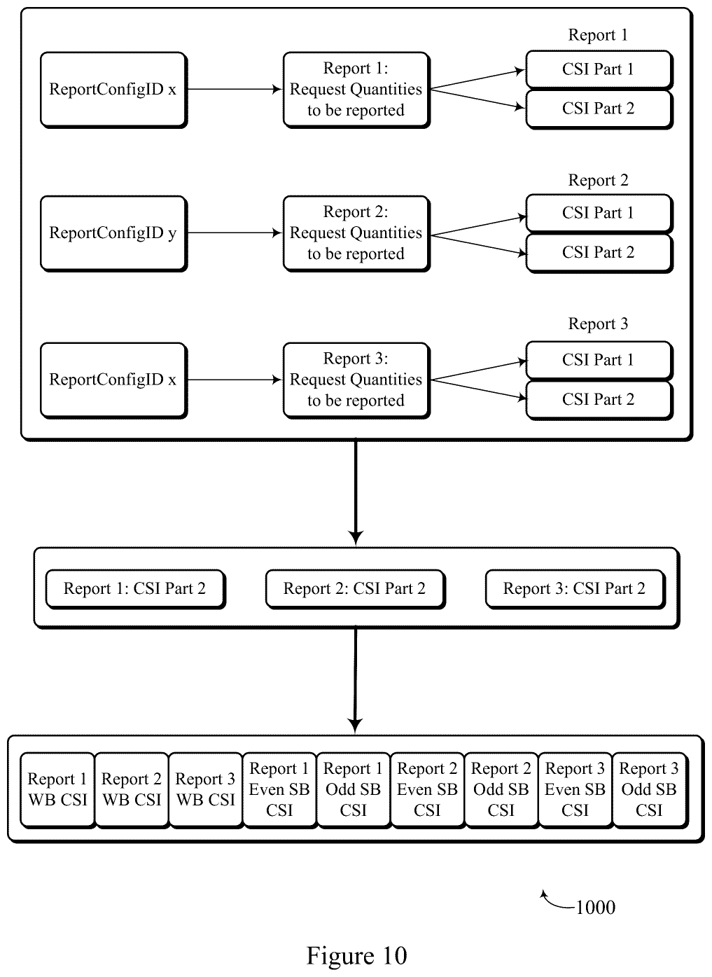

FIG. 10 illustrates at 1000 partial CSI omission for PUSCH-Based CSI. For aperiodic CSI reporting, PUSCH-based reports can be divided into two CSI parts: CSI Part1 and CSI Part 2. For instance, the size of CSI payload can vary significantly, and therefore a worst-case UCI payload size design can result in large overhead.

CSI Part 1 has a fixed payload size (and can be decoded by the gNB without prior information) and contains the following: RI (if reported), CSI-RS Resource Index (CRI) (if reported) and Channel Quality Indicator (CQI) for the first codeword; and number of non-zero wideband amplitude coefficients per layer for Type II CSI feedback on PUSCH. CSI Part 2 can have a variable payload size that can be derived from the CSI parameters in CSI Part 1 and contains PMI and the CQI for the second codeword when RI>4. For example, if the aperiodic trigger state indicated by DCI format 0_1 defines 3 report settings x, y, and z, then the aperiodic CSI reporting for CSI part 2 will be ordered such as illustrated at 900.

As mentioned above, CSI reports can be prioritized according to: time-domain behavior and physical channel, where more dynamic reports are given precedence over less dynamic reports and PUSCH has precedence over PUCCH; CSI content, where beam reports (e.g., L1-RSRP reporting) has priority over regular CSI reports; the serving cell to which the CSI corresponds (in case of carrier aggregation (CA) operation). CSI corresponding to the PCell has priority over CSI corresponding to Scells; and/or the reportConfigID.

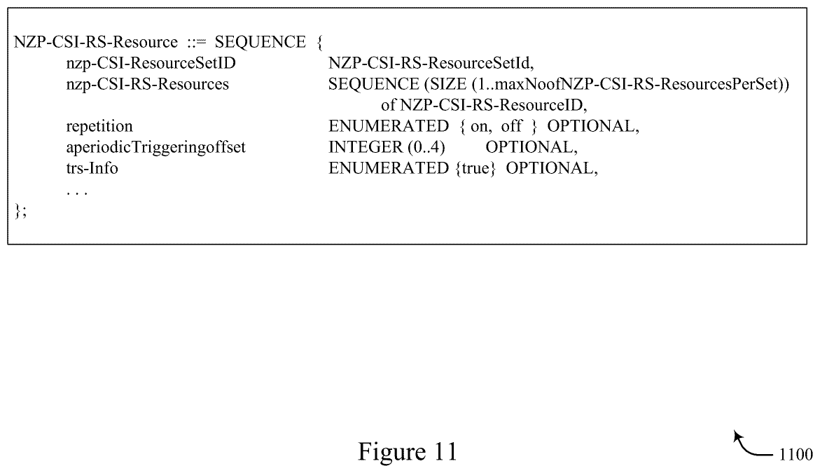

FIG. 11 illustrates at 1100 ASN-1 code for configuring an NZP-CSI-RS resource set. For instance, in NR Rel. 15, tracking reference signal (TRS) is transmitted for establishing fine time and frequency synchronization at the UE to aid in demodulation of PDSCH, particularly for higher order modulations. A TRS is an NZP-CSI-RS resource set with trs-info set to true, as illustrated at 1000.

Here, trs-Info indicates that the antenna port for all NZP-CSI-RS resources in the CSI-RS resource set is same. The TRS contains either 2 or 4 periodic CSI-RS resources with periodicity 2^{-μ}*Xp slots where Xp=10, 20, 40, or 80 and where μ is related to the SCS, e.g. μ=0, 1, 2, 3, 4 for 15, 30, 60, 120, 240 kHz, respectively. The slot offsets for the 2 or 4 CSI-RS resources are configured such that the first pair of resources are transmitted in one slot, and the 2nd pair (if configured) are transmitted in the next (adjacent) slot.

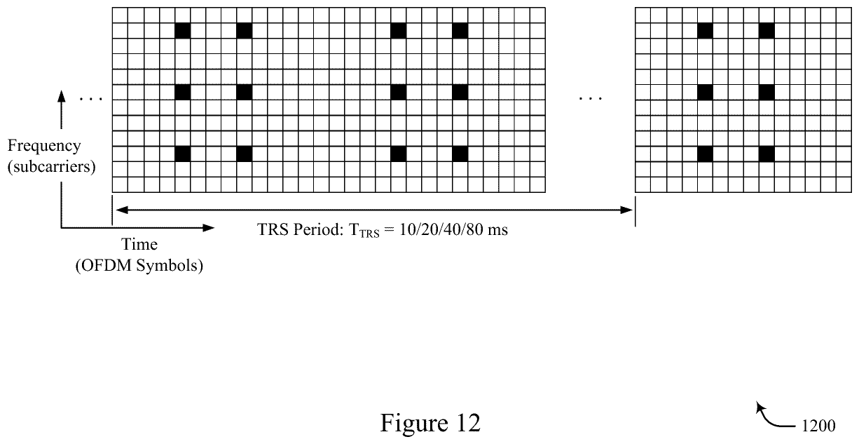

FIG. 12 illustrates at 1200 an example where four resources are single port with density 3. The two CSI-RS within a slot can be separated by four symbols in the time domain. This time-domain separation sets a limit for the maximum frequency error that can be compensated. Likewise, the frequency-domain separation of four subcarriers sets a limit for the maximum timing error that can be compensated. The maximum number of TRS a UE can be configured with is a UE capability:
Maximum number of TRS resource sets (per component carrier (CC)) a UE can track simultaneously: Candidate values {1 to 8}
The maximum number of TRS resource sets configured to UE per CC: Candidate value set: {1 to 64}. UE is mandated to report at least 8 for FR1 and 16 for FR2.
The maximum number of TRS resource sets configured to UE across CCs: Candidate value set: {1 to 256}. UE is mandated to report at least 16 for FR1 and 32 for FR2

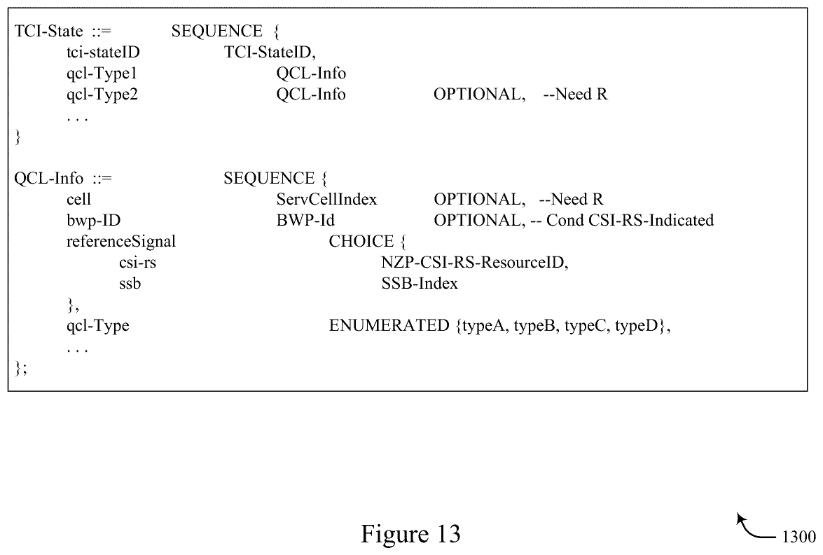

FIG. 13 illustrates at 1300 ASN-1 code for QCL information. In scenarios an aperiodic TRS is a set of aperiodic CSI-RS for tracking that is optionally configured, but a periodic TRS may always be configured, and its time and frequency domain configurations (except for the periodicity) may match those of the periodic TRS. A UE may assume that the aperiodic TRS resources are quasi-co-located with the periodic TRS resources. A Transmission Configuration Indicator (TCI) state such as configured by RRC may have two QCL types (e.g., two reference signals) with the second QCL type for operation in FR2, such as illustrated at 1200.

In aspects of this disclosure various terminology and features can be discussed as follows: The following notions interchangeably: network nodes, transmit-receive point (TRP), panel, set of antennas, set of antenna ports, uniform linear array, cell, node, radio head, communication (e.g., signals/channels) associated with a CORESET (control resource set) pool, communication associated with a TCI state from a transmission configuration comprising at least two TCI states. A TRS can corresponds to an NZP CSI-RS resource set with a parameter ‘trs-info’ being configured. A CSI-RS for beam management can correspond to an NZP CSI-RS resource set with a parameter ‘repetition’ being configured. A CSI-RS for CSI can correspond to an NZP CSI-RS resource set with neither parameters ‘trs-info’ nor ‘repetition’ being configured. A matrix can represent a sequence of fields of an arbitrary dimension, including an array (vector) of values, a standard 2D matrix and more generally a Q-dimensional matrix (tensor) wherein Q≥2 is an integer value. Unless otherwise stated, transmission and reception can be assumed from a network perspective, e.g., transmission can refer to network transmission and reception can refer to network reception. While implementations are discussed with reference to signals for cell discontinuous signaling, the implementations may equivalently apply to channels for cell discontinuous signaling. Multiple implementations are described below and according to implementations, one or more elements or features from one or more of the described implementations may be combined.

According to aspects of the present disclosure signals are associated with cell discontinuous signaling, e.g., cell DTX and/or cell DRX. In such implementations signals associated with cell DTX and/or cell DRX operation can be classified into at least two groups based on their urgency, priority, and/or required transmission periodicity. Different implementations are described below. According to implementations, one or more elements or features from one or more of the described implementations may be combined in various ways.

In implementations at least two groups of signals can be configured for cell DTX. For instance, in a first example, a first group of the at least two groups includes at least one of SPS occasions including one or more of SPS-PDSCH, periodic or semi-persistent CSI-RS for CSI measurement, or PDCCH associated with DCI formats 2_0, 2_1, 2_2, 2_3, 2_4, and 2_5. In another example, a second group of the at least two groups includes at least one of SSB, SIB, P TRS, periodic or semi-persistent CSI-RS for BM, PRS, PDCCH scrambled with UE-specific RNTI, PDCCH in Type-3 CSS, PDCCH for RAR, or PDCCH for msg4 HARQ transmission. In another example the first group of the at least two groups configured for cell DTX is optionally configured, e.g., the first group is a null set. In another example the second group of the at least two groups configured for cell DTX is optionally configured, e.g., the second group is a null set.

In implementations signals of a first group of the at least two groups are monitored by a UE in a first transmission occasion of two transmission occasions associated with cell DTX, and signals of a second group of the at least two groups are monitored by the UE over a second transmission occasion of the two transmission occasions associated with cell DTX.

In implementations signals of a first group of the at least two groups are monitored by the UE in a first transmission occasion of two transmission occasions associated with cell DTX, and signals of a second group of the at least two groups are monitored by the UE over two transmission occasions associated with cell DTX.

In implementations at least two groups of signals are configured for cell DRX. For instance, in an example a first group of the at least two groups includes at least one of CG occasions including CG-PUSCH, SR occasions, periodic or semi-persistent CSI reports, and/or periodic or semi-persistent SRS excluding SRS for positioning. In another example a second group of the two groups includes at least one of SRS for positioning or HARQ-ACK feedback for SPS PDSCH. In another example the first group of signals configured for cell DRX is optionally configured, e.g., the first group is a null set. In another example the second group of signals configured for cell DRX is optionally configured, e.g., the second group is a null set.

In implementations signals of a first group of the at least two groups are transmitted by the UE in a first reception occasion of two reception occasions associated with cell DRX, and signals of a second group of the at least two groups are transmitted by the UE over a second reception occasion of the two reception occasions associated with cell DRX.

In implementations signals of a first group of the at least two groups are transmitted by the UE in a first reception occasion of two reception occasions associated with cell DRX, and signals of a second group of the at least two groups are transmitted by the UE over the two reception occasions associated with cell DRX.

Implementations described herein provide for additional transmission occasions are provide for cell DTX behavior. For instance, special occasions for cell transmission are configured for transmission of different signals before cell DTX activation and/or after cell DTX deactivation. Several implementations are described below. According to implementations one or more elements or features from one or more of the described implementations may be combined.

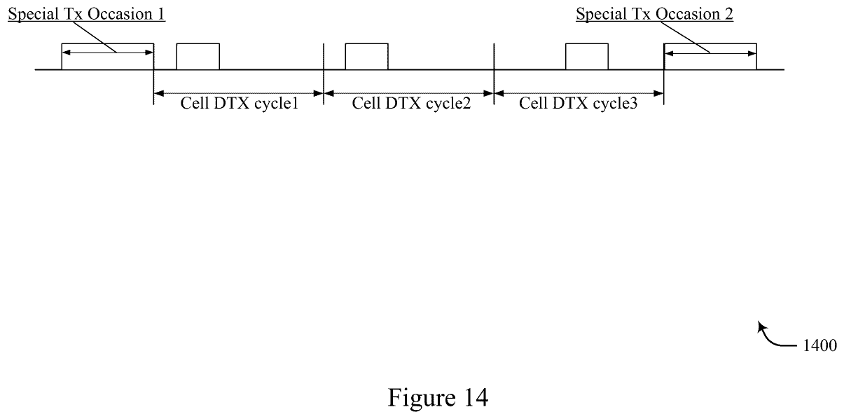

FIG. 14 illustrates an implementation 1400 in accordance with aspects of the present disclosure. The implementation 1400 illustrates two special occasions for cell transmission, e.g., a first special transmission occasion “Special Tx Occasion 1” and a second special transmission occasion “Special Tx Occasion 2.” The first special transmission occasion, for instance, occurs before a first cell DTX cycle “Cell DTX cycle1”, (e.g., before cell DTX activation) and a second special transmission occasion occurs after a last cell DTX cycle Cell DTX cycle3, e.g., after cell DTX deactivation.

In an example the first special occasion occupies a set of slots that precede a first slot in which cell DTX cycle is activated, e.g., the first slot of the first cell DTX cycle. In an example the second special occasion occupies a set of slots that succeed the last slot in which cell DTX is activated, the last slot of the last cell DTX cycle before cell DTX is deactivated. In an example the second special occasion is optionally configured, e.g., an existence of the second special occasion is conditioned on an optional network configuration. In an example the two special occasions are associated with aperiodic signal transmission where the aperiodic signal transmission is triggered within a cell DTX configuration signaling.

In implementations a first slot offset associated with a first cycle of a cell DTX takes on a distinct value compared with a second slot offset associated with subsequent cycles of cell DTX. For instance, in an example the first slot offset of the first cycle of a cell DTX is assumed to take on a fixed value, e.g., {0, 1, 2, 3} or a single-digit value, in an order of number of slots and/or milliseconds. In an example the first slot offset of the first cycle of a cell DTX takes on a first configured value where the first configured value is no larger than a second configured value of the second slot offset associated with the subsequent cycles of cell DTX. In an example a signal transmission associated with the first cycle of the cell DTX is an aperiodic signal transmission that is triggered within a cell DTX configuration signaling.

According to implementations a first slot offset associated with a last cycle of a cell DTX (e.g., a DTX cycle that succeeds a cell DTX deactivation command) takes on a distinct value compared with a second slot offset associated with preceding cycles of cell DTX. For instance in an example the first slot offset of the last cycle of the cell DTX is assumed to take on a fixed value (e.g., DRX cycle length subtracted by a single-digit value) in an order of number of slots or milliseconds. In an example the first slot offset of the last cycle of a cell DTX takes on a first configured value, where the first configured value is no less than a second configured value of the second slot offset associated with the subsequent cycles of cell DTX. In an example a signal transmission associated with the last cycle of the cell DTX is an aperiodic signal transmission that is triggered within a cell DTX configuration signaling.

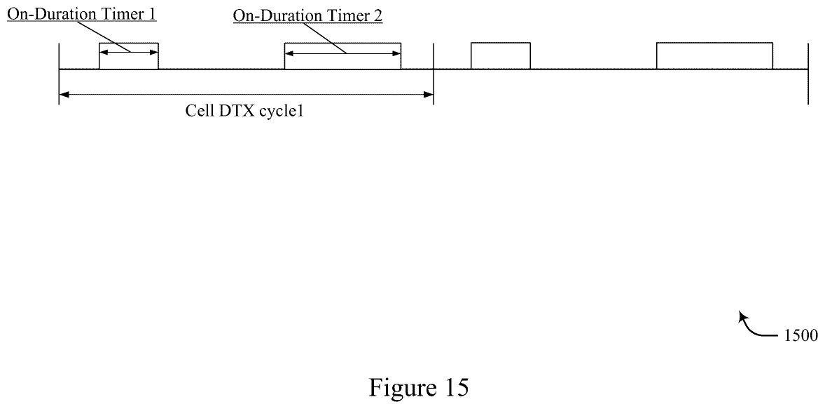

FIG. 15 illustrates an implementation 1500 in accordance with aspects of the present disclosure. The implementation 1500 illustrates a first on-duration timer “On-Duration Timer 1” and a second on-duration timer “On-Duration Timer 2” within a cell DTX cycle 1. In implementations two cell transmission occasions correspond to the two on-duration timers for cell transmission are configured, where a first on-duration period associated with the first on-duration timer occupies a first set of slots in a first half of the cell DTX cycle and a second on-duration period associated with the second on-duration timer occupies a second set of slots in a second half of the cell DTX cycle. A first set of signals are associated with the first on-duration timer and a second set of signals are associated with the second on-duration timer.

In an example a first offset value associated with the first on-duration timer is indicated with respect to a first slot of the cell DTX cycle and a second offset value associated with the second on-duration timer is indicated with respect to a last slot of the cell DTX cycle. In an example a second offset value associated with the second on-duration timer is indicated with respect to a first offset value associated with the first on-duration timer. In an example the second set of signals is a subset of the first set of signals. In an example the first set of signals and the second set of signals are disjoint. In an example the second set of signals comprises at least one of periodic or semi-persistent CSI-RS associated with BM, SSB, SIB, TRS and/or PRS. In an example the second on-duration timer is optionally configured, e.g., an existence of the second special occasion is conditioned on an optional network configuration.

In implementations two cell DTX cycle patterns are jointly configured where a first length of a cell DTX cycle associated with a first of the two DTX cycle patterns is an integer multiple of a second length of a cell DTX cycle associated with a second of the two DTX cycle patterns. Further, a first on-duration period associated with a first on-duration timer of the first cell DTX cycle pattern corresponds to the first transmission occasion, and a second on-duration period associated with a second on-duration timer of the second cell DTX cycle pattern corresponds to the second transmission occasion

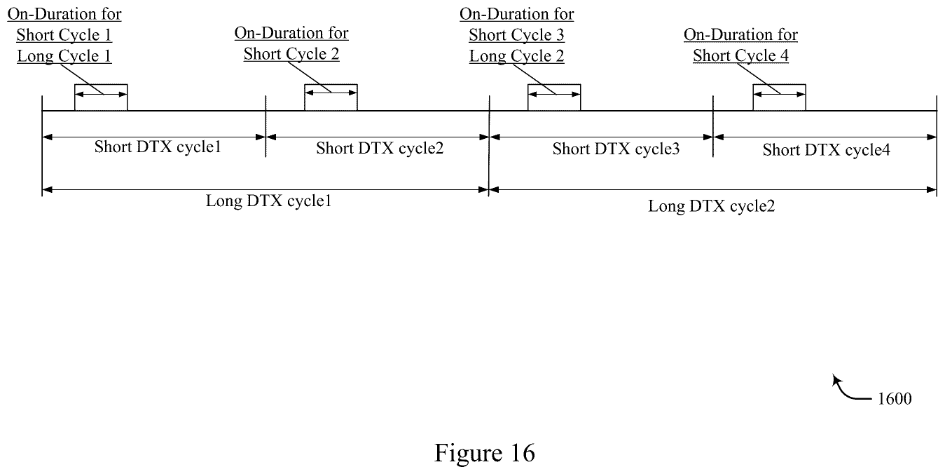

FIG. 16 illustrates an implementation 1600 in accordance with aspects of the present disclosure. The implementation 1600 illustrates Short DTX cycles 1-4 and Long DTX cycles 1, 2. Further, the DTX cycles include an “On-Duration for Short Cycle 1 and Long Cycle 1,” an “On-Duration for Short Cycle 2,” an “On-Duration for Short Cycle 3 and Long Cycle 2,” and an “On-Duration for Short Cycle 4.”

In an example the first cell DTX cycle pattern is a long cell DTX cycle pattern and the second cell DTX cycle pattern is a short cell DTX cycle pattern. In an example the two cell DTX cycle patterns are configured with a same slot offset value corresponding to a start of an on-duration timer of each of the two cell DTX cycle patterns, e.g., the on-duration periods of both cell DTX cycles associated with the two cell DTX cycle patterns are at least partially overlapping. In an example the two cell DTX cycle patterns are configured with a same on-duration timer value. In the previous two examples the on-duration periods of both cell DTX cycles associated with the two cell DTX cycle patterns can be fully overlapping.

In an example a first set of signals are monitored by the UE during the on-duration period of the first cell DTX cycle pattern and a second set of signals are monitored by the UE during the on-duration period of the second cell DTX cycle pattern, where the second set is disjoint from the first set, a subset of the first set, or partially overlapping with the first set. In an example the second cell DTX cycle pattern is optionally configured, e.g., the second cell DTX cycle pattern is absent.

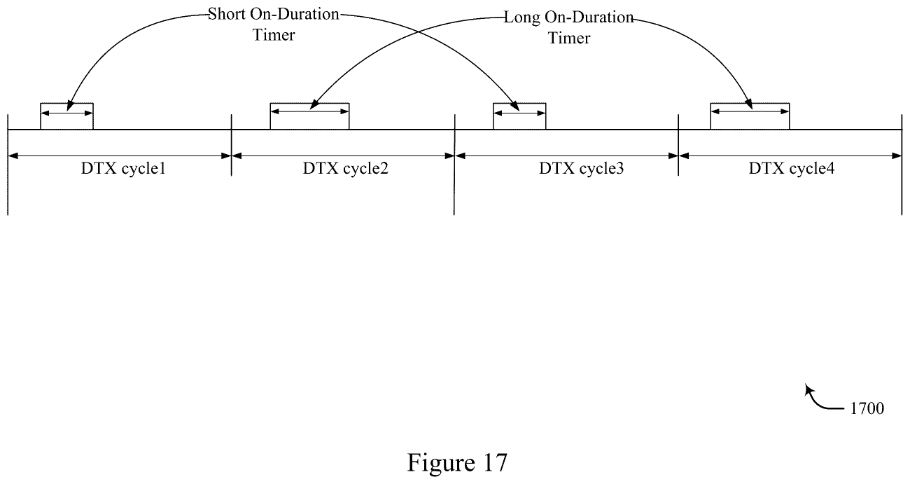

FIG. 17 illustrates an implementation 1700 in accordance with aspects of the present disclosure. The implementation 1700 illustrates DTX cycles 1-4 with Short On-Duration Timers in the DTX cycles 1, 3 and Long On-Duration Timers in the DTX cycles 2, 4. In an example two cell transmission occasions corresponding to two on-duration timers for cell transmission are configured where a first on-duration period associated with a first on-duration timer corresponds to a first subset of cell DTX cycles, and a second on-duration period associated with a second on-duration timer corresponds to a second subset of cell DTX cycles.

In an example a first set of signals are associated with the first on-duration timer, and a second set of signals are associated with the second on-duration timer. In an example a first value of the first on-duration timer and a second value of the second on-duration timer are not the same. In an example a first offset value associated with the first on-duration timer is equal to a second offset value associated with the second on-duration timer.

In an example the second set of signals is a subset of the first set of signals. In an example the first set of signals and the second set of signals are disjoint. In an example the second on-duration timer is optionally configured, e.g., an existence of the second special occasion is conditioned on an optional network configuration. In an example the first subset of cell DTX cycles and the second subset of cell DTX cycles are disjoint. In an example the first subset of cell DTX cycles corresponds to even DTX cycles, and the second subset of cell DTX cycles correspond to odd DTX cycles.

Implementations further provide additional cell reception occasions for cell DRX operations. For instance special occasions for cell reception are configured for transmission of different signals before cell DRX activation and/or after cell DRX deactivation. Several implementations are described below. According to implementations one or more elements or features from one or more of the described implementations may be combined.

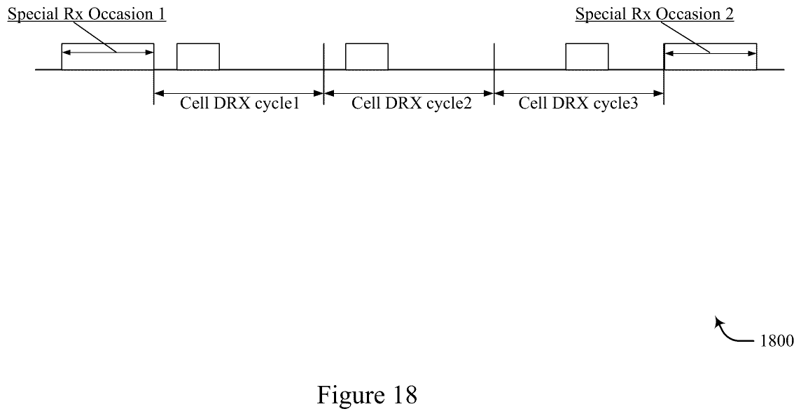

FIG. 18 illustrates an implementation 1800 in accordance with aspects of the present disclosure. The implementation 1800 illustrates two special occasions for cell reception, e.g., a first special reception occasion “Special Rx Occasion 1” and a second special reception occasion “Special Rx Occasion 2.” The first special reception occasion, for instance, occurs before a first cell DRX cycle “Cell DRX cycle1”, (e.g., before cell DRX activation) and a second special reception occasion occurs after a last cell DRX cycle Cell DRX cycle3, e.g., after cell DRX deactivation.

In an example the first special occasion occupies a set of slots that precede a first slot in which cell DRX cycle is activated, e.g., the first slot of the first cell DRX cycle. In an example the second special occasion occupies a set of slots that succeed the last slot in which cell DRX is activated, the last slot of the last cell DRX cycle before cell DRX is deactivated. In an example the second special occasion is optionally configured, e.g., an existence of the second special occasion is conditioned on an optional network configuration. In an example the two special occasions are associated with aperiodic signal reception where the aperiodic signal reception is triggered within a cell DRX configuration signaling.

In implementations a first slot offset associated with a first cycle of a cell DRX takes on a distinct value compared with a second slot offset associated with subsequent cycles of cell DRX. For instance, in an example the first slot offset of the first cycle of a cell DRX is assumed to take on a fixed value, e.g., {0, 1, 2, 3} or a single-digit value, in an order of number of slots and/or milliseconds. In an example the first slot offset of the first cycle of a cell DRX takes on a first configured value where the first configured value is no larger than a second configured value of the second slot offset associated with the subsequent cycles of cell DRX. In an example a signal reception associated with the first cycle of the cell DRX is an aperiodic signal reception that is triggered within a cell DRX configuration signaling.

According to implementations a first slot offset associated with a last cycle of a cell DRX (e.g., a DRX cycle that succeeds a cell DRX deactivation command) takes on a distinct value compared with a second slot offset associated with preceding cycles of cell DRX. For instance in an example the first slot offset of the last cycle of the cell DRX is assumed to take on a fixed value (e.g., DRX cycle length subtracted by a single-digit value) in an order of number of slots or milliseconds. In an example the first slot offset of the last cycle of a cell DRX takes on a first configured value, where the first configured value is no less than a second configured value of the second slot offset associated with the subsequent cycles of cell DRX. In an example a signal reception associated with the last cycle of the cell DRX is an aperiodic signal reception that is triggered within a cell DRX configuration signaling.

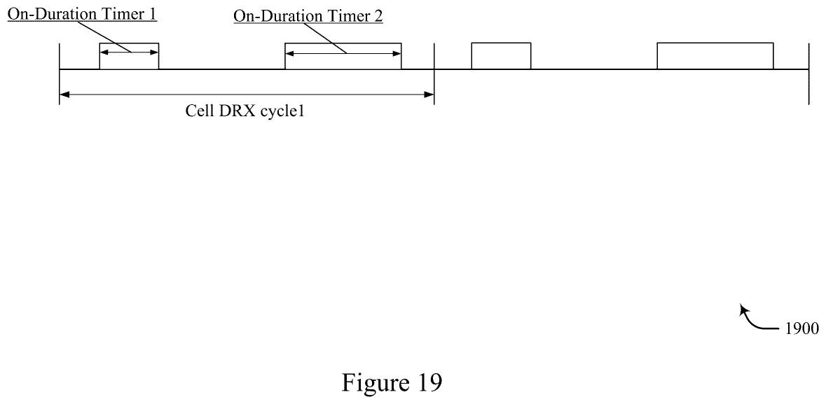

FIG. 19 illustrates an implementation 1900 in accordance with aspects of the present disclosure. The implementation 1900 illustrates a first on-duration timer “On-Duration Timer 1” and a second on-duration timer “On-Duration Timer 2” within a cell DRX cycle 1. In implementations two cell reception occasions correspond to the two on-duration timers for cell reception are configured, where a first on-duration period associated with the first on-duration timer occupies a first set of slots in a first half of the cell DRX cycle and a second on-duration period associated with the second on-duration timer occupies a second set of slots in a second half of the cell DRX cycle. A first set of signals are associated with the first on-duration timer and a second set of signals are associated with the second on-duration timer.

In an example a first offset value associated with the first on-duration timer is indicated with respect to a first slot of the cell DRX cycle and a second offset value associated with the second on-duration timer is indicated with respect to a last slot of the cell DRX cycle. In an example a second offset value associated with the second on-duration timer is indicated with respect to a first offset value associated with the first on-duration timer. In an example the second set of signals is a subset of the first set of signals. In an example the first set of signals and the second set of signals are disjoint. In an example the second set of signals comprises at least one of periodic or semi-persistent CSI-RS associated with BM, SSB, SIB, TRS and/or PRS. In an example the second on-duration timer is optionally configured, e.g., an existence of the second special occasion is conditioned on an optional network configuration.

In implementations two cell DRX cycle patterns are jointly configured where a first length of a cell DRX cycle associated with a first of the two DRX cycle patterns is an integer multiple of a second length of a cell DRX cycle associated with a second of the two DRX cycle patterns. Further, a first on-duration period associated with a first on-duration timer of the first cell DRX cycle pattern corresponds to the first reception occasion, and a second on-duration period associated with a second on-duration timer of the second cell DRX cycle pattern corresponds to the second reception occasion.

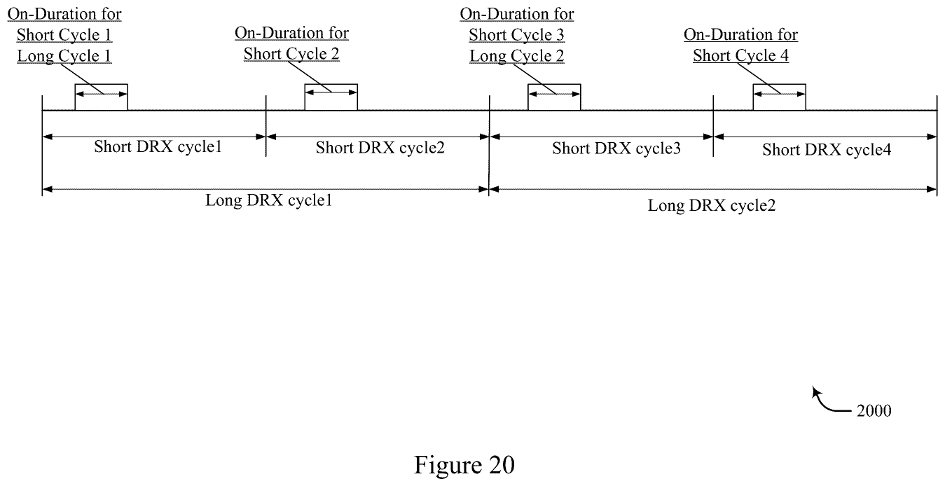

FIG. 20 illustrates an implementation 2000 in accordance with aspects of the present disclosure. The implementation 2000 illustrates Short DRX cycles 1-4 and Long DRX cycles 1, 2. Further, the DRX cycles include an “On-Duration for Short Cycle 1 and Long Cycle 1,” an “On-Duration for Short Cycle 2,” an “On-Duration for Short Cycle 3 and Long Cycle 2,” and an “On-Duration for Short Cycle 4.”

In an example the first cell DRX cycle pattern is a long cell DRX cycle pattern and the second cell DRX cycle pattern is a short cell DRX cycle pattern. In an example the two cell DRX cycle patterns are configured with a same slot offset value corresponding to a start of an on-duration timer of each of the two cell DRX cycle patterns, e.g., the on-duration periods of both cell DRX cycles associated with the two cell DRX cycle patterns are at least partially overlapping. In an example the two cell DRX cycle patterns are configured with a same on-duration timer value. In the previous two examples the on-duration periods of both cell DRX cycles associated with the two cell DRX cycle patterns can be fully overlapping.

In an example a first set of signals are transmitted by the UE during the on-duration period of the first cell DRX cycle pattern and a second set of signals are transmitted by the UE during the on-duration period of the second cell DRX cycle pattern, where the second set is disjoint from the first set, a subset of the first set, or partially overlapping with the first set. In an example the second cell DRX cycle pattern is optionally configured, e.g., the second cell DRX cycle pattern is absent.

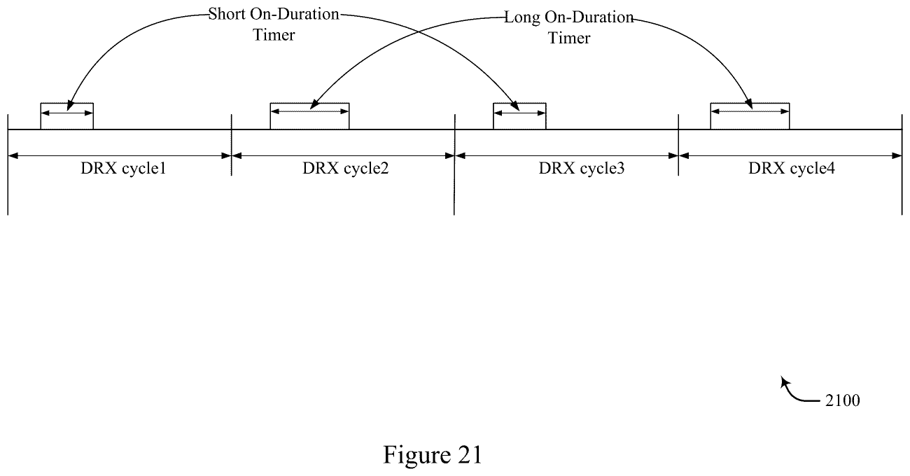

FIG. 21 illustrates an implementation 2100 in accordance with aspects of the present disclosure. The implementation 2100 illustrates DRX cycles 1-4 with Short On-Duration Timers in the DRX cycles 1, 3 and Long On-Duration Timers in the DRX cycles 2, 4. In an example two cell reception occasions corresponding to two on-duration timers for cell reception are configured where a first on-duration period associated with a first on-duration timer corresponds to a first subset of cell DRX cycles, and a second on-duration period associated with a second on-duration timer corresponds to a second subset of cell DRX cycles.

In an example a first set of signals are associated with the first on-duration timer, and a second set of signals are associated with the second on-duration timer. In an example a first value of the first on-duration timer and a second value of the second on-duration timer are not the same. In an example a first offset value associated with the first on-duration timer is equal to a second offset value associated with the second on-duration timer.

In an example the second set of signals is a subset of the first set of signals. In an example the first set of signals and the second set of signals are disjoint. In an example the second on-duration timer is optionally configured, e.g., an existence of the second special occasion is conditioned on an optional network configuration. In an example the first subset of cell DRX cycles and the second subset of cell DRX cycles are disjoint. In an example the first subset of cell DRX cycles corresponds to even DRX cycles, and the second subset of cell DRX cycles correspond to odd DRX cycles.

Implementations described herein also enable cell DTX dependent signal configuration. Under such an approach a signal whose transmission is impacted by cell DTX operation is configured with two higher-layer configurations where a first of the two higher-layer configurations is associated with transmission when cell DTX operation is deactivated and a second of the two higher-layer configurations is associated with transmission when cell DTX operation is activated. Several implementations are described below. According to implementations one or more elements or features from one or more of the described implementations may be combined.

In implementations a triggering of one of the two higher-layer configurations is based on receiving a PDCCH signal associated with a DCI format associated with cell DTX operation. In an example an activation of one of the two higher-layer configurations is inferred from a cell DTX activation/deactivation command. In an example an activation of one of the two higher-layer configurations is explicitly indicated via a dedicated DCI field of the PDCCH.

In implementations a triggering of one of the two higher-layer configurations is based on a reception of a cell DTX command MAC CE at the UE, wherein a cell DTX deactivation command activates the first of the two higher-layer configurations, and a cell DTX activation command activates the second of the two higher-layer configurations. In an example an activation of one of the two higher-layer configurations is inferred from a cell DTX activation/deactivation command MAC CE. In an example an activation of one of the two higher-layer configurations is explicitly indicated via a dedicated field in the cell DTX activation/deactivation command MAC CE.

In implementations the first higher-layer configuration is based on one of a periodic or semi-persistent transmission with a higher periodicity value compared with that of the second higher-layer configuration, a higher density signaling compared with that of the second higher-layer configuration, or a combination thereof. In an example a periodicity value of a first NZP CSI-RS resource associated with the first of the two higher-layer configurations is smaller than a periodicity value of a second NZP CSI-RS resource associated with the second of the two higher-layer configurations. In an example a frequency density value of a first NZP CSI-RS resource indicated in a CSI-RS resource mapping associated with the first of the two higher-layer configurations is larger than a frequency density value of a second NZP CSI-RS resource indicated in a CSI-RS resource mapping associated with the second of the two higher-layer configurations.

In implementations an identification value (ID) of the second of the two higher-layer configurations is indicated within the cell DTX configuration. In an example an ID of a CSI reporting setting (e.g., CSI-ReportConfigId) corresponding to the second of the two higher-layer configurations associated with a CSI reporting setting of a cell DTX operation is included within the cell DTX configuration IE. In an example the ID of the second of the two higher-layer configurations is indicated within the cell DTX higher-layer configuration, e.g., cell DTX config IE. In an example the ID of the second of the two higher-layer configurations is indicated in a DCI field of the cell DTX PDCCH signal. In an example the ID of the second of the two higher-layer configurations is indicated in a field of the cell DTX command MAC CE.

Implementations described herein also enable cell DRX dependent signal configuration. Under such an approach a signal whose reception is impacted by cell DRX operation is configured with two higher-layer configurations where a first of the two higher-layer configurations is associated with reception when cell DRX operation is deactivated and a second of the two higher-layer configurations is associated with reception when cell DRX operation is activated. Several implementations are described below. According to implementations one or more elements or features from one or more of the described implementations may be combined.

In implementations a triggering of one of the two higher-layer configurations is based on receiving a PDCCH signal associated with a DCI format associated with cell DRX operation. In an example an activation of one of the two higher-layer configurations is inferred from a cell DRX activation/deactivation command. In an example an activation of one of the two higher-layer configurations is explicitly indicated via a dedicated DCI field of the PDCCH.

In implementations a triggering of one of the two higher-layer configurations is based on a reception of a cell DRX command MAC CE at the UE, wherein a cell DRX deactivation command activates the first of the two higher-layer configurations, and a cell DRX activation command activates the second of the two higher-layer configurations. In an example an activation of one of the two higher-layer configurations is inferred from a cell DRX activation/deactivation command MAC CE. In an example an activation of one of the two higher-layer configurations is explicitly indicated via a dedicated field in the cell DRX activation/deactivation command MAC CE.

In implementations the first higher-layer configuration is based on one of a periodic or semi-persistent transmission with a higher periodicity value compared with that of the second higher-layer configuration, a higher density signaling compared with that of the second higher-layer configuration, or a combination thereof. In an example a periodicity value of a first NZP CSI-RS resource associated with the first of the two higher-layer configurations is smaller than a periodicity value of a second NZP CSI-RS resource associated with the second of the two higher-layer configurations. In an example a frequency density value of a first NZP CSI-RS resource indicated in a CSI-RS resource mapping associated with the first of the two higher-layer configurations is larger than a frequency density value of a second NZP CSI-RS resource indicated in a CSI-RS resource mapping associated with the second of the two higher-layer configurations.

In implementations an identification value (ID) of the second of the two higher-layer configurations is indicated within the cell DRX configuration. In an example an ID of a CSI reporting setting (e.g., CSI-ReportConfigId) corresponding to the second of the two higher-layer configurations associated with a CSI reporting setting of a cell DRX operation is included within the cell DRX configuration IE. In an example the ID of the second of the two higher-layer configurations is indicated within the cell DRX higher-layer configuration, e.g., cell DRX config IE. In an example the ID of the second of the two higher-layer configurations is indicated in a DCI field of the cell DRX PDCCH signal. In an example the ID of the second of the two higher-layer configurations is indicated in a field of the cell DRX command MAC CE.

Implementations described herein also provide for cell DTX behavior for signals occupying multiple slots. Under such approaches a signal whose transmission occupies multiple slots where a subset of the multiple slots are within a cell DTX period outside of the on-time duration (e.g., within inactive time of cell DTX) is discussed. Different behaviors of the signal transmission that depend on the subset of the multiple slots are discussed. Several implementations are described below and according to implementations one or more elements or features from one or more of the described implementations may be combined.

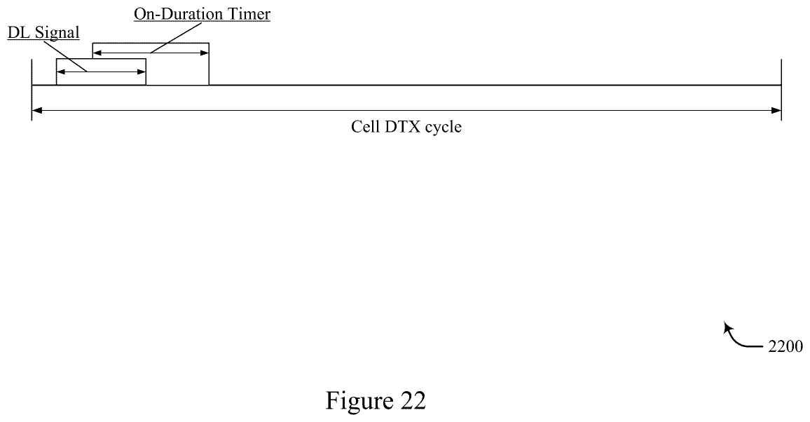

FIG. 22 illustrates an implementation 2200 in accordance with aspects of the present disclosure. The implementation 2200 includes a cell DTX cycle with a DL signal and an on-duration timer. In implementations a DL signal occupying multiple slots is not monitored by the UE if cell DTX is configured and if a first slot over which the signal is transmitted within the cell DTX cycle is outside of an on-duration period associated with an on-duration timer of the cell DTX cycle. In an example a CSI-RS transmission corresponding to DL multi-TRP transmission (e.g., a CSI-RS Resource Set for channel measurement configured with two Resource Groups and N Resource Pairs) that occupies two consecutive slots (e.g., n, n+1) is not monitored by the UE if slot n is within the cell DTX cycle and not within the on-duration period. This behavior can apply even if slot n+1 is within the on-duration period of the cell DTX cycle. In an example an on-duration period corresponds to a period that precedes a start of the on-duration timer of the cell DTX or succeeds an end of the on-duration timer of the cell DTX.

In implementations a DL signal occupying multiple slots is monitored by the UE if cell DTX is configured and if a first slot over which the signal is transmitted before a first slot in which a cell DTX cycle is activated. In an example a CSI-RS transmission corresponding to DL multi-TRP transmission (e.g., a CSI-RS Resource Set for channel measurement configured with two Resource Groups and N Resource Pairs) that occupies two consecutive slots (e.g., n, n+1) is monitored by the UE if slot n precedes a start of a first cell DTX cycle activated by the network. This behavior can apply even if slot n+1 is within the cell DTX cycle and not within the on-duration period of the cell DTX.

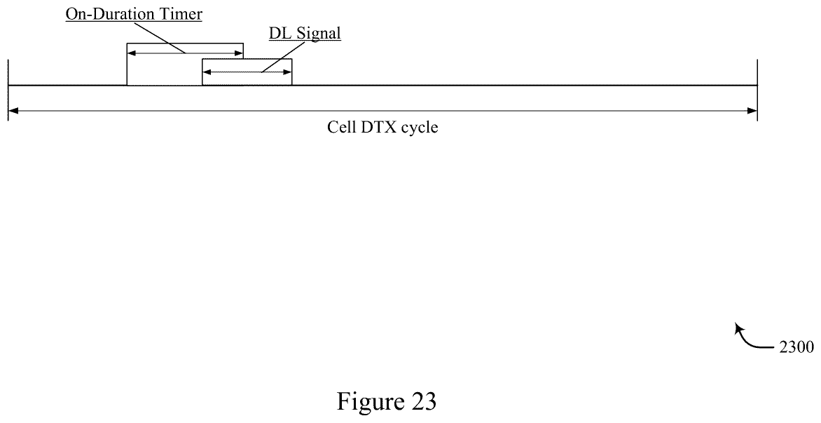

FIG. 23 illustrates an implementation 2300 in accordance with aspects of the present disclosure. The implementation 2300 includes a cell DTX cycle with a DL signal and an on-duration timer. In such implementations a DL signal occupying multiple slots is monitored by the UE if cell DTX is configured and if a first slot over which the signal is transmitted within the cell DTX cycle and within an on-duration period associated with an on-duration timer of the cell DTX cycle. In an example a CSI-RS transmission corresponding to DL multi-TRP transmission (e.g., a CSI-RS Resource Set for channel measurement configured with two Resource Groups and N Resource Pairs) that occupies two consecutive slots (e.g., n, n+1) is monitored by the UE if slot n is within the cell DTX cycle and within the on-duration period. This behavior can apply even if slot n+1 is not within the on-duration period of the cell DTX cycle.

In implementations if a DL signal occupying multiple slots that is associated with a repetition where a first subset of transmission occasions of a set of transmission occasions corresponding to the DL signal are transmitted within the cell DTX cycle and outside of an on-duration period associated with an on-duration timer of the cell DTX cycle, the UE is not expected to monitor the first subset of transmission occasions. The UE may still monitor a second subset of transmission occasions of the set of transmission occasions corresponding to the DL signal that are transmitted within the cell DTX cycle and within the on-duration period associated with the on-duration timer of the cell DTX cycle.

In an example the DL channel is an PDSCH configured with a repetition scheme set to TDM Scheme A, wherein a repetition of the PDSCH occurs over multiple slots, e.g., SPS PDSCH. In an example only transmission occasions and/or retransmissions occurring within on-duration periods of a cell DTX are monitored by the UE.

In implementations if a DL signal occupying multiple slots that is not associated with a repetition where a subset of the multiple slots over which the DL signal are a set of transmission occasions corresponding to the DL signal are transmitted within the cell DTX cycle and outside of an on-duration period associated with an on-duration timer of the cell DTX cycle, the UE is not expected to monitor the DL signal. In an example the DL signal is a CSI-RS transmission corresponding to DL multi-TRP transmission (e.g., a CSI-RS Resource Set for channel measurement configured with two Resource Groups and N Resource Pairs) that occupies two consecutive slots. In an example the DL signal is a CSI-RS transmission corresponding to a CSI reporting setting configured with a coherent joint transmission (CJT) Type-II codebook type.

In implementations if a UE is configured with periodic or semi-persistent CSI reporting setting that is configured with a time restriction for channel measurements being turned off, and is configured with cell DTX wherein at least one DTX cycle overlaps with at least one periodic or semi-persistent CSI-RS transmission occasion for channel measurement, the UE ignores the time restriction for channel measurements configuration. For instance, the UE assumes that time restriction for channel measurements is turned on.

In implementations if a UE is configured with periodic or semi-persistent CSI reporting setting that is configured with a time restriction for interference measurements being turned off, and is configured with cell DTX where at least one DTX cycle overlaps with at least one periodic or semi-persistent CSI-RS transmission occasion for interference measurement, the UE ignores the time restriction for interference measurements configuration. The UE, for instance, assumes time restriction for interference measurements is turned on.

Implementations described herein also provide for cell DRX behavior for signals occupying multiple slots. Under such approaches a signal whose reception occupies multiple slots where a subset of the multiple slots are within a cell DRX period outside of the on-time duration (e.g., within inactive time of cell DRX) is discussed. Different behaviors of the signal reception that depend on the subset of the multiple slots are stated. Several implementations are described below and according to implementations one or more elements or features from one or more of the described implementations may be combined.

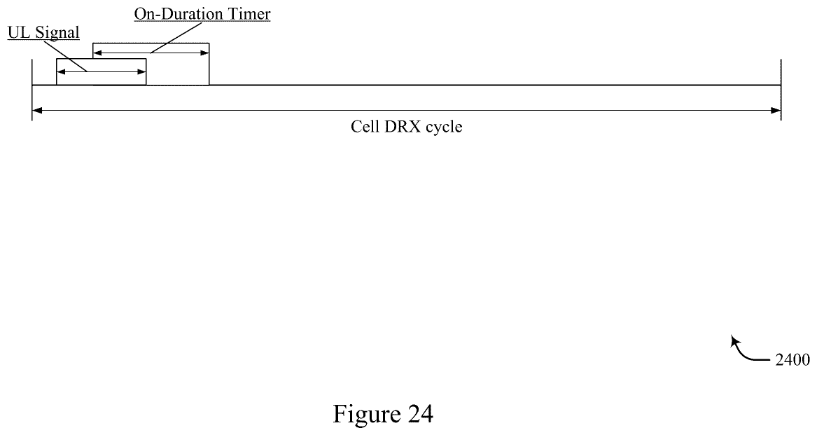

FIG. 24 illustrates an implementation 2400 in accordance with aspects of the present disclosure. The implementation 2400 includes a cell DRX cycle with an UL signal and an on-duration timer. In implementations an UL signal occupying multiple slots is not expected to be transmitted by the UE if cell DRX is configured and if a first slot over which the signal is received within the cell DRX cycle is outside of an on-duration period associated with an on-duration timer of the cell DRX cycle. In an example a PUCCH resource configured with inter-slot repetition is not monitored by the UE if a first PUCCH reception is within the cell DRX cycle and not within the on-duration period, even if subsequent PUCCH reception occasions are within the on-duration period of the cell DRX cycle. In an example an on-duration period corresponds to a period that precedes a start of the on-duration timer of the cell DRX or succeeds an end of the on-duration timer of the cell DRX.

In implementations an UL signal occupying multiple slots is expected to be transmitted by the UE if cell DRX is configured and if a first slot over which the signal is received before a first slot in which a cell DRX cycle is activated. In an example a PUCCH resource configured with inter-slot repetition is monitored by the UE if a first PUCCH reception precedes a start of a first cell DRX cycle activated by the network, even if subsequent PUCCH reception occasions are within the cell DRX cycle and not within the on-duration period of the cell DRX.

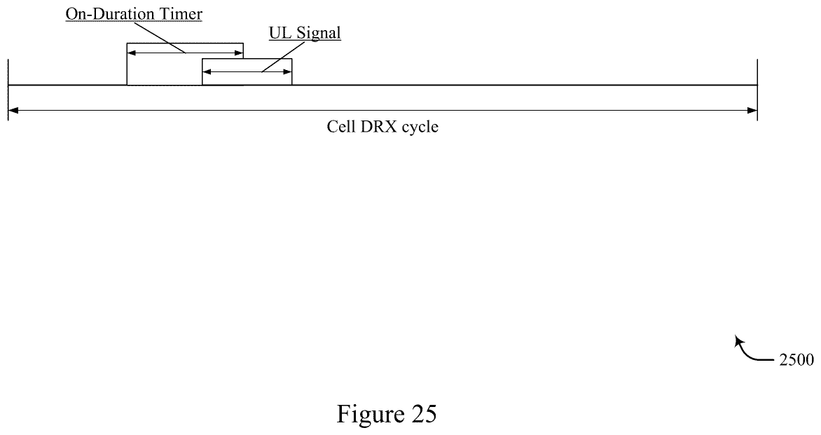

FIG. 25 illustrates an implementation 2500 in accordance with aspects of the present disclosure. The implementation 2500 includes a cell DRX cycle with an UL signal and an on-duration timer. In implementations an UL signal occupying multiple slots is expected to be transmitted by the UE if cell DRX is configured and if a first slot over which the signal is received within the cell DRX cycle and within an on-duration period associated with an on-duration timer of the cell DRX cycle. In an example a PUCCH resource configured with inter-slot repetition is monitored by the UE if a first PUCCH reception is within the cell DRX cycle and within the on-duration period, even if subsequent PUCCH reception occasions are not within the on-duration period of the cell DRX cycle.

In implementations if an UL signal occupying multiple slots that is associated with a repetition where a first subset of reception occasions of a set of reception occasions corresponding to the UL signal are received within the cell DRX cycle and outside of an on-duration period associated with an on-duration timer of the cell DRX cycle, the UE is not expected to transmit the first subset of transmission occasions. The UE, however, may still transmit a second subset of reception occasions of the set of reception occasions corresponding to the UL signal that are received within the cell DRX cycle and within the on-duration period associated with the on-duration timer of the cell DRX cycle.

In an example the UL channel is a PUCCH configured with inter-slot repetition. In an example the UL channel is a PUSCH configured with repetition Type B over multiple slots, e.g., CG PUSCH. In an example only UE retransmissions occurring within on-duration periods of a cell DRX are expected to be retransmitted by the UE.

In implementations if an UL signal occupying multiple slots that is not associated with a repetition where a subset of the multiple slots over which the UL signal are a set of reception occasions corresponding to the UL signal are received within the cell DRX cycle and outside of an on-duration period associated with an on-duration timer of the cell DRX cycle, the UE is not expected to monitor the UL signal. In an example the UL signal is a periodic or semi-persistent SRS transmission corresponding to a usage value set to antenna switching where SRS symbols are transmitted over more than one slot.

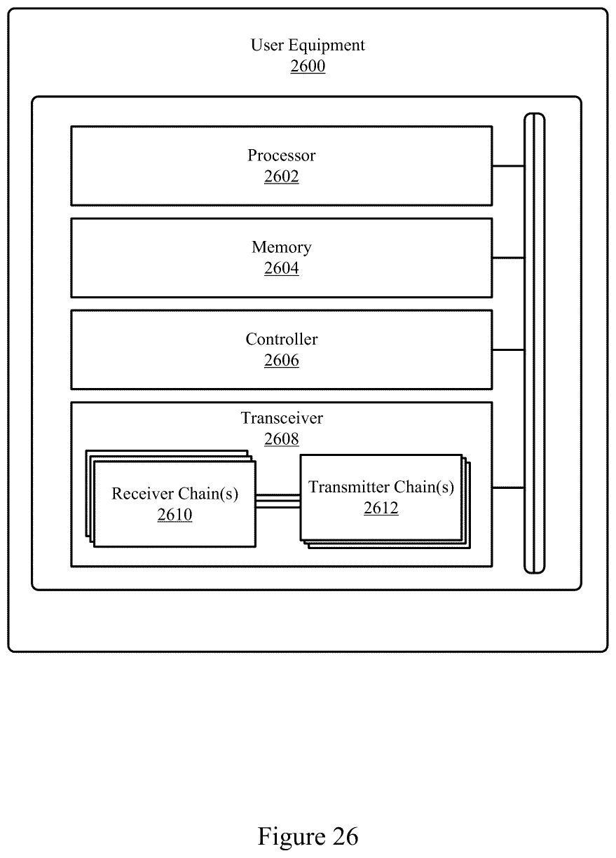

FIG. 26 illustrates an example of a UE 2600 in accordance with aspects of the present disclosure. The UE 2600 may include a processor 2602, a memory 2604, a controller 2606, and a transceiver 2608. The processor 2602, the memory 2604, the controller 2606, or the transceiver 2608, or various combinations thereof or various components thereof may be examples of means for performing various aspects of the present disclosure as described herein. These components may be coupled (e.g., operatively, communicatively, functionally, electronically, electrically) via one or more interfaces.

The processor 2602, the memory 2604, the controller 2606, or the transceiver 2608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2602 may include an intelligent hardware device (e.g., a general-purpose processor, a DSP, a CPU, an ASIC, an FPGA, or any combination thereof). In some implementations, the processor 2602 may be configured to operate the memory 2604. In some other implementations, the memory 2604 may be integrated into the processor 2602. The processor 2602 may be configured to execute computer-readable instructions stored in the memory 2604 to cause the UE 2600 to perform various functions of the present disclosure.

The memory 2604 may include volatile or non-volatile memory. The memory 2604 may store computer-readable, computer-executable code including instructions when executed by the processor 2602 cause the UE 2600 to perform various functions described herein. The code may be stored in a non-transitory computer-readable medium such as the memory 2604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2602 and the memory 2604 coupled with the processor 2602 may be configured to cause the UE 2600 to perform one or more of the functions described herein (e.g., executing, by the processor 2602, instructions stored in the memory 2604). For example, the processor 2602 may support wireless communication at the UE 2600 in accordance with examples as disclosed herein.

The UE 2600 may be configured to or operable to support a means for receiving a first signaling occasion including cell discontinuous signaling configuration and including at least one of: a cell DTX behavior including a cell DTX cycle in which the UE is not to monitor a first signal set corresponding to a cell DTX inactive period and at least two monitor intervals in which the UE is permitted to monitor the first signal set; or a cell DRX behavior including a cell DRX cycle in which the UE is not to transmit a second signal set corresponding to a cell DRX inactive period and at least two transmit intervals in which the UE is permitted to transmit the second signal set; receiving a second signaling occasion activating the cell discontinuous signaling configuration; and performing at least one of: monitoring a first signal monitor group of the first signal set at a first monitor interval of the at least two monitor intervals, and monitor a second signal monitor group of the first signal set at a second monitor interval of the at least two monitor intervals based on the cell DTX behavior; or transmitting a first signal transmit group of the second signal set at a first transmit interval of the at least two transmit intervals, and transmit a second signal transmit group of the second signal set at a second transmit interval of the at least two transmit intervals based on the cell DRX behavior.

Additionally, the UE 2600 may be configured to support any one or combination of a first subset of the first signal set includes at least one of SPS occasions including SPS PDSCH, one or more of periodic or semi-persistent CSI RS for CSI measurement associated with RI reporting, or PDCCH corresponding to DCI formats not associated with scheduling PDSCH or PUSCH; and a second subset of the first signal set includes at least one of SSB, SIB, PTRS, periodic or semi-persistent CSI-RS for BM, PRS, PDCCH scrambled with UE-specific radio network temporary identifier (RNTI), PDCCH in Type-3 CSS, PDCCH for RAR, PDCCH for msg4 hybrid automatic repeat request (HARQ) transmission; at least one of: the first signal monitor group includes the first subset of the first set signal set and the second signal monitor group includes the second subset of the first signal set; the first signal monitor group includes the first subset of the first set signal set and the second subset of the first signal set, and the second signal monitor group includes the second subset of the first signal set; or the first signal monitor group and second signal monitor group each include the first subset of the first set signal set and the second subset of the first signal set.

Additionally, the UE 2600 may be configured to support any one or combination of a first subset of the second signal set includes at least one of CG occasions including CG PUSCH, one or more of periodic or semi-persistent SRS not associated with positioning, one or more of periodic or semi-persistent CSI report over one or more of PUSCH or PUCCH, SR occasions; and a second subset of the second signal set includes at least one of SRS for positioning or HARQ-ACK feedback for SPS PDSCH; at least one of: the first signal transmit group includes the first subset of the second set signal set and the second signal transmit group includes the second subset of the second signal set; the first signal transmit group includes the first subset of the second set signal set and the second subset of the second signal set, and the second signal transmit group includes the second subset of the second signal set; or the first signal transmit group and second signal transmit group each include the first subset of the second set signal set and the second subset of the second signal set.

Additionally, the UE 2600 may be configured to support any one or combination of at least one of: the at least two monitor intervals include at least one of a first monitor interval that precedes a first slot corresponding to a first cell DTX cycle based on a cell DTX activation via the second signaling occasion, and a second monitor interval that succeeds a last slot corresponding to a last cell DTX cycle based on a cell DTX deactivation via the second signaling occasion; or the at least two transmit intervals include at least one of a first transmit interval that precedes a first slot corresponding to a first cell DRX cycle based on a cell DRX activation via the second signaling occasion, and a second transmit interval that succeeds a last slot corresponding to a last DRX cycle based on a cell DRX deactivation via the second signaling occasion; at least one of: one or more signals received in the at least two monitor intervals are based at least in part on aperiodic triggering, wherein aperiodic triggering for one or more signals received in a first monitor interval of the at least two monitor intervals is inferred from cell DTX activation via the second signaling occasion, and aperiodic triggering one or more signals received in a second monitor interval of the at least two monitor intervals is inferred from cell DTX deactivation via the second signaling occasion; or one or more signals transmitted in the at least two transmit intervals are based at least in part on aperiodic triggering.

Additionally, the UE 2600 may be configured to support any one or combination of wherein aperiodic triggering for one or more signals transmitted in a first transmit interval of the at least two transmit intervals is inferred from cell DRX activation via the second signaling occasion, and aperiodic triggering one or more signals transmitted in a second transmit interval of the at least two transmit intervals is inferred from cell DRX deactivation via the second signaling occasion; at least one of: the at least two monitor intervals correspond to two on-duration periods within a same cell DTX cycle, wherein a monitor first interval is associated with a first slot offset value and a first on-duration timer value, and a second monitor interval is associated with a second slot offset value and a second on-duration timer value; or the at least two transmit intervals correspond to two on-duration periods within a same cell DRX cycle, wherein a transmit first interval is associated with a first slot offset value and a first on-duration timer value, and a second transmit interval is associated with a second slot offset value and a second on-duration timer value; at least one of: the cell discontinuous signaling configuration indicates two types of cell DTX cycles, a first type of cell DTX cycle corresponding to a long cell DTX cycle and a second type of cell DTX cycle corresponding to a short cell DTX cycle; or the cell discontinuous signaling configuration indicates two types of cell DRX cycles, a first type of cell DRX cycle corresponding to a long cell DRX cycle and a second type of cell DRX cycle corresponding to a short cell DRX cycle.

Additionally, the UE 2600 may be configured to support any one or combination of at least one of: a length of the long cell DTX cycle is an integer multiple of a length of the short cell DTX cycle, and a first slot offset value associated with a first on-duration timer of the long cell DTX cycle is equivalent to a second slot offset value associated with a second on-duration timer of the short cell DTX cycle, and a first on-duration timer value of the long cell DTX cycle is equivalent to a second first on-duration timer value of the short cell DTX cycle; or a length of the long cell DRX cycle is an integer multiple of a length of the short cell DRX cycle, and a first slot offset value associated with a first on-duration timer of the long cell DRX cycle is equivalent to a second slot offset value associated with a second on-duration timer of the short cell DRX cycle, and a first on-duration timer value of the long cell DRX cycle is equivalent to a second first on-duration timer value of the short cell DRX cycle.

Additionally, the UE 2600 may be configured to support any one or combination of at least one of: the long cell DTX cycle and the short cell DTX cycle are jointly triggered via the second signaling occasion; or the long cell DRX cycle and the short cell DRX cycle are jointly triggered via the second signaling occasion; at least one of: the at least two monitor intervals correspond to two on-duration periods associated with two alternating cell DTX cycles, wherein the first monitor interval is associated with a first slot offset value and a first on-duration timer value, and the second monitor interval is associated with a second slot offset value and a second on-duration timer value; or the at least two transmit intervals correspond to two on-duration periods associated with two alternating cell DRX cycles, wherein the first transmit interval is associated with a third slot offset value and a third on-duration timer value, and the second transmit interval is associated with a fourth slot offset value and a fourth on-duration timer value; at least one of: a signal associated with cell DTX is configured with two higher-layer DTX configurations, a first higher-layer DTX configuration corresponding to a period wherein cell DTX is deactivated, and a second higher-layer DTX configuration corresponding to the at least two monitor intervals associated with cell DTX being activated; or a signal associated with cell DRX is configured with two higher-layer DRX configurations, a first higher-layer DRX configuration corresponding to a period wherein cell DRX is deactivated, and a second higher-layer DRX configuration corresponding to the at least two monitor intervals associated with cell DRX being activated.

Additionally, the UE 2600 may be configured to support any one or combination of at least one of: inferring a trigger of a higher-layer configuration of the two higher-layer configurations from a trigger of one or more of cell DTX activation or cell DTX deactivation via the second signaling occasion; or inferring a trigger of a higher-layer configuration of the two higher-layer configurations from a trigger of one or more of cell DRX activation or cell DRX deactivation via the second signaling occasion; at least one of: a trigger of a higher-layer configuration of the two higher-layer configurations is based at least in part on a cell DTX-based command MAC CE; or a trigger of a higher-layer configuration of the two higher-layer configurations is based at least in part on a cell DRX-based command MAC-CE; at least one of: an ID value of a second higher-layer DTX configuration of the two higher-layer DTX configurations is indicated within at least one of the first signaling occasion or the second signaling occasion; or an ID value of a second higher-layer DRX configuration of the two higher-layer DRX configurations is indicated within at least one of the first signaling occasion or the second signaling occasion.

Additionally, or alternatively, the UE 2600 may support functionality to receive a first signaling occasion including cell discontinuous signaling configuration and including at least one of: a cell DTX behavior including a cell DTX cycle in which the UE is not to monitor a first signal set corresponding to a cell DTX inactive period and at least two monitor intervals in which the UE is permitted to monitor the first signal set; or a cell DRX behavior including a cell DRX cycle in which the UE is not to transmit a second signal set corresponding to a cell DRX inactive period and at least two transmit intervals in which the UE is permitted to transmit the second signal set; receive a second signaling occasion activating the cell discontinuous signaling configuration; and perform at least one of to: monitor a first signal monitor group of the first signal set at a first monitor interval of the at least two monitor intervals, and monitor a second signal monitor group of the first signal set at a second monitor interval of the at least two monitor intervals based on the cell DTX behavior; or transmit a first signal transmit group of the second signal set at a first transmit interval of the at least two transmit intervals, and transmit a second signal transmit group of the second signal set at a second transmit interval of the at least two transmit intervals based on the cell DRX behavior.

Additionally, the UE 2600 may be configured to support any one or combination of where a first subset of the first signal set includes at least one of SPS occasions including SPS PDSCH, one or more of periodic or semi-persistent CSI RS for CSI measurement associated with RI reporting, or PDCCH corresponding to DCI formats not associated with scheduling PDSCH or PUSCH; and a second subset of the first signal set includes at least one of SSB, SIB, PTRS, periodic or semi-persistent CSI-RS for BM, PRS, PDCCH scrambled with UE-specific radio network temporary identifier (RNTI), PDCCH in Type-3 CSS, PDCCH for RAR, PDCCH for msg4 hybrid automatic repeat request (HARQ) transmission.

Additionally, the UE 2600 may be configured to support any one or combination of where at least one of: the first signal monitor group includes the first subset of the first set signal set and the second signal monitor group includes the second subset of the first signal set; the first signal monitor group includes the first subset of the first set signal set and the second subset of the first signal set, and the second signal monitor group includes the second subset of the first signal set; or the first signal monitor group and second signal monitor group each include the first subset of the first set signal set and the second subset of the first signal set; a first subset of the second signal set includes at least one of CG occasions including CG PUSCH, one or more of periodic or semi-persistent SRS not associated with positioning, one or more of periodic or semi-persistent CSI report over one or more of PUSCH or PUCCH, SR occasions; and a second subset of the second signal set includes at least one of SRS for positioning or HARQ-ACK feedback for SPS PDSCH.

Additionally, the UE 2600 may be configured to support any one or combination of where at least one of: the first signal transmit group includes the first subset of the second set signal set and the second signal transmit group includes the second subset of the second signal set; the first signal transmit group includes the first subset of the second set signal set and the second subset of the second signal set, and the second signal transmit group includes the second subset of the second signal set; or the first signal transmit group and second signal transmit group each include the first subset of the second set signal set and the second subset of the second signal set; at least one of: the at least two monitor intervals include at least one of a first monitor interval that precedes a first slot corresponding to a first cell DTX cycle based on a cell DTX activation via the second signaling occasion, and a second monitor interval that succeeds a last slot corresponding to a last cell DTX cycle based on a cell DTX deactivation via the second signaling occasion; or the at least two transmit intervals include at least one of a first transmit interval that precedes a first slot corresponding to a first cell DRX cycle based on a cell DRX activation via the second signaling occasion, and a second transmit interval that succeeds a last slot corresponding to a last DRX cycle based on a cell DRX deactivation via the second signaling occasion.

Additionally, the UE 2600 may be configured to support any one or combination of where at least one of: one or more signals received in the at least two monitor intervals are based at least in part on aperiodic triggering, wherein aperiodic triggering for one or more signals received in a first monitor interval of the at least two monitor intervals is inferred from cell DTX activation via the second signaling occasion, and aperiodic triggering one or more signals received in a second monitor interval of the at least two monitor intervals is inferred from cell DTX deactivation via the second signaling occasion; or one or more signals transmitted in the at least two transmit intervals are based at least in part on aperiodic triggering, wherein aperiodic triggering for one or more signals transmitted in a first transmit interval of the at least two transmit intervals is inferred from cell DRX activation via the second signaling occasion, and aperiodic triggering one or more signals transmitted in a second transmit interval of the at least two transmit intervals is inferred from cell DRX deactivation via the second signaling occasion.

Additionally, the UE 2600 may be configured to support any one or combination of where at least one of: the at least two monitor intervals correspond to two on-duration periods within a same cell DTX cycle, wherein a monitor first interval is associated with a first slot offset value and a first on-duration timer value, and a second monitor interval is associated with a second slot offset value and a second on-duration timer value; or the at least two transmit intervals correspond to two on-duration periods within a same cell DRX cycle, wherein a transmit first interval is associated with a first slot offset value and a first on-duration timer value, and a second transmit interval is associated with a second slot offset value and a second on-duration timer value; at least one of: the cell discontinuous signaling configuration indicates two types of cell DTX cycles, a first type of cell DTX cycle corresponding to a long cell DTX cycle and a second type of cell DTX cycle corresponding to a short cell DTX cycle; or the cell discontinuous signaling configuration indicates two types of cell DRX cycles, a first type of cell DRX cycle corresponding to a long cell DRX cycle and a second type of cell DRX cycle corresponding to a short cell DRX cycle.

Additionally, the UE 2600 may be configured to support any one or combination of where at least one of: a length of the long cell DTX cycle is an integer multiple of a length of the short cell DTX cycle, and a first slot offset value associated with a first on-duration timer of the long cell DTX cycle is equivalent to a second slot offset value associated with a second on-duration timer of the short cell DTX cycle, and a first on-duration timer value of the long cell DTX cycle is equivalent to a second first on-duration timer value of the short cell DTX cycle; or a length of the long cell DRX cycle is an integer multiple of a length of the short cell DRX cycle, and a first slot offset value associated with a first on-duration timer of the long cell DRX cycle is equivalent to a second slot offset value associated with a second on-duration timer of the short cell DRX cycle, and a first on-duration timer value of the long cell DRX cycle is equivalent to a second first on-duration timer value of the short cell DRX cycle; at least one of: the long cell DTX cycle and the short cell DTX cycle are jointly triggered via the second signaling occasion; or the long cell DRX cycle and the short cell DRX cycle are jointly triggered via the second signaling occasion.

Additionally, the UE 2600 may be configured to support any one or combination of where at least one of: the at least two monitor intervals correspond to two on-duration periods associated with two alternating cell DTX cycles, wherein the first monitor interval is associated with a first slot offset value and a first on-duration timer value, and the second monitor interval is associated with a second slot offset value and a second on-duration timer value; or the at least two transmit intervals correspond to two on-duration periods associated with two alternating cell DRX cycles, wherein the first transmit interval is associated with a third slot offset value and a third on-duration timer value, and the second transmit interval is associated with a fourth slot offset value and a fourth on-duration timer value; at least one of: a signal associated with cell DTX is configured with two higher-layer DTX configurations, a first higher-layer DTX configuration corresponding to a period wherein cell DTX is deactivated, and a second higher-layer DTX configuration corresponding to the at least two monitor intervals associated with cell DTX being activated; or a signal associated with cell DRX is configured with two higher-layer DRX configurations, a first higher-layer DRX configuration corresponding to a period wherein cell DRX is deactivated, and a second higher-layer DRX configuration corresponding to the at least two monitor intervals associated with cell DRX being activated.

Additionally, the UE 2600 may be configured to support any one or combination of to infer a trigger of a higher-layer configuration of the two higher-layer configurations from a trigger of one or more of cell DTX activation or cell DTX deactivation via the second signaling occasion; or infer a trigger of a higher-layer configuration of the two higher-layer configurations from a trigger of one or more of cell DRX activation or cell DRX deactivation via the second signaling occasion; at least one of: a trigger of a higher-layer configuration of the two higher-layer configurations is based at least in part on a cell DTX-based command MAC CE; or a trigger of a higher-layer configuration of the two higher-layer configurations is based at least in part on a cell DRX-based command MAC-CE; at least one of: an ID value of a second higher-layer DTX configuration of the two higher-layer DTX configurations is indicated within at least one of the first signaling occasion or the second signaling occasion; or an ID value of a second higher-layer DRX configuration of the two higher-layer DRX configurations is indicated within at least one of the first signaling occasion or the second signaling occasion.

The UE 2600 may be configured to or operable to support a means for receiving a first signaling occasion including cell discontinuous signaling configuration including at least one of: a cell DTX behavior including a plurality of DTX cycles, a DTX cycle including a period of time in which the UE is not to monitor a first set of DL signals except for a first on-duration period configured in each DTX cycle, and a first DL signal in the first set of DL signals occupies a first set of multiple slots that overlap at least in part with slots of the DTX cycle excluding the first on-duration period; or a cell DRX behavior including a plurality of DRX cycles, a DRX cycle including a period of time in which the UE is not to transmit a second set of UL signals except for a second on-duration period configured in each DRX cycle, and a second UL signal in the second set of UL signals occupies a second set of multiple slots that overlap at least in part with slots of the DRX cycle excluding the second on-duration period; receiving a second signaling occasion activating the cell discontinuous signaling configuration; and performing at least one of to: monitoring, based at least in part on the cell DTX behavior, the first DL signal based at least in part on a type of the first DL signal and a first overlapping pattern between the first set of multiple slots and the slots of the DTX cycle excluding the first on-duration period; or transmitting, based at least in part on the cell DRX behavior, the second UL signal based at least in part on a type of the second UL signal and a second overlapping pattern between the second set of multiple slots and the slots of the DRX cycle excluding the second on-duration period.

Additionally, the UE 2600 may be configured to support any one or combination of where at least one of: the first overlapping pattern corresponds to at least a first slot over which a first DL signal is configured and overlaps with the DTX cycle excluding the first on-duration period, and subsequent slots over which the first DL signal do not overlap with the DTX cycle excluding the first on-duration period; or the second overlapping pattern corresponds to at least a second slot over which the second UL signal is configured, overlaps with the DRX cycle excluding the second on-duration period, and subsequent slots over which the second UL signal do not overlap with the DRX cycle excluding the second on-duration period; further including at least one of: not monitoring the first DL signal; or not transmitting the second UL signal; at least one of: the first overlapping pattern corresponds to at least a first slot over which the first DL signal is configured and does not overlap with the DTX cycle excluding the first on-duration period; or the second overlapping pattern corresponds to at least a first slot over which the second UL signal is configured and does not overlap with the DRX cycle excluding the second on-duration period.

Additionally, the UE 2600 may be configured to support any one or combination of at least one of: monitoring the first DL signal; or transmitting the second UL signal; the first DL signal includes at least one of: one or more of a periodic or semi-persistent CSI RS associated with a jointly configured NZP CSI-RS resource pair and two resource groups occupying two consecutive slots; a periodic or semi-persistent CSI-RS associated with a plurality of NZP CSI-RS resources associated with a CSI reporting setting configured with a joint transmission PMI codebook type; or a SPS PDSCH configured with a repetition scheme set to TDM over multiple slots; the second UL signal includes at least one of: a periodic or semi-persistent SRS associated with a usage value set to antenna switching over more than one slot; a PUCCH configured with an inter-slot repetition pattern; or a PUSCH configured with a repetition pattern over multiple slots.

Additionally, the UE 2600 may be configured to support any one or combination of at least one of: the first DL signal is associated with a repetition pattern including multiple transmissions of a same DL signal content from a network over the first set of multiple slots; or the second UL signal is associated with a repetition pattern including multiple scheduled transmissions of a same UL signal content from the UE over the second set of the multiple slots; the first DL signal includes at least a PDSCH configured with a repetition scheme set to TDM over multiple slots; the second UL signal includes at least one of: a PUCCH configured with inter-slot repetition; or a PUSCH configured with repetition type B over multiple slots; at least one of: the first overlapping pattern corresponds to a first subset of the multiple transmissions from the network that overlaps with the DTX cycle excluding the first on-duration period and a second subset of the multiple transmissions from the network does not overlap with the DTX cycle excluding the first on-duration period; or the second overlapping pattern corresponds to a third subset of the multiple scheduled transmissions and overlaps with the DRX cycle excluding the second on-duration period, and a fourth subset of the multiple scheduled transmissions does not overlap with the DRX cycle excluding the second on-duration period.

Additionally, the UE 2600 may be configured to support any one or combination of at least one of: not monitoring the first subset of the multiple transmissions from the network, and to monitor the second subset of the multiple transmissions from the network; or not transmitting the third subset of the multiple scheduled transmissions and transmit the fourth subset of the multiple scheduled transmissions; at least one of: the first DL signal is associated with multiple transmissions of different DL signal content from a network over the first set of multiple slots; or the second UL signal is associated with multiple scheduled transmissions of different UL signal content from the UE over the second set of multiple slots; the first DL signal includes at least one of: a periodic or semi-persistent CSI RS associated with a jointly configured NZP CSI-RS resource pair and two resource groups occupying two consecutive slots; or a periodic or semi-persistent CSI-RS associated with a plurality of NZP CSI-RS resources associated with a CSI reporting setting configured with a joint transmission PMI codebook type.

Additionally, the UE 2600 may be configured to support any one or combination of where the second UL signal includes at least a periodic or semi-persistent SRS associated with a usage value set to antenna switching over more than one slot; at least one of: the first overlapping pattern corresponds to a first subset of the multiple transmissions and overlaps with the DTX cycle excluding the first on-duration period, and a second subset of the multiple transmissions does not overlap with the DTX cycle excluding the first on-duration period; or the second overlapping pattern corresponds to a third subset of the multiple scheduled transmissions and overlaps with the DRX cycle excluding the second on-duration period, and a fourth subset of the multiple transmissions does not overlap with the DRX cycle excluding the second on-duration period; further including at least one of: not monitoring the first DL signal; or not transmitting the second UL signal; the first DL signal is a periodic or semi-persistent NZP CSI RS associated with a CSI reporting setting configured with one or more of a time restriction for channel measurements configuration set to disabled or a time restriction for interference measurements configuration set to disabled; further including ignoring the time restriction for channel measurements configuration and the time restriction for interference measurements configuration from the CSI reporting setting, and assuming time restriction for channel measurements configuration and time restriction for interference measurements configuration; the first DL signal occupies a single slot for each transmission occasion.

Additionally, or alternatively, the UE 2600 may support functionality to receive a first signaling occasion including cell discontinuous signaling configuration including at least one of: a cell DTX behavior including a plurality of DTX cycles, a DTX cycle including a period of time in which the UE is not to monitor a first set of DL signals except for a first on-duration period configured in each DTX cycle, and a first DL signal in the first set of DL signals occupies a first set of multiple slots that overlap at least in part with slots of the DTX cycle excluding the first on-duration period; or a cell DRX behavior including a plurality of DRX cycles, a DRX cycle including a period of time in which the UE is not to transmit a second set of UL signals except for a second on-duration period configured in each DRX cycle, and a second UL signal in the second set of UL signals occupies a second set of multiple slots that overlap at least in part with slots of the DRX cycle excluding the second on-duration period; receive a second signaling occasion activating the cell discontinuous signaling configuration; and perform at least one of to: monitor, based at least in part on the cell DTX behavior, the first DL signal based at least in part on a type of the first DL signal and a first overlapping pattern between the first set of multiple slots and the slots of the DTX cycle excluding the first on-duration period; or transmit, based at least in part on the cell DRX behavior, the second UL signal based at least in part on a type of the second UL signal and a second overlapping pattern between the second set of multiple slots and the slots of the DRX cycle excluding the second on-duration period.

Additionally, the UE 2600 may be configured to support any one or combination of at least one of: the first overlapping pattern corresponds to at least a first slot over which a first DL signal is configured and overlaps with the DTX cycle excluding the first on-duration period, and subsequent slots over which the first DL signal do not overlap with the DTX cycle excluding the first on-duration period; or the second overlapping pattern corresponds to at least a second slot over which the second UL signal is configured, overlaps with the DRX cycle excluding the second on-duration period, and subsequent slots over which the second UL signal do not overlap with the DRX cycle excluding the second on-duration period; the at least one processor is configured to cause the UE to least one of: not monitor the first DL signal; or not transmit the second UL signal; at least one of: the first overlapping pattern corresponds to at least a first slot over which the first DL signal is configured and does not overlap with the DTX cycle excluding the first on-duration period; or the second overlapping pattern corresponds to at least a first slot over which the second UL signal is configured and does not overlap with the DRX cycle excluding the second on-duration period.

Additionally, the UE 2600 may be configured to support any one or combination of where the at least one processor is configured to cause the UE to at least one of: monitor the first DL signal; or transmit the second UL signal; the first DL signal includes at least one of: one or more of a periodic or semi-persistent CSI RS associated with a jointly configured NZP CSI-RS resource pair and two resource groups occupying two consecutive slots; a periodic or semi-persistent CSI-RS associated with a plurality of NZP CSI-RS resources associated with a CSI reporting setting configured with a joint transmission PMI codebook type; or a SPS PDSCH configured with a repetition scheme set to TDM over multiple slots; the second UL signal includes at least one of: a periodic or semi-persistent SRS associated with a usage value set to antenna switching over more than one slot; a PUCCH configured with an inter-slot repetition pattern; or a PUSCH configured with a repetition pattern over multiple slots.

Additionally, the UE 2600 may be configured to support any one or combination of at least one of: the first DL signal is associated with a repetition pattern including multiple transmissions of a same DL signal content from a network over the first set of multiple slots; or the second UL signal is associated with a repetition pattern including multiple scheduled transmissions of a same UL signal content from the UE over the second set of the multiple slots; the first DL signal includes at least a PDSCH configured with a repetition scheme set to TDM over multiple slots; the second UL signal includes at least one of: a PUCCH configured with inter-slot repetition; or a PUSCH configured with repetition type B over multiple slots; at least one of: the first overlapping pattern corresponds to a first subset of the multiple transmissions from the network that overlaps with the DTX cycle excluding the first on-duration period and a second subset of the multiple transmissions from the network does not overlap with the DTX cycle excluding the first on-duration period; or the second overlapping pattern corresponds to a third subset of the multiple scheduled transmissions and overlaps with the DRX cycle excluding the second on-duration period, and a fourth subset of the multiple scheduled transmissions does not overlap with the DRX cycle excluding the second on-duration period.

Additionally, the UE 2600 may be configured to support any one or combination of where the at least one processor is configured to cause the UE to at least one of: not monitor the first subset of the multiple transmissions from the network, and to monitor the second subset of the multiple transmissions from the network; or not transmit the third subset of the multiple scheduled transmissions and transmit the fourth subset of the multiple scheduled transmissions; at least one of: the first DL signal is associated with multiple transmissions of different DL signal content from a network over the first set of multiple slots; or the second UL signal is associated with multiple scheduled transmissions of different UL signal content from the UE over the second set of multiple slots; the first DL signal includes at least one of: a periodic or semi-persistent CSI RS associated with a jointly configured NZP CSI-RS resource pair and two resource groups occupying two consecutive slots; or a periodic or semi-persistent CSI-RS associated with a plurality of NZP CSI-RS resources associated with a CSI reporting setting configured with a joint transmission PMI codebook type.

Additionally, the UE 2600 may be configured to support any one or combination of where the second UL signal includes at least a periodic or semi-persistent SRS associated with a usage value set to antenna switching over more than one slot; at least one of: the first overlapping pattern corresponds to a first subset of the multiple transmissions and overlaps with the DTX cycle excluding the first on-duration period, and a second subset of the multiple transmissions does not overlap with the DTX cycle excluding the first on-duration period; or the second overlapping pattern corresponds to a third subset of the multiple scheduled transmissions and overlaps with the DRX cycle excluding the second on-duration period, and a fourth subset of the multiple transmissions does not overlap with the DRX cycle excluding the second on-duration period; the at least one processor is configured to cause the UE to at least one of: not monitor the first DL signal; or not transmit the second UL signal; the first DL signal is a periodic or semi-persistent NZP CSI RS associated with a CSI reporting setting configured with one or more of a time restriction for channel measurements configuration set to disabled or a time restriction for interference measurements configuration set to disabled; the at least one processor is configured to cause the UE to ignore the time restriction for channel measurements configuration and the time restriction for interference measurements configuration from the CSI reporting setting, and assume time restriction for channel measurements configuration and time restriction for interference measurements configuration; the first DL signal occupies a single slot for each transmission occasion.

The controller 2606 may manage input and output signals for the UE 2600. The controller 2606 may also manage peripherals not integrated into the UE 2600. In some implementations, the controller 2606 may utilize an operating system such as iOS®, ANDROID®, WINDOWS®, or other operating systems. In some implementations, the controller 2606 may be implemented as part of the processor 2602.

In some implementations, the UE 2600 may include at least one transceiver 2608. In some other implementations, the UE 2600 may have more than one transceiver 2608. The transceiver 2608 may represent a wireless transceiver. The transceiver 2608 may include one or more receiver chains 2610, one or more transmitter chains 2612, or a combination thereof.

A receiver chain 2610 may be configured to receive signals (e.g., control information, data, packets) over a wireless medium. For example, the receiver chain 2610 may include one or more antennas to receive a signal over the air or wireless medium. The receiver chain 2610 may include at least one amplifier (e.g., a low-noise amplifier (LNA)) configured to amplify the received signal. The receiver chain 2610 may include at least one demodulator configured to demodulate the receive signal and obtain the transmitted data by reversing the modulation technique applied during transmission of the signal. The receiver chain 2610 may include at least one decoder for decoding the demodulated signal to receive the transmitted data.

A transmitter chain 2612 may be configured to generate and transmit signals (e.g., control information, data, packets). The transmitter chain 2612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 2612 may also include at least one power amplifier configured to amplify the modulated signal to an appropriate power level suitable for transmission over the wireless medium. The transmitter chain 2612 may also include one or more antennas for transmitting the amplified signal into the air or wireless medium.

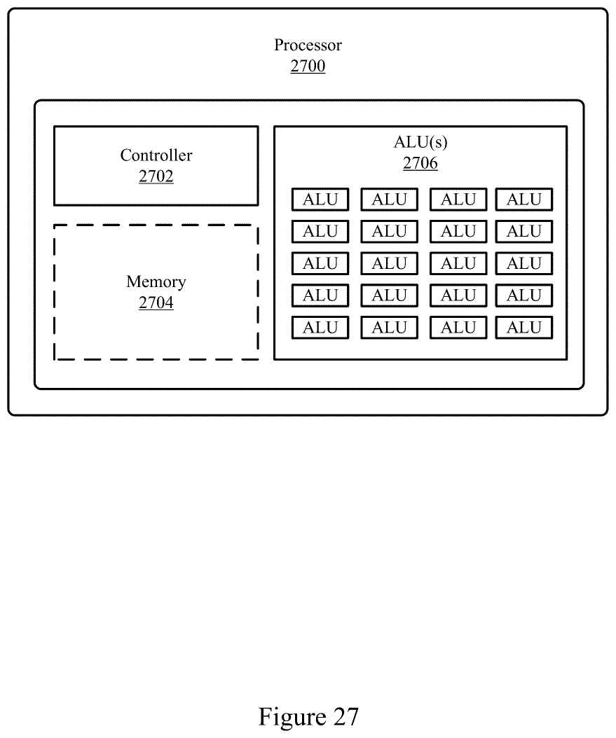

FIG. 27 illustrates an example of a processor 2700 in accordance with aspects of the present disclosure. The processor 2700 may be an example of a processor configured to perform various operations in accordance with examples as described herein. The processor 2700 may include a controller 2702 configured to perform various operations in accordance with examples as described herein. The processor 2700 may optionally include at least one memory 2704, which may be, for example, an L1/L2/L3 cache. Additionally, or alternatively, the processor 2700 may optionally include one or more arithmetic-logic units (ALUs) 2706. One or more of these components may be in electronic communication or otherwise coupled (e.g., operatively, communicatively, functionally, electronically, electrically) via one or more interfaces (e.g., buses).

The processor 2700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 2700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 2702 may be configured to manage and coordinate various operations (e.g., signaling, receiving, obtaining, retrieving, transmitting, outputting, forwarding, storing, determining, identifying, accessing, writing, reading) of the processor 2700 to cause the processor 2700 to support various operations in accordance with examples as described herein. For example, the controller 2702 may operate as a control unit of the processor 2700, generating control signals that manage the operation of various components of the processor 2700. These control signals include enabling or disabling functional units, selecting data paths, initiating memory access, and coordinating timing of operations.

The controller 2702 may be configured to fetch (e.g., obtain, retrieve, receive) instructions from the memory 2704 and determine subsequent instruction(s) to be executed to cause the processor 2700 to support various operations in accordance with examples as described herein. The controller 2702 may be configured to track memory addresses of instructions associated with the memory 2704. The controller 2702 may be configured to decode instructions to determine the operation to be performed and the operands involved. For example, the controller 2702 may be configured to interpret the instruction and determine control signals to be output to other components of the processor 2700 to cause the processor 2700 to support various operations in accordance with examples as described herein. Additionally, or alternatively, the controller 2702 may be configured to manage flow of data within the processor 2700. The controller 2702 may be configured to control transfer of data between registers, ALUs 2706, and other functional units of the processor 2700.

The memory 2704 may include one or more caches (e.g., memory local to or included in the processor 2700 or other memory, such as RAM, ROM, DRAM, SDRAM, SRAM, MRAM, flash memory, etc. In some implementations, the memory 2704 may reside within or on a processor chipset (e.g., local to the processor 2700). In some other implementations, the memory 2704 may reside external to the processor chipset (e.g., remote to the processor 2700).

The memory 2704 may store computer-readable, computer-executable code including instructions that, when executed by the processor 2700, cause the processor 2700 to perform various functions described herein. The code may be stored in a non-transitory computer-readable medium such as system memory or another type of memory. The controller 2702 and/or the processor 2700 may be configured to execute computer-readable instructions stored in the memory 2704 to cause the processor 2700 to perform various functions. For example, the processor 2700 and/or the controller 2702 may be coupled with or to the memory 2704, the processor 2700, and the controller 2702, and may be configured to perform various functions described herein. In some examples, the processor 2700 may include multiple processors and the memory 2704 may include multiple memories. One or more of the multiple processors may be coupled with one or more of the multiple memories, which may, individually or collectively, be configured to perform various functions herein.

The one or more ALUs 2706 may be configured to support various operations in accordance with examples as described herein. In some implementations, the one or more ALUs 2706 may reside within or on a processor chipset (e.g., the processor 2700). In some other implementations, the one or more ALUs 2706 may reside external to the processor chipset (e.g., the processor 2700). One or more ALUs 2706 may perform one or more computations such as addition, subtraction, multiplication, and division on data. For example, one or more ALUs 2706 may receive input operands and an operation code, which determines an operation to be executed. One or more ALUs 2706 may be configured with a variety of logical and arithmetic circuits, including adders, subtractors, shifters, and logic gates, to process and manipulate the data according to the operation. Additionally, or alternatively, the one or more ALUs 2706 may support logical operations such as AND, OR, exclusive-OR (XOR), not-OR (NOR), and not-AND (NAND), enabling the one or more ALUs 2706 to handle conditional operations, comparisons, and bitwise operations.

The processor 2700 may support wireless communication in accordance with examples as disclosed herein. The processor 2700 may be configured to or operable to receive a first signaling occasion including cell discontinuous signaling configuration and including at least one of: a cell DTX behavior including a cell DTX cycle in which a UE is not to monitor a first signal set corresponding to a cell DTX inactive period and at least two monitor intervals in which the UE is permitted to monitor the first signal set; or a cell DRX behavior including a cell DRX cycle in which the UE is not to transmit a second signal set corresponding to a cell DRX inactive period and at least two transmit intervals in which the UE is permitted to transmit the second signal set; receive a second signaling occasion activating the cell discontinuous signaling configuration; and perform at least one of to: monitor a first signal monitor group of the first signal set at a first monitor interval of the at least two monitor intervals, and monitor a second signal monitor group of the first signal set at a second monitor interval of the at least two monitor intervals based on the cell DTX behavior; or transmit a first signal transmit group of the second signal set at a first transmit interval of the at least two transmit intervals, and transmit a second signal transmit group of the second signal set at a second transmit interval of the at least two transmit intervals based on the cell DRX behavior.

Additionally, the processor 2700 may be configured to support any one or combination of where a first subset of the first signal set includes at least one of SPS occasions including SPS PDSCH, one or more of periodic or semi-persistent CSI RS for CSI measurement associated with RI reporting, or PDCCH corresponding to DCI formats not associated with scheduling PDSCH or PUSCH; and a second subset of the first signal set includes at least one of SSB, SIB, PTRS, periodic or semi-persistent CSI-RS for BM, PRS, PDCCH scrambled with UE-specific radio network temporary identifier (RNTI), PDCCH in Type-3 CSS, PDCCH for RAR, PDCCH for msg4 hybrid automatic repeat request (HARQ) transmission; at least one of: the first signal monitor group includes the first subset of the first set signal set and the second signal monitor group includes the second subset of the first signal set.

Additionally, the processor 2700 may be configured to support any one or combination of where the first signal monitor group includes the first subset of the first set signal set and the second subset of the first signal set, and the second signal monitor group includes the second subset of the first signal set; or the first signal monitor group and second signal monitor group each include the first subset of the first set signal set and the second subset of the first signal set; a first subset of the second signal set includes at least one of CG occasions including CG PUSCH, one or more of periodic or semi-persistent SRS not associated with positioning, one or more of periodic or semi-persistent CSI report over one or more of PUSCH or PUCCH, SR occasions; and a second subset of the second signal set includes at least one of SRS for positioning or HARQ-ACK feedback for SPS PDSCH.

Additionally, the processor 2700 may be configured to support any one or combination of at least one of: the first signal transmit group includes the first subset of the second set signal set and the second signal transmit group includes the second subset of the second signal set; the first signal transmit group includes the first subset of the second set signal set and the second subset of the second signal set, and the second signal transmit group includes the second subset of the second signal set; or the first signal transmit group and second signal transmit group each include the first subset of the second set signal set and the second subset of the second signal set; at least one of: the at least two monitor intervals include at least one of a first monitor interval that precedes a first slot corresponding to a first cell DTX cycle based on a cell DTX activation via the second signaling occasion, and a second monitor interval that succeeds a last slot corresponding to a last cell DTX cycle based on a cell DTX deactivation via the second signaling occasion; or the at least two transmit intervals include at least one of a first transmit interval that precedes a first slot corresponding to a first cell DRX cycle based on a cell DRX activation via the second signaling occasion, and a second transmit interval that succeeds a last slot corresponding to a last DRX cycle based on a cell DRX deactivation via the second signaling occasion.

Additionally, the processor 2700 may be configured to support any one or combination of at least one of: one or more signals received in the at least two monitor intervals are based at least in part on aperiodic triggering, wherein aperiodic triggering for one or more signals received in a first monitor interval of the at least two monitor intervals is inferred from cell DTX activation via the second signaling occasion, and aperiodic triggering one or more signals received in a second monitor interval of the at least two monitor intervals is inferred from cell DTX deactivation via the second signaling occasion; or one or more signals transmitted in the at least two transmit intervals are based at least in part on aperiodic triggering, wherein aperiodic triggering for one or more signals transmitted in a first transmit interval of the at least two transmit intervals is inferred from cell DRX activation via the second signaling occasion, and aperiodic triggering one or more signals transmitted in a second transmit interval of the at least two transmit intervals is inferred from cell DRX deactivation via the second signaling occasion.

Additionally, the processor 2700 may be configured to support any one or combination of at least one of: the at least two monitor intervals correspond to two on-duration periods within a same cell DTX cycle, wherein a monitor first interval is associated with a first slot offset value and a first on-duration timer value, and a second monitor interval is associated with a second slot offset value and a second on-duration timer value; or the at least two transmit intervals correspond to two on-duration periods within a same cell DRX cycle, wherein a transmit first interval is associated with a first slot offset value and a first on-duration timer value, and a second transmit interval is associated with a second slot offset value and a second on-duration timer value; at least one of: the cell discontinuous signaling configuration indicates two types of cell DTX cycles, a first type of cell DTX cycle corresponding to a long cell DTX cycle and a second type of cell DTX cycle corresponding to a short cell DTX cycle; or the cell discontinuous signaling configuration indicates two types of cell DRX cycles, a first type of cell DRX cycle corresponding to a long cell DRX cycle and a second type of cell DRX cycle corresponding to a short cell DRX cycle.

Additionally, the processor 2700 may be configured to support any one or combination of at least one of: a length of the long cell DTX cycle is an integer multiple of a length of the short cell DTX cycle, and a first slot offset value associated with a first on-duration timer of the long cell DTX cycle is equivalent to a second slot offset value associated with a second on-duration timer of the short cell DTX cycle, and a first on-duration timer value of the long cell DTX cycle is equivalent to a second first on-duration timer value of the short cell DTX cycle; or a length of the long cell DRX cycle is an integer multiple of a length of the short cell DRX cycle, and a first slot offset value associated with a first on-duration timer of the long cell DRX cycle is equivalent to a second slot offset value associated with a second on-duration timer of the short cell DRX cycle, and a first on-duration timer value of the long cell DRX cycle is equivalent to a second first on-duration timer value of the short cell DRX cycle; at least one of: the long cell DTX cycle and the short cell DTX cycle are jointly triggered via the second signaling occasion; or the long cell DRX cycle and the short cell DRX cycle are jointly triggered via the second signaling occasion.

Additionally, the processor 2700 may be configured to support any one or combination of at least one of: the at least two monitor intervals correspond to two on-duration periods associated with two alternating cell DTX cycles, wherein the first monitor interval is associated with a first slot offset value and a first on-duration timer value, and the second monitor interval is associated with a second slot offset value and a second on-duration timer value; or the at least two transmit intervals correspond to two on-duration periods associated with two alternating cell DRX cycles, wherein the first transmit interval is associated with a third slot offset value and a third on-duration timer value, and the second transmit interval is associated with a fourth slot offset value and a fourth on-duration timer value; at least one of: a signal associated with cell DTX is configured with two higher-layer DTX configurations, a first higher-layer DTX configuration corresponding to a period wherein cell DTX is deactivated, and a second higher-layer DTX configuration corresponding to the at least two monitor intervals associated with cell DTX being activated; or a signal associated with cell DRX is configured with two higher-layer DRX configurations, a first higher-layer DRX configuration corresponding to a period wherein cell DRX is deactivated, and a second higher-layer DRX configuration corresponding to the at least two monitor intervals associated with cell DRX being activated.

Additionally, the processor 2700 may be configured to support any one or combination of where the at least one controller is configured to cause the processor to at least one of: infer a trigger of a higher-layer configuration of the two higher-layer configurations from a trigger of one or more of cell DTX activation or cell DTX deactivation via the second signaling occasion; or infer a trigger of a higher-layer configuration of the two higher-layer configurations from a trigger of one or more of cell DRX activation or cell DRX deactivation via the second signaling occasion; at least one of: a trigger of a higher-layer configuration of the two higher-layer configurations is based at least in part on a cell DTX-based command MAC CE; or a trigger of a higher-layer configuration of the two higher-layer configurations is based at least in part on a cell DRX-based command MAC-CE; at least one of: an ID value of a second higher-layer DTX configuration of the two higher-layer DTX configurations is indicated within at least one of the first signaling occasion or the second signaling occasion; or an ID value of a second higher-layer DRX configuration of the two higher-layer DRX configurations is indicated within at least one of the first signaling occasion or the second signaling occasion.

The processor 2700 may support wireless communication in accordance with examples as disclosed herein. The processor 2700 may be configured to or operable to receive a first signaling occasion including cell discontinuous signaling configuration including at least one of: a cell DTX behavior including a plurality of DTX cycles, a DTX cycle including a period of time in which a UE is not to monitor a first set of DL signals except for a first on-duration period configured in each DTX cycle, and a first DL signal in the first set of DL signals occupies a first set of multiple slots that overlap at least in part with slots of the DTX cycle excluding the first on-duration period; or a cell DRX behavior including a plurality of DRX cycles, a DRX cycle including a period of time in which the UE is not to transmit a second set of UL signals except for a second on-duration period configured in each DRX cycle, and a second UL signal in the second set of UL signals occupies a second set of multiple slots that overlap at least in part with slots of the DRX cycle excluding the second on-duration period; receive a second signaling occasion activating the cell discontinuous signaling configuration; and perform at least one of to: monitor, based at least in part on the cell DTX behavior, the first DL signal based at least in part on a type of the first DL signal and a first overlapping pattern between the first set of multiple slots and the slots of the DTX cycle excluding the first on-duration period; or transmit, based at least in part on the cell DRX behavior, the second UL signal based at least in part on a type of the second UL signal and a second overlapping pattern between the second set of multiple slots and the slots of the DRX cycle excluding the second on-duration period.

Additionally, the processor 2700 may be configured to support any one or combination of at least one of: the first overlapping pattern corresponds to at least a first slot over which a first DL signal is configured and overlaps with the DTX cycle excluding the first on-duration period, and subsequent slots over which the first DL signal do not overlap with the DTX cycle excluding the first on-duration period; or the second overlapping pattern corresponds to at least a second slot over which the second UL signal is configured, overlaps with the DRX cycle excluding the second on-duration period, and subsequent slots over which the second UL signal do not overlap with the DRX cycle excluding the second on-duration period; the at least one controller is configured to cause the processor to least one of: not monitor the first DL signal; or not transmit the second UL signal; at least one of: the first overlapping pattern corresponds to at least a first slot over which the first DL signal is configured and does not overlap with the DTX cycle excluding the first on-duration period; or the second overlapping pattern corresponds to at least a first slot over which the second UL signal is configured and does not overlap with the DRX cycle excluding the second on-duration period; the at least one controller is configured to cause the processor to least one of: monitor the first DL signal; or transmit the second UL signal.

Additionally, the processor 2700 may be configured to support any one or combination of where the first DL signal includes at least one of: one or more of a periodic or semi-persistent CSI RS associated with a jointly configured NZP CSI-RS resource pair and two resource groups occupying two consecutive slots; a periodic or semi-persistent CSI-RS associated with a plurality of NZP CSI-RS resources associated with a CSI reporting setting configured with a joint transmission PMI codebook type; or a SPS PDSCH configured with a repetition scheme set to TDM over multiple slots; the second UL signal includes at least one of: a periodic or semi-persistent SRS associated with a usage value set to antenna switching over more than one slot; a PUCCH configured with an inter-slot repetition pattern; or a PUSCH configured with a repetition pattern over multiple slots.

Additionally, the processor 2700 may be configured to support any one or combination of at least one of: the first DL signal is associated with a repetition pattern including multiple transmissions of a same DL signal content from a network over the first set of multiple slots; or the second UL signal is associated with a repetition pattern including multiple scheduled transmissions of a same UL signal content from the UE over the second set of the multiple slots; the first DL signal includes at least a PDSCH configured with a repetition scheme set to TDM over multiple slots; the second UL signal includes at least one of: a PUCCH configured with inter-slot repetition; or a PUSCH configured with repetition type B over multiple slots; at least one of: the first overlapping pattern corresponds to a first subset of the multiple transmissions from the network that overlaps with the DTX cycle excluding the first on-duration period and a second subset of the multiple transmissions from the network does not overlap with the DTX cycle excluding the first on-duration period; or the second overlapping pattern corresponds to a third subset of the multiple scheduled transmissions and overlaps with the DRX cycle excluding the second on-duration period, and a fourth subset of the multiple scheduled transmissions does not overlap with the DRX cycle excluding the second on-duration period.

Additionally, the processor 2700 may be configured to support any one or combination of where the at least one controller is configured to cause the processor to least one of: not monitor the first subset of the multiple transmissions from the network, and to monitor the second subset of the multiple transmissions from the network; or not transmit the third subset of the multiple scheduled transmissions and transmit the fourth subset of the multiple scheduled transmissions; at least one of: the first DL signal is associated with multiple transmissions of different DL signal content from a network over the first set of multiple slots; or the second UL signal is associated with multiple scheduled transmissions of different UL signal content from the UE over the second set of multiple slots; the first DL signal includes at least one of: a periodic or semi-persistent CSI RS associated with a jointly configured NZP CSI-RS resource pair and two resource groups occupying two consecutive slots; or a periodic or semi-persistent CSI-RS associated with a plurality of NZP CSI-RS resources associated with a CSI reporting setting configured with a joint transmission PMI codebook type.

Additionally, the processor 2700 may be configured to support any one or combination of where the second UL signal includes at least a periodic or semi-persistent SRS associated with a usage value set to antenna switching over more than one slot; at least one of: the first overlapping pattern corresponds to a first subset of the multiple transmissions and overlaps with the DTX cycle excluding the first on-duration period, and a second subset of the multiple transmissions does not overlap with the DTX cycle excluding the first on-duration period; or the second overlapping pattern corresponds to a third subset of the multiple scheduled transmissions and overlaps with the DRX cycle excluding the second on-duration period, and a fourth subset of the multiple transmissions does not overlap with the DRX cycle excluding the second on-duration period; the at least one controller is configured to cause the processor to least one of: not monitor the first DL signal; or not transmit the second UL signal; the first DL signal is a periodic or semi-persistent NZP CSI RS associated with a CSI reporting setting configured with one or more of a time restriction for channel measurements configuration set to disabled or a time restriction for interference measurements configuration set to disabled; the at least one controller is configured to cause the processor to least one of ignore the time restriction for channel measurements configuration and the time restriction for interference measurements configuration from the CSI reporting setting, and assume time restriction for channel measurements configuration and time restriction for interference measurements configuration; the first DL signal occupies a single slot for each transmission occasion.

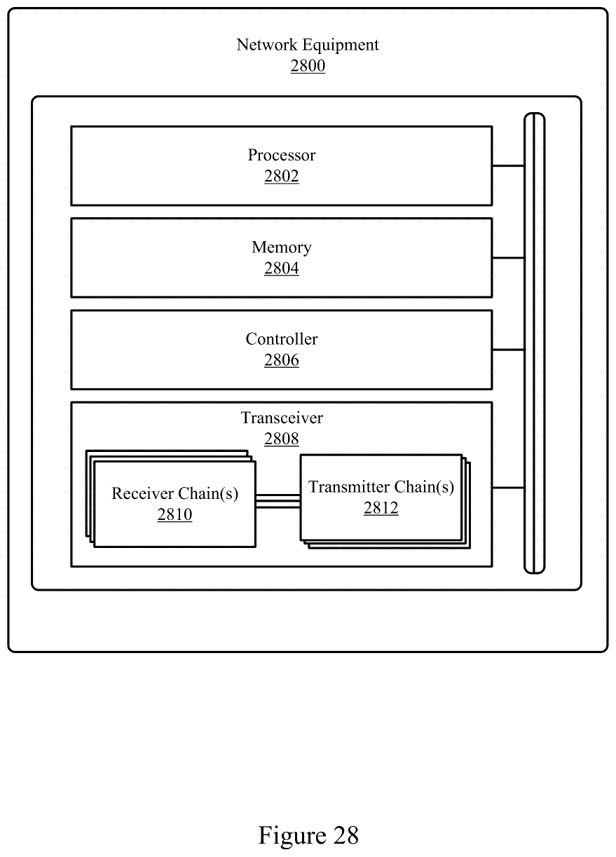

FIG. 28 illustrates an example of a NE 2800 in accordance with aspects of the present disclosure. The NE 2800 may include a processor 2802, a memory 2804, a controller 2806, and a transceiver 2808. The processor 2802, the memory 2804, the controller 2806, or the transceiver 2808, or various combinations thereof or various components thereof may be examples of means for performing various aspects of the present disclosure as described herein. These components may be coupled (e.g., operatively, communicatively, functionally, electronically, electrically) via one or more interfaces.

The processor 2802, the memory 2804, the controller 2806, or the transceiver 2808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2802 may include an intelligent hardware device (e.g., a general-purpose processor, a DSP, a CPU, an ASIC, an FPGA, or any combination thereof). In some implementations, the processor 2802 may be configured to operate the memory 2804. In some other implementations, the memory 2804 may be integrated into the processor 2802. The processor 2802 may be configured to execute computer-readable instructions stored in the memory 2804 to cause the NE 2800 to perform various functions of the present disclosure.

The memory 2804 may include volatile or non-volatile memory. The memory 2804 may store computer-readable, computer-executable code including instructions when executed by the processor 2802 cause the NE 2800 to perform various functions described herein. The code may be stored in a non-transitory computer-readable medium such as the memory 2804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2802 and the memory 2804 coupled with the processor 2802 may be configured to cause the NE 2800 to perform one or more of the functions described herein (e.g., executing, by the processor 2802, instructions stored in the memory 2804). For example, the processor 2802 may support wireless communication at the NE 2800 in accordance with examples as disclosed herein.

The NE 2800 may be configured to or operable to support a means for transmitting, to a UE, a first signaling occasion including cell discontinuous signaling configuration and including at least one of: a cell DTX behavior including a cell DTX cycle in which the UE is not to monitor a first signal set corresponding to a cell DTX inactive period and at least two monitor intervals in which the UE is permitted to monitor the first signal set; or a cell DRX behavior including a cell DRX cycle in which the UE is not to transmit a second signal set corresponding to a cell DRX inactive period and at least two transmit intervals in which the UE is permitted to transmit the second signal set; and transmitting, to the UE, a second signaling occasion activating the cell discontinuous signaling configuration.

Additionally, the NE 2800 may be configured to support any one or combination of where a first subset of the first signal set includes at least one of SPS occasions including SPS PDSCH, one or more of periodic or semi-persistent CSI RS for CSI measurement associated with RI reporting, or PDCCH corresponding to DCI formats not associated with scheduling PDSCH or PUSCH; and a second subset of the first signal set includes at least one of SSB, SIB, PTRS, periodic or semi-persistent CSI-RS for BM, PRS, PDCCH scrambled with UE-specific radio network temporary identifier (RNTI), PDCCH in Type-3 CSS, PDCCH for RAR, PDCCH for msg4 hybrid automatic repeat request (HARQ) transmission; a first subset of the second signal set includes at least one of CG occasions including CG PUSCH, one or more of periodic or semi-persistent SRS not associated with positioning, one or more of periodic or semi-persistent CSI report over one or more of PUSCH or PUCCH, SR occasions; and a second subset of the second signal set includes at least one of SRS for positioning or HARQ-ACK feedback for SPS PDSCH.

Additionally, the NE 2800 may be configured to support any one or combination of at least one of: the at least two monitor intervals include at least one of a first monitor interval that precedes a first slot corresponding to a first cell DTX cycle based on a cell DTX activation via the second signaling occasion, and a second monitor interval that succeeds a last slot corresponding to a last cell DTX cycle based on a cell DTX deactivation via the second signaling occasion; or the at least two transmit intervals include at least one of a first transmit interval that precedes a first slot corresponding to a first cell DRX cycle based on a cell DRX activation via the second signaling occasion, and a second transmit interval that succeeds a last slot corresponding to a last DRX cycle based on a cell DRX deactivation via the second signaling occasion; at least one of: the at least two monitor intervals correspond to two on-duration periods within a same cell DTX cycle, wherein a monitor first interval is associated with a first slot offset value and a first on-duration timer value, and a second monitor interval is associated with a second slot offset value and a second on-duration timer value; or the at least two transmit intervals correspond to two on-duration periods within a same cell DRX cycle, wherein a transmit first interval is associated with a first slot offset value and a first on-duration timer value, and a second transmit interval is associated with a second slot offset value and a second on-duration timer value.

Additionally, the NE 2800 may be configured to support any one or combination of at least one of: the cell discontinuous signaling configuration indicates at least two types of cell DTX cycles, a first type of cell DTX cycle corresponding to a long cell DTX cycle and a second type of cell DTX cycle corresponding to a short cell DTX cycle; or the cell discontinuous signaling configuration indicates at least two types of cell DRX cycles, a first type of cell DRX cycle corresponding to a long cell DRX cycle and a second type of cell DRX cycle corresponding to a short cell DRX cycle; at least one of: a length of the long cell DTX cycle is an integer multiple of a length of the short cell DTX cycle, and a first slot offset value associated with a first on-duration timer of the long cell DTX cycle is equivalent to a second slot offset value associated with a second on-duration timer of the short cell DTX cycle, and a first on-duration timer value of the long cell DTX cycle is equivalent to a second first on-duration timer value of the short cell DTX cycle; or a length of the long cell DRX cycle is an integer multiple of a length of the short cell DRX cycle, and a first slot offset value associated with a first on-duration timer of the long cell DRX cycle is equivalent to a second slot offset value associated with a second on-duration timer of the short cell DRX cycle, and a first on-duration timer value of the long cell DRX cycle is equivalent to a second first on-duration timer value of the short cell DRX cycle.

Additionally, the NE 2800 may be configured to support any one or combination of at least one of: the at least two monitor intervals correspond to two on-duration periods associated with two alternating cell DTX cycles, wherein the first monitor interval is associated with a first slot offset value and a first on-duration timer value, and the second monitor interval is associated with a second slot offset value and a second on-duration timer value; or the at least two transmit intervals correspond to two on-duration periods associated with two alternating cell DRX cycles, wherein the first transmit interval is associated with a third slot offset value and a third on-duration timer value, and the second transmit interval is associated with a fourth slot offset value and a fourth on-duration timer value; at least one of: a signal associated with cell DTX is configured with two higher-layer DTX configurations, a first higher-layer DTX configuration corresponding to a period wherein cell DTX is deactivated, and a second higher-layer DTX configuration corresponding to the at least two monitor intervals associated with cell DTX being activated; or a signal associated with cell DRX is configured with two higher-layer DRX configurations, a first higher-layer DRX configuration corresponding to a period wherein cell DRX is deactivated, and a second higher-layer DRX configuration corresponding to the at least two monitor intervals associated with cell DRX being activated.

Additionally, the NE 2800 may be configured to support any one or combination of at least one of: a trigger of a higher-layer configuration of the two higher-layer configurations is based at least in part on a cell DTX-based command MAC CE; or a trigger of a higher-layer configuration of the two higher-layer configurations is based at least in part on a cell DRX-based command MAC-CE; at least one of: an ID value of a second higher-layer DTX configuration of the two higher-layer DTX configurations is indicated within at least one of the first signaling occasion or the second signaling occasion; or an ID value of a second higher-layer DRX configuration of the two higher-layer DRX configurations is indicated within at least one of the first signaling occasion or the second signaling occasion.

Additionally, or alternatively, the NE 2800 may support functionality to transmit, to a UE, a first signaling occasion including cell discontinuous signaling configuration and including at least one of: a cell DTX behavior including a cell DTX cycle in which the UE is not to monitor a first signal set corresponding to a cell DTX inactive period and at least two monitor intervals in which the UE is permitted to monitor the first signal set; or a cell DRX behavior including a cell DRX cycle in which the UE is not to transmit a second signal set corresponding to a cell DRX inactive period and at least two transmit intervals in which the UE is permitted to transmit the second signal set; and transmit, to the UE, a second signaling occasion activating the cell discontinuous signaling configuration.

Additionally, the NE 2800 may be configured to support any one or combination of where a first subset of the first signal set includes at least one of SPS occasions including SPS PDSCH, one or more of periodic or semi-persistent CSI RS for CSI measurement associated with RI reporting, or PDCCH corresponding to DCI formats not associated with scheduling PDSCH or PUSCH; and a second subset of the first signal set includes at least one of SSB, SIB, PTRS, periodic or semi-persistent CSI-RS for BM, PRS, PDCCH scrambled with UE-specific radio network temporary identifier (RNTI), PDCCH in Type-3 CSS, PDCCH for RAR, PDCCH for msg4 hybrid automatic repeat request (HARQ) transmission.

Additionally, the NE 2800 may be configured to support any one or combination of where a first subset of the second signal set includes at least one of CG occasions including CG PUSCH, one or more of periodic or semi-persistent SRS not associated with positioning, one or more of periodic or semi-persistent CSI report over one or more of PUSCH or PUCCH, SR occasions; and a second subset of the second signal set includes at least one of SRS for positioning or HARQ-ACK feedback for SPS PDSCH; at least one of: the at least two monitor intervals include at least one of a first monitor interval that precedes a first slot corresponding to a first cell DTX cycle based on a cell DTX activation via the second signaling occasion, and a second monitor interval that succeeds a last slot corresponding to a last cell DTX cycle based on a cell DTX deactivation via the second signaling occasion; or the at least two transmit intervals include at least one of a first transmit interval that precedes a first slot corresponding to a first cell DRX cycle based on a cell DRX activation via the second signaling occasion, and a second transmit interval that succeeds a last slot corresponding to a last DRX cycle based on a cell DRX deactivation via the second signaling occasion.

Additionally, the NE 2800 may be configured to support any one or combination of at least one of: the at least two monitor intervals correspond to two on-duration periods within a same cell DTX cycle, wherein a monitor first interval is associated with a first slot offset value and a first on-duration timer value, and a second monitor interval is associated with a second slot offset value and a second on-duration timer value; or the at least two transmit intervals correspond to two on-duration periods within a same cell DRX cycle, wherein a transmit first interval is associated with a first slot offset value and a first on-duration timer value, and a second transmit interval is associated with a second slot offset value and a second on-duration timer value; at least one of: the cell discontinuous signaling configuration indicates at least two types of cell DTX cycles, a first type of cell DTX cycle corresponding to a long cell DTX cycle and a second type of cell DTX cycle corresponding to a short cell DTX cycle; or the cell discontinuous signaling configuration indicates at least two types of cell DRX cycles, a first type of cell DRX cycle corresponding to a long cell DRX cycle and a second type of cell DRX cycle corresponding to a short cell DRX cycle.

Additionally, the NE 2800 may be configured to support any one or combination of at least one of: a length of the long cell DTX cycle is an integer multiple of a length of the short cell DTX cycle, and a first slot offset value associated with a first on-duration timer of the long cell DTX cycle is equivalent to a second slot offset value associated with a second on-duration timer of the short cell DTX cycle, and a first on-duration timer value of the long cell DTX cycle is equivalent to a second first on-duration timer value of the short cell DTX cycle; or a length of the long cell DRX cycle is an integer multiple of a length of the short cell DRX cycle, and a first slot offset value associated with a first on-duration timer of the long cell DRX cycle is equivalent to a second slot offset value associated with a second on-duration timer of the short cell DRX cycle, and a first on-duration timer value of the long cell DRX cycle is equivalent to a second first on-duration timer value of the short cell DRX cycle.

Additionally, the NE 2800 may be configured to support any one or combination of at least one of: the at least two monitor intervals correspond to two on-duration periods associated with two alternating cell DTX cycles, wherein the first monitor interval is associated with a first slot offset value and a first on-duration timer value, and the second monitor interval is associated with a second slot offset value and a second on-duration timer value; or the at least two transmit intervals correspond to two on-duration periods associated with two alternating cell DRX cycles, wherein the first transmit interval is associated with a third slot offset value and a third on-duration timer value, and the second transmit interval is associated with a fourth slot offset value and a fourth on-duration timer value; at least one of: a signal associated with cell DTX is configured with two higher-layer DTX configurations, a first higher-layer DTX configuration corresponding to a period wherein cell DTX is deactivated, and a second higher-layer DTX configuration corresponding to the at least two monitor intervals associated with cell DTX being activated; or a signal associated with cell DRX is configured with two higher-layer DRX configurations, a first higher-layer DRX configuration corresponding to a period wherein cell DRX is deactivated, and a second higher-layer DRX configuration corresponding to the at least two monitor intervals associated with cell DRX being activated.

Additionally, the NE 2800 may be configured to support any one or combination of at least one of: a trigger of a higher-layer configuration of the two higher-layer configurations is based at least in part on a cell DTX-based command MAC CE; or a trigger of a higher-layer configuration of the two higher-layer configurations is based at least in part on a cell DRX-based command MAC-CE; at least one of: an ID value of a second higher-layer DTX configuration of the two higher-layer DTX configurations is indicated within at least one of the first signaling occasion or the second signaling occasion; or an ID value of a second higher-layer DRX configuration of the two higher-layer DRX configurations is indicated within at least one of the first signaling occasion or the second signaling occasion.

The NE 2800 may be configured to or operable to support a means for transmitting a first signaling occasion including cell discontinuous signaling configuration including at least one of: a cell DTX behavior including a plurality of DTX cycles, a DTX cycle including a period of time in which a UE is not to monitor a first set of DL signals except for a first on-duration period configured in each DTX cycle, and a first DL signal in the first set of DL signals occupies a first set of multiple slots that overlap at least in part with slots of the DTX cycle excluding the first on-duration period; or a cell DRX behavior including a plurality of DRX cycles, a DRX cycle including a period of time in which the UE is not to transmit a second set of UL signals except for a second on-duration period configured in each DRX cycle, and a second UL signal in the second set of UL signals occupies a second set of multiple slots that overlap at least in part with slots of the DRX cycle excluding the second on-duration period; and transmitting a second signaling occasion activating the cell discontinuous signaling configuration.

Additionally, or alternatively, the NE 2800 may support functionality to transmit a first signaling occasion including cell discontinuous signaling configuration including at least one of: a cell DTX behavior including a plurality of DTX cycles, a DTX cycle including a period of time in which a UE is not to monitor a first set of DL signals except for a first on-duration period configured in each DTX cycle, and a first DL signal in the first set of DL signals occupies a first set of multiple slots that overlap at least in part with slots of the DTX cycle excluding the first on-duration period; or a cell DRX behavior including a plurality of DRX cycles, a DRX cycle including a period of time in which the UE is not to transmit a second set of UL signals except for a second on-duration period configured in each DRX cycle, and a second UL signal in the second set of UL signals occupies a second set of multiple slots that overlap at least in part with slots of the DRX cycle excluding the second on-duration period; and transmit a second signaling occasion activating the cell discontinuous signaling configuration.

The controller 2806 may manage input and output signals for the NE 2800. The controller 2806 may also manage peripherals not integrated into the NE 2800. In some implementations, the controller 2806 may utilize an operating system such as iOS®, ANDROID®, WINDOWS®, or other operating systems. In some implementations, the controller 2806 may be implemented as part of the processor 2802.

In some implementations, the NE 2800 may include at least one transceiver 2808. In some other implementations, the NE 2800 may have more than one transceiver 2808. The transceiver 2808 may represent a wireless transceiver. The transceiver 2808 may include one or more receiver chains 2810, one or more transmitter chains 2812, or a combination thereof.

A receiver chain 2810 may be configured to receive signals (e.g., control information, data, packets) over a wireless medium. For example, the receiver chain 2810 may include one or more antennas to receive a signal over the air or wireless medium. The receiver chain 2810 may include at least one amplifier (e.g., a low-noise amplifier (LNA)) configured to amplify the received signal. The receiver chain 2810 may include at least one demodulator configured to demodulate the receive signal and obtain the transmitted data by reversing the modulation technique applied during transmission of the signal. The receiver chain 2810 may include at least one decoder for decoding the demodulated signal to receive the transmitted data.

A transmitter chain 2812 may be configured to generate and transmit signals (e.g., control information, data, packets). The transmitter chain 2812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 2812 may also include at least one power amplifier configured to amplify the modulated signal to an appropriate power level suitable for transmission over the wireless medium. The transmitter chain 2812 may also include one or more antennas for transmitting the amplified signal into the air or wireless medium.

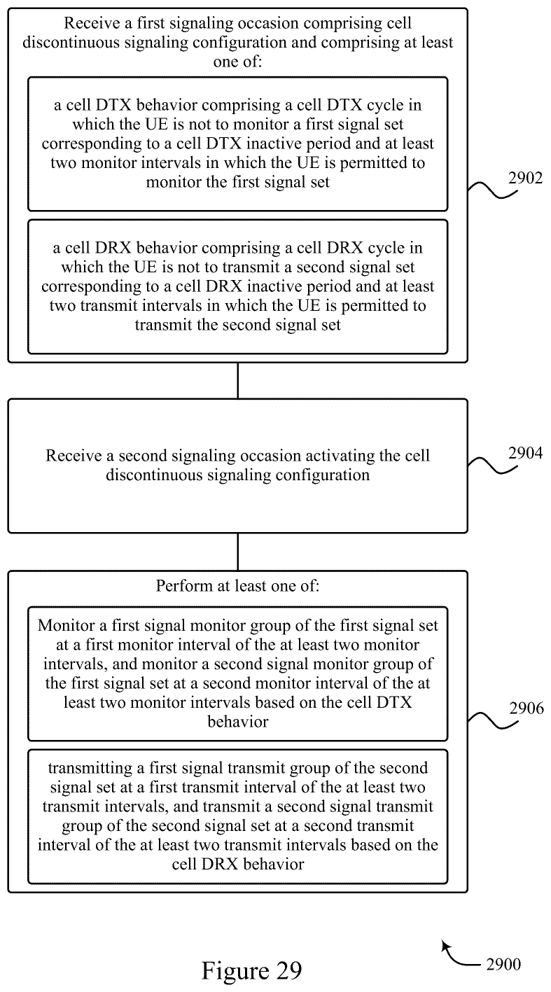

FIG. 29 illustrates a flowchart of a method 2900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 2902, the method may include receiving a first signaling occasion comprising cell discontinuous signaling configuration and comprising at least one of a cell DTX behavior comprising a cell DTX cycle in which the UE is not to monitor a first signal set corresponding to a cell DTX inactive period and at least two monitor intervals in which the UE is permitted to monitor the first signal set, or a cell DRX behavior comprising a cell DRX cycle in which the UE is not to transmit a second signal set corresponding to a cell DRX inactive period and at least two transmit intervals in which the UE is permitted to transmit the second signal set. The operations of 2902 may be performed in accordance with examples as described herein. In some implementations, aspects of the operations of 2902 may be performed by a UE as described with reference to FIG. 26.

At 2904, the method may include receiving a second signaling occasion activating the cell discontinuous signaling configuration. The operations of 2904 may be performed in accordance with examples as described herein. In some implementations, aspects of the operations of 2904 may be performed by a UE as described with reference to FIG. 26.

At 2906, the method may include performing at least one of monitoring a first signal monitor group of the first signal set at a first monitor interval of the at least two monitor intervals, and monitor a second signal monitor group of the first signal set at a second monitor interval of the at least two monitor intervals based on the cell DTX behavior, or transmitting a first signal transmit group of the second signal set at a first transmit interval of the at least two transmit intervals, and transmit a second signal transmit group of the second signal set at a second transmit interval of the at least two transmit intervals based on the cell DRX behavior. The operations of 2906 may be performed in accordance with examples as described herein. In some implementations, aspects of the operations of 2906 may be performed a UE as described with reference to FIG. 26.

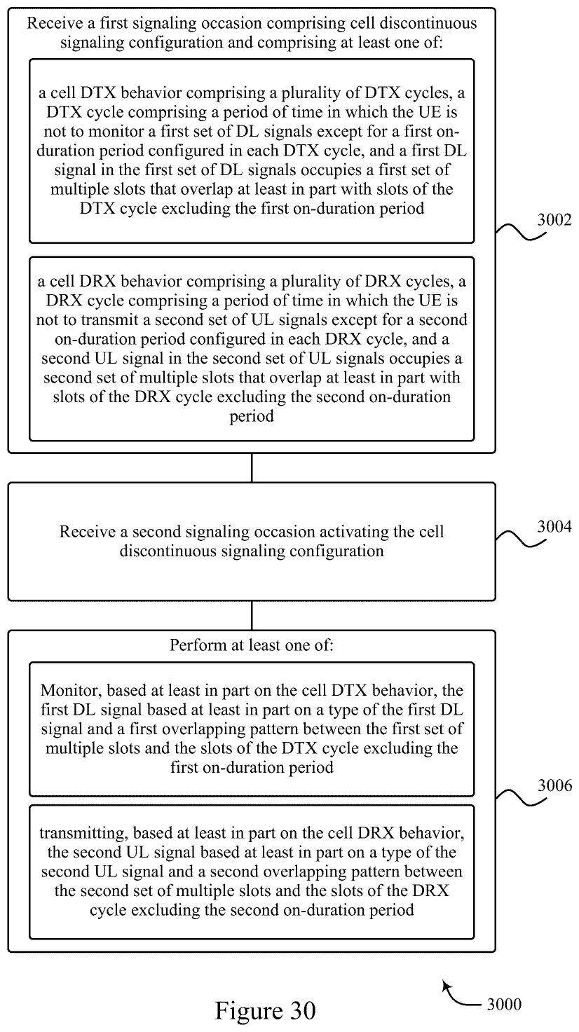

FIG. 30 illustrates a flowchart of a method 3000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 3002, the method may include receiving a first signaling occasion comprising cell discontinuous signaling configuration comprising at least one of a cell DTX behavior comprising a plurality of DTX cycles, a DTX cycle comprising a period of time in which the UE is not to monitor a first set of DL signals except for a first on-duration period configured in each DTX cycle, and a first DL signal in the first set of DL signals occupies a first set of multiple slots that overlap at least in part with slots of the DTX cycle excluding the first on-duration period, or a cell DRX behavior comprising a plurality of DRX cycles, a DRX cycle comprising a period of time in which the UE is not to transmit a second set of UL signals except for a second on-duration period configured in each DRX cycle, and a second UL signal in the second set of UL signals occupies a second set of multiple slots that overlap at least in part with slots of the DRX cycle excluding the second on-duration period. The operations of 3002 may be performed in accordance with examples as described herein. In some implementations, aspects of the operations of 3002 may be performed by a UE as described with reference to FIG. 26.

At 3004, the method may include receiving a second signaling occasion activating the cell discontinuous signaling configuration. The operations of 3004 may be performed in accordance with examples as described herein. In some implementations, aspects of the operations of 3004 may be performed by a UE as described with reference to FIG. 26.

At 3006, the method may include performing at least one of monitoring, based at least in part on the cell DTX behavior, the first DL signal based at least in part on a type of the first DL signal and a first overlapping pattern between the first set of multiple slots and the slots of the DTX cycle excluding the first on-duration period, or transmitting, based at least in part on the cell DRX behavior, the second UL signal based at least in part on a type of the second UL signal and a second overlapping pattern between the second set of multiple slots and the slots of the DRX cycle excluding the second on-duration period. The operations of 3006 may be performed in accordance with examples as described herein. In some implementations, aspects of the operations of 3006 may be performed a UE as described with reference to FIG. 26.

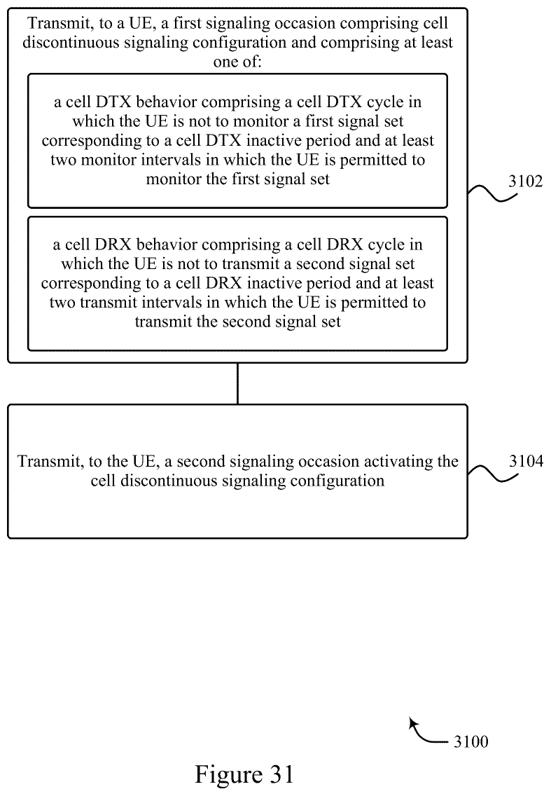

FIG. 31 illustrates a flowchart of a method 3100 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 3102, the method may include transmitting, to a UE, a first signaling occasion comprising cell discontinuous signaling configuration and comprising at least one of a cell DTX behavior comprising a cell DTX cycle in which the UE is not to monitor a first signal set corresponding to a cell DTX inactive period and at least two monitor intervals in which the UE is permitted to monitor the first signal set, or a cell DRX behavior comprising a cell DRX cycle in which the UE is not to transmit a second signal set corresponding to a cell DRX inactive period and at least two transmit intervals in which the UE is permitted to transmit the second signal set. The operations of 3102 may be performed in accordance with examples as described herein. In some implementations, aspects of the operations of 3102 may be performed by a NE as described with reference to FIG. 28.

At 3104, the method may include transmitting, to the UE, a second signaling occasion activating the cell discontinuous signaling configuration. The operations of 3104 may be performed in accordance with examples as described herein. In some implementations, aspects of the operations of 3104 may be performed by a NE as described with reference to FIG. 28.

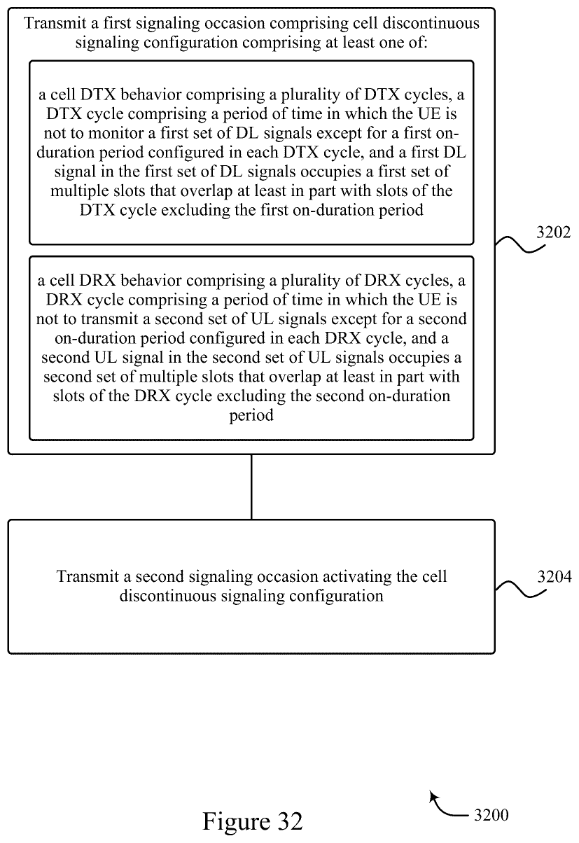

FIG. 32 illustrates a flowchart of a method 3200 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 3202, the method may include transmitting a first signaling occasion comprising cell discontinuous signaling configuration comprising at least one of a cell DTX behavior comprising a plurality of DTX cycles, a DTX cycle comprising a period of time in which a UE is not to monitor a first set of DL signals except for a first on-duration period configured in each DTX cycle, and a first DL signal in the first set of DL signals occupies a first set of multiple slots that overlap at least in part with slots of the DTX cycle excluding the first on-duration period, or a cell DRX behavior comprising a plurality of DRX cycles, a DRX cycle comprising a period of time in which the UE is not to transmit a second set of UL signals except for a second on-duration period configured in each DRX cycle, and a second UL signal in the second set of UL signals occupies a second set of multiple slots that overlap at least in part with slots of the DRX cycle excluding the second on-duration period. The operations of 3202 may be performed in accordance with examples as described herein. In some implementations, aspects of the operations of 3202 may be performed by a NE as described with reference to FIG. 28.

At 3204, the method may include transmitting a second signaling occasion activating the cell discontinuous signaling configuration. The operations of 3204 may be performed in accordance with examples as described herein. In some implementations, aspects of the operations of 3204 may be performed by a NE as described with reference to FIG. 28.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a first signaling comprising a cell discontinuous reception (DRX) behavior comprising a plurality of DRX cycles, a DRX cycle comprising a period of time in which the UE is not to transmit a second set of uplink (UL) signals except for a second on-duration period configured in each DRX cycle, and a second UL signal in the second set of UL signals occupies a second set of multiple slots that overlap at least in part with slots of the DRX cycle excluding the second on-duration period;
receive a second signaling occasion activating the cell DRX behavior; and
transmit, based at least in part on the cell DRX behavior, the second UL signal.

2. The UE of claim 1, wherein the second UL signal comprises at least one of:
a periodic or semi-persistent sounding reference signal (SRS) associated with a usage value set to antenna switching over more than one slot;
a physical uplink control channel (PUCCH) configured with an inter-slot repetition pattern; or
a physical uplink shared channel (PUSCH) configured with a repetition pattern over multiple slots.

3. The UE of claim 1, wherein the second UL signal is associated with a repetition pattern comprising multiple scheduled transmissions of a same UL signal content from the UE over a second set of multiple slots.

4. The UE of claim 3, wherein the second UL signal comprises at least one of:
a PUCCH configured with inter-slot repetition; or
a PUSCH configured with repetition type B over multiple slots.

5. The UE of claim 1, wherein the second UL signal is associated with multiple scheduled transmissions of different UL signal content from the UE over the second set of multiple slots.

6. The UE of claim 5, wherein the second UL signal comprises at least a periodic or semi-persistent SRS associated with a usage value set to antenna switching over more than one slot.

7. A processor for wireless communication, comprising:
at least one controller coupled with at least one memory and configured to cause the processor to:
receive a first signaling comprising a cell discontinuous reception (DRX) behavior comprising a plurality of DRX cycles, a DRX cycle comprising a period of time in which a user equipment (UE) is not to transmit a second set of uplink (UL) signals except for a second on-duration period configured in each DRX cycle, and a second UL signal in the second set of UL signals occupies a second set of multiple slots that overlap at least in part with slots of the DRX cycle excluding the second on-duration period;
receive a second signaling occasion activating the cell DRX behavior; and
transmit, based at least in part on the cell DRX behavior, the second UL signal.

8. The processor of claim 7, wherein the second UL signal comprises at least one of:
a periodic or semi-persistent sounding reference signal (SRS) associated with a usage value set to antenna switching over more than one slot;
a physical uplink control channel (PUCCH) configured with an inter-slot repetition pattern; or
a physical uplink shared channel (PUSCH) configured with a repetition pattern over multiple slots.

9. The processor of claim 7, wherein the second UL signal is associated with a repetition pattern comprising multiple scheduled transmissions of a same UL signal content from the UE over a second set of multiple slots.

10. The processor of claim 9, wherein the second UL signal comprises at least one of:
a PUCCH configured with inter-slot repetition; or
a PUSCH configured with repetition type B over multiple slots.

11. The processor of claim 7, wherein the second UL signal is associated with multiple scheduled transmissions of different UL signal content from the UE over the second set of multiple slots.

12. The processor of claim 11, wherein the second UL signal comprises at least a periodic or semi-persistent SRS associated with a usage value set to antenna switching over more than one slot.

13. A method performed by a user equipment (UE), the method comprising:
receiving a first signaling comprising a cell discontinuous reception (DRX) behavior comprising a plurality of DRX cycles, a DRX cycle comprising a period of time in which the UE is not to transmit a second set of uplink (UL) signals except for a second on-duration period configured in each DRX cycle, and a second UL signal in the second set of UL signals occupies a second set of multiple slots that overlap at least in part with slots of the DRX cycle excluding the second on-duration period;
receiving a second signaling occasion activating the cell DRX behavior; and
transmitting, based at least in part on the cell DRX behavior, the second UL signal.

14. The method of claim 13, wherein the second UL signal comprises at least one of:
a periodic or semi-persistent sounding reference signal (SRS) associated with a usage value set to antenna switching over more than one slot;
a physical uplink control channel (PUCCH) configured with an inter-slot repetition pattern; or
a physical uplink shared channel (PUSCH) configured with a repetition pattern over multiple slots.

15. The method of claim 13, wherein the second UL signal is associated with a repetition pattern comprising multiple scheduled transmissions of a same UL signal content from the UE over a second set of multiple slots.

16. The method of claim 15, wherein the second UL signal comprises at least one of:
a PUCCH configured with inter-slot repetition; or
a PUSCH configured with repetition type B over multiple slots.

17. The method of claim 13, wherein the second UL signal is associated with multiple scheduled transmissions of different UL signal content from the UE over the second set of multiple slots.

18. The method of claim 17, wherein the second UL signal comprises at least a periodic or semi-persistent SRS associated with a usage value set to antenna switching over more than one slot.

19. A network equipment for wireless communication, comprising:
at least one memory; and
at least one processor coupled with the at least one memory and configured to cause the network equipment to:
transmit a first signaling comprising a cell discontinuous reception (DRX) behavior comprising a plurality of DRX cycles, a DRX cycle comprising a period of time in which a user equipment (UE) is not to transmit a second set of uplink (UL) signals except for a second on-duration period configured in each DRX cycle, and a second UL signal in a second set of UL signals occupies a second set of multiple slots that overlap at least in part with slots of the DRX cycle excluding the second on-duration period; and
transmit a second signaling occasion activating the cell DRX behavior.

20. The network equipment of claim 19, wherein one or more of:
the second UL signal is associated with multiple scheduled transmissions of different UL signal content from the UE over the second set of multiple slots; or
the second UL signal comprises at least a periodic or semi-persistent SRS associated with a usage value set to antenna switching over more than one slot.
